(19) United States
(12) Patent Application Publication
(10) Pub. No.: US 2012/0266209 A1
(43) Pub. Date: Oct. 18, 2012

(54) Method of Secure Electric Power Grid Operations Using Common Cyber Security Services

(76) Inventors: David Jeffrey Gooding, Upland, CA (US); Jeremy McDonald, Carlsbad, CA (US)

(21) Appl. No.: 13/493,920

(22) Filed: Jun. 11, 2012

(51) Int. Cl. G06F 21/00

(52) U.S. Cl. 726/1

(57) ABSTRACT

A system of operating an electric power grid using common cyber security services to ensure secure connections from control systems to devices in the electric transmission, electric distribution, and energy centric devices in electric customers' networks.

### BACKGROUND OF INVENTION

This invention relates generally to methods of secure operations of an electric power grid and, more specifically, to methods of operating an electric power grid using common cyber security services to ensure secure connections from control systems to devices in the electric transmission, electric distribution, and energy centric devices in electric customers' networks.

Common cyber security services have been used in other contexts, but have not been used in conjunction with the operation of an electric power grid.

### SUMMARY

This invention satisfies the need for common cyber security services to be used in conjunction with the operation of an electric power grid.

### DRAWINGS

FIG. 1 is a diagram of the Southern California Edison (SCE) Smart Grid System-of-Systems Overview;

FIG. 2 is a diagram of the Smart Grid Operational Environment Overview;

FIG. 3 is a diagram of the Bump-In-The-Wire End-to-End Communications;

FIG. 4 is a diagram of the Bump-In-The-Wire Channel Multiple ECSC;

FIG. 5 is a diagram of the Bump-In-The-Stack Channel;

FIG. 6 is a diagram of the Trusted Network Connect (TNC) Architecture;

FIG. 7 is a diagram of the OODA Loop;

FIG. 8 is a diagram of the TNC Interfaces;

FIG. 9 is a diagram of the Example PTS protocol message exchange;

FIG. 10 is a diagram of the Bill of Health as Attribute Certificate;

FIG. 11 is a diagram of the PKI Components;

FIG. 12 is a diagram of the Certificate Enrollment Sequence Diagram;

FIG. 13 is a diagram of the Certificate Renewal Sequence Diagram;

FIG. 14 is a diagram of the CCS TAs;

FIG. 15 is a diagram of the CCS Signing Authorities/Responsibilities;

FIG. 16 is a diagram of the TA Assignments;

FIG. 17 is a diagram of the TAMP Message Communication Over DDS Topics;

FIG. 18 is a diagram of the Rollover Process Sequence;

FIG. 19 is a diagram of the Updating Trust Anchors on Online Client;

FIG. 20 is a diagram of the Updating Trust Anchors on Offline Clients;

FIG. 21 is a diagram of the IKEv2 Child SA Creation;

FIG. 22 is a diagram of the IKE v2 Exchange Without Child SA;

FIG. 23 is a diagram of the OCSP Request to OCSP Responder;

FIG. 24 is a diagram of the Administrator Initiated SA Connect Scenario;

FIG. 25 is a diagram of the Boot-Up Configured SA Connection Scenario;

FIG. 26 is a diagram of the Admin Initiated Disconnection Scenario;

FIG. 27 is a diagram of the Peer Initiated Disconnect Scenario;

FIG. 28 is a diagram of the PMU Group with Initial IKEv2 SA Setup;

FIG. 29 is a diagram of the PMU Group with Complete GDOI SA Setup;

FIG. 30 is a diagram of the IEC 61850-90-5 Related Documentation Relationships;

FIG. 31 is a diagram of the IKEv2 Related Documentation Relationships;

FIG. 32 is a diagram of the GDOI GROUPKEY-PULL Exchange;

FIG. 33 is a diagram of the GDOI GROUPKEY-PUSH Exchange;

FIG. 34 is a diagram of the PMU Multicast Group Setup;

FIG. 35 is a diagram of the PMU Multicast Group Member Eviction;

FIG. 36 is a diagram of the Network Participants of the CCS Network connected by Syslog-NG;

FIG. 37 is a diagram of the Smart Grid SoS research;

FIG. 38 is a diagram of the CCS security associations;

FIG. 39 is a diagram of the CCS advanced visualization;

FIG. 40 is a diagram of the CCS control plane;

FIG. 41 is a diagram of the CCS groups; and

FIG. 42 is a diagram of the Security Policy Enforcement & Status.

### DETAILED DESCRIPTION

### 1.1 Identification

This specification defines and allocates the applicable Common Cyber Security Services (CCS) requirements and interface requirements to Edge Security Clients (ESC [aka Clients]) to be deployed throughout the Smart Grid.

The functional interface requirements are defined in terms of Request for Comments (RFCs) and standards that a Client must comply with in order to interoperate with the Central Security Services. It also specifies the functional security requirements that the Client must implement in order to provide security for communications operations between Electric Power System (EPS) Cyber Systems and EPS Cyber System Components.

The Edge Security Client is an EPS Cyber Systems Component (ECSC) capable of providing distributed enforcement of security policy at or near the perimeter of the system.

### The Edge Security Client:

1. Provides a secure interface so that it can be monitored and managed by the Central Security Configuration Services.
2. Provides a controlled local interface for technician login.
3. Requires little human intervention once configured.
4. Is built for speed and efficiency.
5. Provides the cryptographic services needed to meet security policy for Edge Security.
6. Provides the boundary enforcement mechanisms of edge devices (as applicable) configured by Central Security Configuration Services.
(a) Some clients may not need to provide boundary enforcement due to their location within a security perimeter and other security mechanisms afforded them.
7. From a design perspective, are modular with well-defined standards based interfaces.

The physical environment is a key design consideration for Edge Security Client services and requirements which results in multiple classes of devices dependent on environment. The term Edge Security Client and Client are synonymous and are used interchangeably throughout this document.

### 1.1.1 Terms

The following terms used in this document were derived from North American Electric Reliability Corporation (NERC) Critical Infrastructure Protection (CIP) CIP-010-Cyber Security-BES Cyber System Categorization:

### Electric Power System (EPS)—

The electrical generation resources, transmission lines, distribution equipment, interconnections with neighboring systems, and associated equipment.

### EPS Cyber System Component (ECSC)—

One or more programmable electronic devices (including hardware, software and data) organized for the collection, storage, processing, maintenance, use, sharing, communication, disposition, or display of data; which respond to a EPS condition or disturbance; or enable control and operation.

### EPS Cyber System Application (ECSA)—

Application software designed to use EPS Cyber System Components to perform specific tasks for a particular purpose, i.e. Distribution Management System (DMS), Automated Load Control System (ALCS), Wide Area Situational Awareness System (WASAS), Analytics and Visualization (A&V), Common Cybersecurity Services (CCS), etc.

### EPS Cyber System (ECS)—

One or more EPS Cyber System Components which if rendered unavailable, degraded, compromised, or misused could, within 15 minutes, cause a disturbance to the EPS, or restrict control and operation of the EPS, or affect situational awareness of the EPS.

### Control Center (CC)—

A set of one or more EPS Cyber Systems capable of performing one or more of the following functions for multiple (i.e., two or more) EPS generation, distribution, or transmission facilities, at multiple (i.e., two or more) locations:
1. Supervisory control of EPS Cybersecurity assets, including generation plants, transmission facilities, substations, Automatic Generation Control systems or automatic load-shedding systems,
2. Acquisition, aggregation, processing, inter-utility exchange, or display of EPS Cyber reliability or operability data for the support of real-time operations,
3. EPS Cyber status monitoring and processing for reliability and asset management purposes (e.g., providing information used by Responsible Entities to make real-time operational decisions regarding reliability and operability of the EPS),
4. Alarm monitoring and processing specific to operation and restoration function, or
5. Coordination of EPS Cyber restoration activities.

### Edge Security Client—

An EPS Cyber Systems Component (ECSC) capable of providing distributed enforcement of security policy at or near the perimeter of the system; also referred to as the “Client”.

Personality Profile—Defines the physical and cybersecurity Assurance Levels that a “Client” as well as any specific performance, hardware, computer resources, etc. that the Client is required to meet.

### 1.2 Problem Description

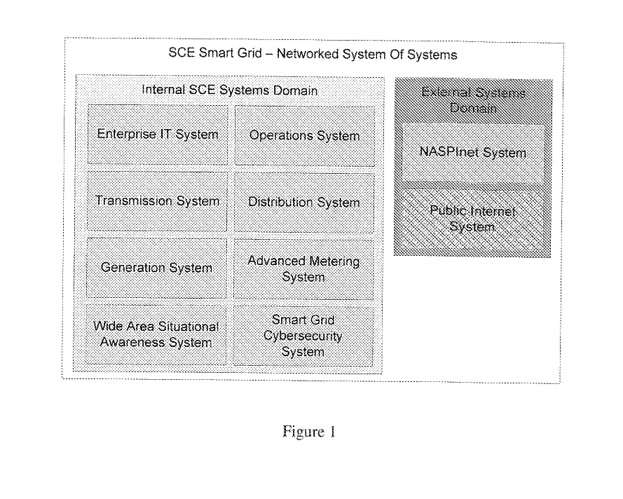

The Southern California Edison, (SCE) Smart Grid is essentially a Networked System of Systems (FIG. 1), with each system collectively providing “Smart Grid Applications”. These applications integrate and manage new sources of renewable and distributed energy supply and storage; improve capital efficiency and assets using better intelligence and technology for optimal system planning; maximize workforce productivity, effectiveness, and safety by using enabling tools; enable the grid to automatically adjust to changing loads and supply requirements; and empower customers to become “active” participants in the energy supply chain managing their own energy consumption.

The smart grid requires a new layer of information technology that dynamically links most all elements of the grid and interconnected devices into a unified network. The creation of such a network enables significant benefits, but also introduces potentially significant cyber-security threats. These EPS Cyber Systems and Components consists of programmable electronic devices (including hardware, software and data) which are dependent upon networked communications to respond to EPS conditions and disturbances and enable control and operation.

This dependency upon networked communications has the potential to create vulnerabilities within the EPS and “SCE recognizes the need to increasingly safeguard the communications and computing systems installed throughout its grid network from cyber-attack.” To tackle the cybersecurity challenge, SCE has developed a Common Cybersecurity Services (CCS) Reference Design which defines the cybersecurity architecture for the CCS necessary to provide the security and integrity for communications and operation of the SCE Smart Grid EPS.

The systems depicted within the “Internal SCE Systems Domain” in FIG. 1 are considered EPS Cyber Systems.

### 1.3 Solution Overview

The Common Cybersecurity Services (CCS) is a collection of security controls and mechanisms distributed throughout the Smart Grid Networked System of Systems (FIG. 1). These security controls and mechanisms are architected to be integrated into the existing EPS Cyber Systems and Components as well as those to be deployed in the future. It should be noted that existing EPS Cyber Systems and Components provide little if any of the security needed to secure the communications infrastructure that the Smart Grid EPS will require.

This specification does not attempt to define specific software or hardware requirements because the requirements specified herein may be implemented by a vendor in any number of configurations dependent on the hardware, software, and system environment.

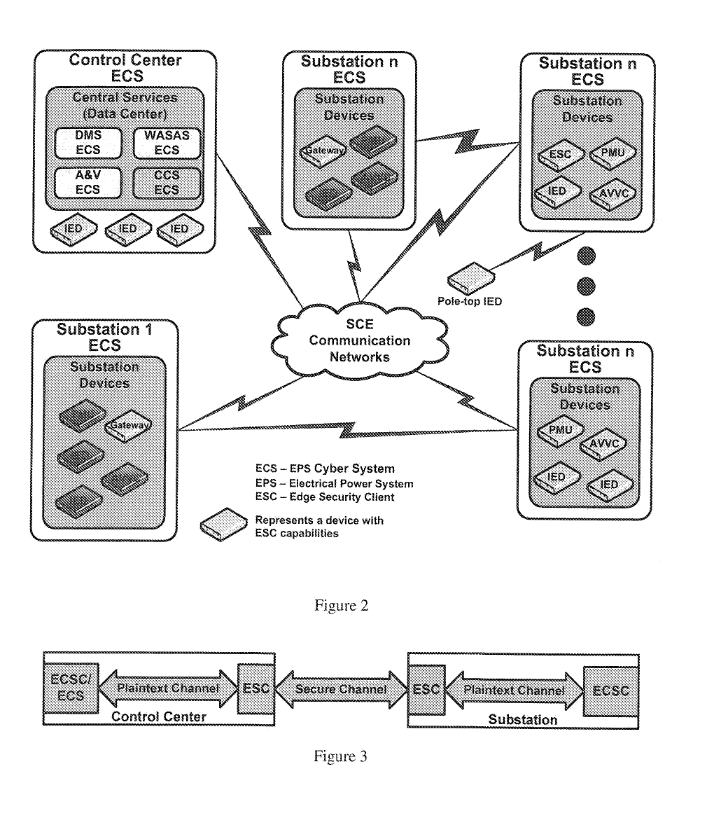

FIG. 2 is a notional depiction of the operational elements that make up the SCE Smart Grid and the communications environment. The diagram shows:
1. Communications between substations using the SCE Communications Network,
2. Communications between substations and the Control Center, and
3. Communications between Field Devices and substations.

FIG. 2 does not show the communication redundancy necessary to meet the availability and reliability requirements of the “Grid” at large. The Phasor Data Concentrator (PDC), Intelligent Electronic Device (IED), Phasor Measurement Unit (PMU), Advanced Volt/V Ar Control (AVVC), and Client elements within the substations are instantiations of EPS Cyber System Components defined above. The elements within the Control Center are themselves EPS Cyber Systems either currently deployed or planned as part of Smart Grid Operations. The Client itself is an EPS Cyber System Component (ECSC) that implements the CCS requirements identified in this specification. The Client is responsible for implementing the security services necessary to provide secure communications between EPS Cyber System Components that make up the larger EPS Cyber Systems, i.e., DMS, WASAS, A & V, eDNA (a leading real-time data historian for acquiring, storing, and displaying large amounts of operations and engineering information), Advanced Metering Infrastructure (AMI), etc.

FIG. 3 depicts a configuration where the Edge Security Client (ESC) is a hardware configuration item (referred to as a Bump-In-The-Wire configuration) that implements the software and hardware necessary to meet the requirements defined in this specification. In this configuration the Client provides the cybersecurity services for a single ECSC within the substation and another ECSC or ECS within the Control Center. The “Secure Channel” represents a communications channel between Clients that is made secure by the cybersecurity services provided by the Client and the “Plaintext Channel” represents a communications channel between the Client an ECS or ECSC that is a “trusted path” between the Client and the ECS or ECSC. A trusted path is simply some mechanism that provides confidence that the user/device is communicating with what the user/device intended to communicate with, ensuring that attackers can't intercept or modify whatever information is being communicated.

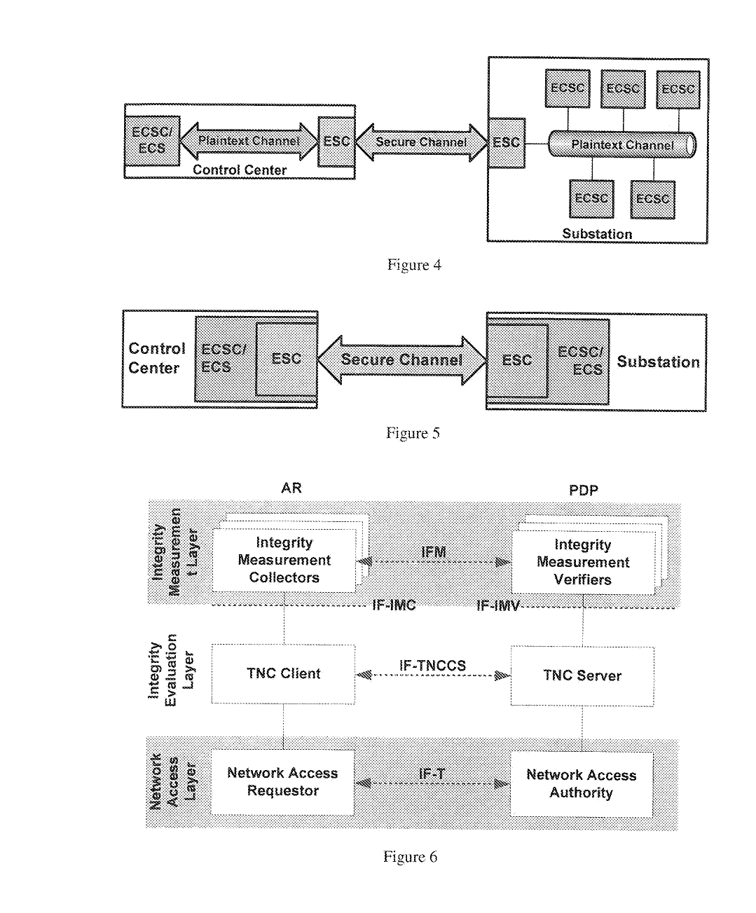

FIG. 4 depicts another Bump-In-The-Wire configuration where the Client is a hardware configuration item that implements the software and hardware necessary to meet the requirements defined in this specification. In this configuration it provides the cybersecurity services for multiple ECSCs within the substation and another ECSC or ECS within the Control Center. This configuration can provide a cost effective solution for substations that have several or many ECSCs that can be protected by a single Client.

FIG. 5 depicts another configuration (Bump-In-The-Stack) where the Client is a software configuration item that implements the software necessary to meet the requirements defined in this specification. In this configuration, the Client is integrated into an ECS, providing the cybersecurity services for its host within the substation and another ECSC or ECS within the Control Center. In this configuration the Client and Plaintext Channels are internal to the host ECSC or ECS and imply that the ECSC/ECS have the resources necessary to support a software implementation of the Client.

The configurations depicted above are examples of how the flexibility of the client will allow the acquisition and integration of various Client configurations which are dependent on the environment in which they operate.

### 1.3.1 Assumptions

### 1.3.1.1 Assumption 1

Conventional hardware can be used to implement this system.

### 1.3.1.2 Assumption 2

The software implementation intended to support a subset of the capabilities defined in this specification is within the skill of the art. Therefore subsequent updates to this specification will be released.

### 1.3.1.3 Assumption 3

This specification defines the security requirements for networked field devices required to support the CCS. It is assumed that the networked device will at a minimum support the Assurance Level 1 requirements specified herein.

### 1.3.1.4 Assumption 4

This specification defines the Control Plane Secure Channel interface (SCI-01) and two of the Data Plane Secure Channel Interfaces (SCI-02, SCI-03) that are required to support secure communications. Additional Secure Channel Interfaces (SCI-04+) are included to support the various power industry standards (i.e., DNP3, IEC 61850, etc.) in procurement specifications.

### 1.3.1.5 Assumption 5

This specification defines general requirements for the Plaintext Control Plane and Plaintext Data Plane interfaces Plaintext Channel Interfaces (PCI) required to support EPS System Applications.

### INCORPORATION BY REFERENCE

The following publications listed in Table 0-0 are hereby incorporated by reference in their entirety:

TABLE 0-0
Documents Incorporated by Reference

| Ref. | | |
|---|---|---|
| ID | Title and Revision | Date |
| 1. | Department of Commerce Publication, Federal Information | May 25, 2001, |
| | Processing Standards Publication 140-2, SECURITY | CHANGE |
| | REQUIREMENTS FOR CRYPTOGRAPHIC MODULES, with | NOTICES |
| | Change Notices by the Information Technology Laboratory | (De. 03, 2002) |
| 2. | IEC 61850-90-5 - Communications Security for 61850 | 2011 (DRAFT) |
| | Synchrophasor Data | |
| 3. | Trusted Computing Group, Trusted Network Connect Architecture | May 2009 |
| | v1.4 (TNC) | |
| 4. | Trusted Computing Group, Trusted Network Connect Integrity | 5 Feb. 2007 |
| | Measurement Collector Interface (IF-IMC), Version 1.2, Revision 8 | |
| 5. | Trusted Computing Group, Trusted Network Connect Integrity | 5 Feb. 2007 |
| | Measurement Verifier Interface (IF-IMV), Version 1.2, Revision 8 | |
| 6. | Trusted Computing Group, Trusted Network Connect Client-Server | 22 Jan. 2010 |
| | Interface (IF-TNCCS), TLV Binding Version 2.0, Revision 16 | |
| 7. | Trusted Computing Group, Trusted Network Connect Vendor- | 10 Mar. 2010 |
| | Specific IMC-IMV Messages (IF-M), TNC IF-M: TLV Binding, | |
| | Version 1.0, Revision 37 | |
| 8. | Trusted Computing Group, Trusted Network Connect IF-T Protocol | 21 May 2007 |
| | Binding to Tunneled EAP Methods, Version 1.1, Revision 10 | |
| 9. | The Internet Engineering Task Force, RFC 5934 - Trust Anchor | August 2010 |
| | Management Protocol (TAMP) by Housley, et al., ISSN: 2070-1721 | |
| 10. | Trusted Computing Group, Trusted Computing Group Trusted | 18 May 2009 |
| | Network Connect IF-T Protocol Binding to TLS, Specification | |
| | Version 1.0, Revision 16 | |
| 11. | Trusted Computing Group, Trusted Computing Group Trusted | 18 May 2009 |
| | Network Connect Network Authorization Transport Protocol (IF-T), | |
| | Specification Version 1.0, Revision 16 | |
| 12. | The Internet Engineering Task Force, RFC 5914 - Trust Anchor | June 2010 |
| | Format by Housley, et al., ISSN: 2070-1721 | |
| 13. | The Internet Engineering Task Force, RFC 6024 - Trust Anchor | October 2010 |
| | Management Requirements, by Reddy and Wallace, ISSN: 2070- | |
| | 1721 | |
| 14. | The Internet Engineering Task Force, RFC 5652 - Cryptographic | September 2009 |
| | Message Syntax (CMS) by Housley | |
| 15. | The Internet Engineering Task Force, RFC 2510 - X.509 Public | March 1999 |
| | Key Infrastructure Certificate Management Protocols by Adams and | |
| | Farrell | |
| 16. | The Internet Engineering Task Force, RFC 2527 - Internet X.509 | March 1999 |
| | Public Key Infrastructure Certificate Policy and Certification | |
| | Practices Framework by Chokhani & Ford | |
| 17. | The Internet Engineering Task Force, RFC 2560 - X.509 Internet | June 1999 |
| | Public Key Infrastructure Online Certificate Status Protocol - OCSP | |
| | by Myers, et al. | |
| 18. | The Internet Engineering Task Force, RFC 2986 - PKCS #10: | November 2000 |
| | Certification Request Syntax Specification Version 1.7 by Nystrom | |
| | & Kaliski | |
| 19. | The Internet Engineering Task Force, RFC 3280 - Internet X.509 | April 2002 |
| | Public Key Infrastructure Certificate and Certificate Revocation List | |
| | Profile by Housley et al. | |
| 20. | The Internet Engineering Task Force, RFC 3281 - An Internet | April 2002 |
| | Attribute Certificate Profile for Authorization by Farrell and | |
| | Housley | |
| 21. | The Internet Engineering Task Force, RFC 3547 - The Group | July 2003 |
| | Domain of Interpretation by Baugher, et al. | |
| 22. | The Internet Engineering Task Force, RFC 4211 - Internet X.509 | September 2005 |
| | Public Key Infrastructure Certificate Request Message Format | |
| | (CRMF) by Schaad | |
| 23. | The Internet Engineering Task Force, RFC 5280 - Internet X.509 | May 2008 |
| | Public Key Infrastructure Certificate and Certificate Revocation List | |
| | (CRL) Profile by Cooper, et al. | |
| 24. | The Internet Engineering Task Force, RFC 5272 - Certificate | June 2008 |
| | Management over CMS (CMC) by Schaad and Myers | |
| 25. | The Internet Engineering Task Force, RFC 5273 - Certificate | June 2008 |
| | Management over CMS (CMC): Transport Protocols by Schaad and | |
| | Myers | |
| 26. | The Internet Engineering Task Force, RFC 5755 - Internet Attribute | January 2010 |
| | Certificate Profile for Authorization by Farrell, et al., ISSN: 2070- | |
| | 1721 | |
| 27. | The Internet Engineering Task Force, RFC 4306 - Internet Key | December 2005 |
| | Exchange (IKEv2) Protocol by Kaufman | |
| 28. | The Internet Engineering Task Force, RFC 4476 - Attribute | May 2006 |
| | Certificate (AC) Policies Extension by Francis and Pinkas | |
| 29. | The Internet Engineering Task Force, RFC 4366 - Transport Layer | April 2006 |
| | Security (TLS) Extensions (Online Certificate Status Protocol | |
| | Stapling) by Blake-Wilson, et al. | |
| 30. | The Internet Engineering Task Force, RFC 5246 - The Transport | August 2008 |
| | Layer Security (TLS) Protocol Version 1.2 by Dierks & Rescorla | |
| 31. | The Internet Engineering Task Force, RFC 4347 - Datagram | April 2006 |
| | Transport Layer Security (DTLS) by Rescorla & Modadugu | |
| 32. | The Internet Engineering Task Force, RFC 2828 - Internet Security | May 2000 |
| | Glossary by Shirey | |
| 33. | The Internet Engineering Task Force, RFC 6241 - Network | June 2011 |
| | Configuration Protocol (NETCONF) by Enns, et al., ISSN: 2070- | |
| | 1721 | |
| 34. | The Internet Engineering Task Force, RFC 5996 - Internet Key | September 2010 |
| | Exchange Protocol Version 2 (IKEv2) by Kaufman, et al., ISSN: | |
| | 2070-1721 | |
| 35. | The Internet Engineering Task Force, RFC 2104 - HMAC: Keyed- | February 1997 |
| | Hashing for Message Authentication by Krawczyk, et al. | |
| 36. | The Internet Engineering Task Force, RFC 6020 - YANG - A Data | October 2010 |
| | Modeling Language for the Network Configuration Protocol | |
| | (NETCONF) by Bjorklund, ISSN: 2070-1721 | |
| 37. | RSA Security Inc. Public-Key Cryptography Standards (PKCS), | 28 Jun. 2004 |
| | PKCS #11 v2.20: Cryptographic Token Interface Standard | |
| 38. | Object Management Group, Data Distribution Service for Real-time | Jan. 1, 2007 |
| | Systems (DDS), v1.2 | |
| 39. | U.S. Department of Homeland Security, Department of Homeland | September 2009 |
| | Security: Cyber Security Procurement Language for Control | |
| | Systems | |

### Requirements

This section specifies the system requirements, that is, those characteristics of the system that are conditions for its acceptance.

### 1.4 States and Modes

### 1.4.1 Client States and Modes

The following paragraphs describe the Client States and Modes. The Client States and Modes, shown in Table 3-1, are defined within the context of a device that implements the security services defined in this specification.

TABLE 0-1
Client States and Modes
Client Modes

| Mode Name | Abbreviation | Description |
|---|---|---|
| Non-Operational | NON_OP | The state in which the Client is initializing its |
| | | environment prior to operation. |
| Operational | OPER | The state in which the Client has completed |
| | | successful initialization and is ready for operation. |
| State Name | Abbreviation | Description |

Client States Within the CCS IED Non-Operational Mode

| | | |
|---|---|---|
| Initializing | INIT | The state during which it will perform self-test and |
| | | either transition into one of the Operational states or |
| | | transition into Non-Operational Fatal Alarm state |
| | | indicating the device cannot be put into service. |
| Fatal Alarm | ALRM | The Client enters an Alarm state either as a result of |
| | | certain alert conditions such as detection of tamper |
| | | events or other integrity failures, or as a result of not |
| | | being able to complete INIT within a reasonable |
| | | timeframe (2-3 minutes). When such failures occur, |
| | | the Client will become non-operational. |

Client States Within the CCS IED Operational Mode

| | | |
|---|---|---|
| Ready For | RFP | The Client is waiting to be provisioned with network |
| Provisioning | | connectivity information (IP address, etc.), |
| | | Registration Authority (RA) contact information, |
| | | and Registration bona-fides (Globally Unique ID, |
| | | passphrase/PIN, PKI root CA chain or hash, etc.) |
| Ready For | RFE | The Client has been provisioned with the required |
| Enrollment | | registration information and is ready to enroll its |
| | | operational PKI credentials with the RA. |
| Participating in | COMM | The Client has successfully enrolled its operational |
| Field | | credentials and is ready to perform integrity |
| Communications | | attestation and make security associations. |
| Network | | |
| In-Service | ISRV | The Client has successfully completed one or more |
| | | Internet Key Exchange (IKE) IKEv2 Security |
| | | Associations (SAs). |

### 1.4.2 Security Modes

The Security Modes are only applicable when the Client is in the Operational Mode.

Before a Client is allowed to operate within the CCS, the Client needs to be securely initialized with the public key and other assured information of the trusted Certificate Authority (CAs), to be used in validating certificate paths (i.e. PKI root CA chain). Furthermore, a Client typically needs to be provisioned with CCS RA contact information.

TABLE 0-2
Security Modes Mapped to Client Modes/States

| | | CCS IED | |
|---|---|---|---|
| Name | Label | Mode/State | Description |
| Provisioned | PROV | OPER/RFR | The Provisioned mode is the condition of the |
| | | | Client when it has been initialized with an |
| | | | Apex Trust Anchor, a Management Trust |
| | | | Anchor, Single-use Provisioning Passphrase |
| | | | and its public/private key pair. A Single-use |
| | | | Provisioning Passphrase is a single-use/one |
| | | | shot Key (installed during provisioning) that |
| | | | allows a Client in the field to be authenticated |
| | | | by the CSRA without an Identity Certificate. |
| | | | The Client will have had to be registered with |
| | | | the CCS RA prior to attempting to have its |
| | | | Identity Certificate signed. In this mode the |
| | | | Client is only able to communicate with the |
| | | | Central Security Registration Authority |
| | | | (CSRA) via an HTTPS connection. The only |
| | | | communications supported over this |
| | | | connection is “Client-authenticated TLS |
| | | | handshake”, which the Client uses to have its |
| | | | Identity Certificate authenticated by the CA |
| | | | via the CSRA. In this mode the Client does |
| | | | not have a signed identity certificate and is |
| | | | unable to participate in any Data Distribution |
| | | | Service (DDS) communications within the |
| | | | Control Plane Domain. |
| Enrolled | ENR | OPER/COMM | The Enrolled mode is the condition of the |
| | | | Client when it has been deployed into its |
| | | | operational environment and has enrolled |
| | | | with the CSRA. In this mode the Client is |
| | | | authorized to participate in DDS |
| | | | communications on the Control Plane Domain |
| | | | only. |
| In-Service | INSRV | OPER/ISRV | The In-Service mode is the condition of the |
| | | | Client after it has contacted the IMA and |
| | | | received a Bill-of-Health (BoH) Attribute |
| | | | Certificate, and contacted the CSR and |
| | | | received its Configuration. In this mode the |
| | | | Client is able to begin making Security |
| | | | Associations in the Data Plane. |
| | | | The BoH and configuration requirements are |
| | | | policy-driven. Not all Clients will have the |
| | | | ability to obtain a BoH or a CCS |
| | | | configuration. |
| | | | In this mode the Client is authorized to |
| | | | participate in DDS communications on the |
| | | | Control Plane Domain and participate in |
| | | | security associations in the Data Plane |
| | | | Domain with the peers specified in its |
| | | | Configuration |

### 1.4.3 Example Security Mode Actions

The events a Client processes and the actions it performs that drive it to different security states and modes are policy driven at deployment time. The policy can change from Client to Client depending on the deployment location and/or application. This section describes an example of one policy.

Table 0-3 specifies the actions that the Client is to take based upon the incoming events “Event ▾” and the Client's current Mode “Mode [symbol] ”. The actions to be taken are designated by A* in the appropriate Mode column, which provides an index which subsequently calls out specific actions that the Client is to take.

TABLE 0-3
Example Security Event-Mode-Actions

Mode

| Event | PROV | ENR | INSRV |
|---|---|---|---|
| ATA_UPDT | A0 | A1 | A1 |
| ATA_XPIR | A0 | A2 | A2 |
| MTA_UPDT | A0 | A3 | A3 |
| MTA_XPIR | A0 | A4 | A4 |
| ITA_UPDT | A0 | A5 | A5 |
| ITA_XPIR | A0 | A6 | A6 |
| IDC_UPDT | A0 | A0 | A7 |
| IDC_XPIR | A0 | A8 | A8 |
| BoH | A0 | A12 | A12 |

Table 0-4 identifies the incoming events that the Client is expected to respond to according to its current mode.

TABLE 0-4
Example Client Mode Incoming Events

| Name | Description |
|---|---|
| ATA_UPDT | The Client has received an Apex Trust Anchor Update |
| | message (RFC 5934) to replace the Apex Trust Anchor. |
| ATA_XPIR | The Apex Trust Anchor has expired. |
| MTA_UPDT | The Client has received a Trust Anchor Update message |
| | (RFC 5934) requesting the Client change, remove or |
| | add a Management Trust Anchor |
| MTA_XPIR | The Client has determined that the Management Trust |
| | Anchor certificate has expired. |
| ITA_UPDT | The Client has received a Trust Anchor Update message |
| | (RFC 5934) requesting the Client change, remove or add |
| | an Identity Trust Anchor. |
| ITA_XPIR | The Client has determined that the Identity Trust Anchor |
| | has expired. |
| IDC_UPDT | The Client has received its Identity certificate in |
| | accordance with RFC 5272. |
| IDC_XPIR | The Client Identity certificate has expired. |
| IDC_RVOK | The Client has received certificate revocation request |
| | message. |
| BoH | The Bill-of-Health Certificate has been received. |

Table 0-5 identifies the actions that the Client is expected to take based upon its current mode and the incoming events.

TABLE 0-5
Client Mode-Actions

| ID | Action |
|---|---|
| A0 | No action is taken; the event has no meaning in this state. |
| A1 | The Client shall perform the Apex Trust Anchor Event (ATA EVT) processing |
| | specified in paragraph 1.4.3.1. |
| A2 | The Client shall transition to the Provisioned Security Mode. |
| A3 | The Client shall perform the Management Trust Anchor Event (MTA EVT) |
| | processing specified in paragraph 1.4.3.2. |
| A4 | The MTA has expired so all communications using this MTA is questionable. |
| | The Client shall perform the TA_XPIR event processing specified in Example QoT |
| | Policy |
| | The events a Client processes and the actions it performs that drive it to different |
| | QoT designations for its peer Clients are policy driven at deployment time. The |
| | policy can change from Client to Client depending on the deployment location |
| | and/or application. This section describes an example of one policy. |
| | No Mode change. |
| A5 | The Client shall perform the Identity Trust Anchor Event (ITA EVT) processing |
| | specified in paragraph 1.4.3.3. |
| | The Client shall perform the IDC_UPDT event processing specified in Example QoT |
| | Policy |
| | The events a Client processes and the actions it performs that drive it to different |
| | QoT designations for its peer Clients are policy driven at deployment time. The |
| | policy can change from Client to Client depending on the deployment location |
| | and/or application. This section describes an example of one policy. |
| A6 | The ITA has expired so all communications dependent upon this ITA is |
| | questionable. |
| | The Client shall perform the IDC_XPIR event processing specified in Example QoT |
| | Policy |
| | The events a Client processes and the actions it performs that drive it to different |
| | QoT designations for its peer Clients are policy driven at deployment time. The |
| | policy can change from Client to Client depending on the deployment location |
| | and/or application. This section describes an example of one policy. |
| | No Mode change. |
| A7 | The Client shall perform the Identity Certificate Update Event (IDC_UPDT_EVT) |
| | processing specified in paragraph 0. |
| A8 | The Client shall perform the Identity Certificate Expired Event (IDC_XPIR_EVT) |
| | processing specified in paragraph 1.4.3.5 |
| A12 | The Client shall perform the Bill of Health Event (BOH_EVT) processing specified |
| | in paragraph 1.4.3.6 |

### 1.4.3.1 Apex Trust Anchor Event (ATA EVT)—Example

| REQ. ID | Text |
|---|---|
| 1.4.3.1 | 1. The Client shall perform the processing specified in |
| | paragraph 4.5 Apex Trust Anchor Update of RFC 5934. |
| 1.4.3.1 | 2. If the Apex Trust Anchor Update was successful, the |
| | Client shall generate an audit event indicating that the |
| | Apex Trust Anchor has been changed. |
| 1.4.3.1 | 3. The Client shall transition to the Provisioned [PROV] |
| | Security Mode. If the Apex Trust Anchor Update was |
| | unsuccessful, the Client shall generate an audit event |
| | indicating that the Apex Trust Anchor change has failed. |

### 1.4.3.2 Management Trust Anchor Event (MTA EVT)—Example

| REQ. ID | Text |
|---|---|
| 1.4.3.2 | 1. If the Trust Anchor Update indicates a change to the |
| | management trust anchor the Client shall perform the |
| | processing specified in paragraph 4.3 Trust Anchor |
| | Update of RFC 5934. |
| 1.4.3.2 | 2. If the Trust Anchor Update was a change, then the |
| | Client shall perform the “change” processing specified in |
| | paragraph 4.3 Trust Anchor Update of RFC 5934. |
| 1.4.3.2 | 3. Generate an audit event indicating that the Apex |
| | Trust Anchor has been changed |

### 1.4.3.3 Identity Trust Anchor Event (ITA EVT)—Example

| REQ. ID | Text |
|---|---|
| 1.4.3.3 | 1. If the Trust Anchor Update indicates a “change” to an |
| | Identity Trust Anchor the Client shall perform the “change” |
| | processing specified in paragraph 4.3 Trust Anchor Update |
| | of RFC 5934. |
| 1.4.3.3 | 2. If the Trust Anchor Update indicates “add” an Identity |
| | Trust Anchor, the Client shall perform the “add” processing |
| | specified in paragraph 4.3 Trust Anchor Update of RFC |
| | 5934. |
| 1.4.3.3 | 3. If the Identity Trust Anchor Update was successful, the |
| | Client shall generate an audit event indicating that the Identity |
| | Trust Anchor has been added. |
| 1.4.3.3 | 4. If the Trust Anchor Update indicates “remove”, the |
| | Client shall perform the “remove” processing specified in |
| | paragraph 4.3 Trust Anchor Update of RFC 5934. |
| 1.4.3.3 | 5. If the Identity Trust Anchor Update was not successful, |
| | the Client shall generate an audit event indicating that |
| | the Identity Trust Anchor removal has failed. |
| 1.4.3.3 | 6. If the Identity Trust Anchor Update was successful, the |
| | Client shall generate an audit event indicating that the |
| | Identity Trust Anchor has been removed. |
| 1.4.3.3 | 7. The Client shall transition to the Provisioned [PROV] |
| | Security Mode. |

### 1.4.3.4 Identity Certificate Update Event (IDC_UPDT_EVT)—Example

| REQ. ID | Text |
|---|---|
| 1.4.3.4 | 1. The Client shall perform the “update” processing of its |
| | Identity Certificate in accordance with RFC 5280. |
| 0 | 2. If the processing of its Identity Certificate was successful, |
| | the Client shall perform the IDC_UPDT event processing |
| | specified in Example QoT Policy |
| | 3. The events a Client processes and the actions it performs |
| | that drive it to different QoT designations for its peer |
| | Clients are policy driven at deployment time. The policy |
| | can change from Client to Client depending on the |
| | deployment location and/or application. This section |
| | describes an example of one policy. |
| 1.4.3.4 | 4. If the processing of its Identity Certificate was successful, |
| | the Client shall generate an audit event indicating that |
| | its Identity Certificate has been updated. |
| 1.4.3.4 | 5. If the processing of its Identity Certificate was |
| | unsuccessful, the Client shall generate an audit event |
| | indicating that its Identity Certificate update has failed. |

### 1.4.3.5 Identity Certificate Expired Event (IDC_XPIR_EVT)—Example

| REQ. | |
|---|---|
| ID | Text |
| 1.4.3.5 | 1. The Client shall perform the Certificate Request processing |
| | specified in RFC 2510 to request that its certificate be |
| | updated. |
| 1.4.3.5 | 2. If the processing of its Identity Certificate was successful, the |
| | Client shall perform the IDC_XPIR event processing |
| | specified in Example QoT Policy |
| | 3. The events a Client processes and the actions it performs that |
| | drive it to different QoT designations for its peer Clients are |
| | policy driven at deployment time. The policy can change from |
| | Client to Client depending on the deployment location and/or |
| | application. This section describes an example of one policy. |
| 1.4.3.5 | 4. If the Certificate Request processing was successful, the |
| | Client shall generate an audit event indicating that its Identity |
| | Certificate has been updated. |
| 1.4.3.5 | 5. If the Certificate Request processing was unsuccessful, |
| | the Client shall generate an audit event indicating that its |
| | Identity Certificate update has failed. |

### 1.4.3.6 BoH Event (BOH_EVT)—Example

| REQ. | |
|---|---|
| ID | Text |
| 1.4.3.6 | 1. The Client shall perform the Bill of Health processing |
| | in accordance as specified. |
| 1.4.3.6 | 2. If the Bill of Health processing was successful, the |
| | Client shall perform the BOH_EVT event processing |
| | specified Example QoT Policy |
| | 3. The events a Client processes and the actions it performs |
| | that drive it to different QoT designations for its peer Clients |
| | are policy driven at deployment time. The policy can change |
| | from Client to Client depending on the deployment location |
| | and/or application. This section describes an example of |
| | one policy. |

### 1.4.4 Quality-of-Trust (QoT) Designations

The Client shall calculate and communicate a QoT designation for each associated peer Client and for each associated GDOI multicast group. The QoT designations are shown in Table 0-6. The QoT designation is communicated over DDS (QoT Update message) to the CSG and it at the same time it is communicated to locally installed EPS Applications over an IPC channel on the Client Platform. The QoT designations are used by the Client and by installed EPS Applications to determine the security trust level of data received from the remote peer client EPS Application or GDOI multicast group. QoT designation allows the local EPS Application to make real-time decisions to alter EPS management. The QoT designation is also used to inform CCS operators as to the status of the Client. The QoT calculation is policy driven. The policy driven calculation is SCE-defined for each Client or type of Client or group and takes into account the QoT Events identified in Table 0-8.

TABLE 0-6
QoT Designations

| Name | Abbreviation | Description |
|---|---|---|
| Trusted | QOT_T | This Quality-of-Trust value is assigned to the peer Client |
| | | when the Client has determined that the peer Client or |
| | | GDOI multicast group trust level is “trusted” and all data |
| | | received or transmitted by the peer Client or GDOI |
| | | multicast group is to be considered “trusted”. In this state |
| | | all information provided by the Client or GDOI multicast |
| | | group is considered to be trusted by this Client and any |
| | | EPS Cyber System Application using the data. |
| Questionable | QOT_Q | This Quality-of-Trust value is assigned when the Client has |
| | | determined that the peer Client or GDOI multicast |
| | | group trust level is “questionable” and all data received |
| | | or transmitted by the Client or GDOI multicast group is |
| | | to be considered “questionable”. In this state all |
| | | information provided by this Client or GDOI multicast |
| | | group is considered to be questionable by this Client and |
| | | any EPS Cyber System Application using the data. |
| Untrusted | QOT_U | This Quality-of-Trust state is assigned when the Client |
| | | has determined that the peer Client or GDOI multicast |
| | | group trust level is “untrusted” and all data received or |
| | | transmitted by the Client or GDOI multicast group shall |
| | | be considered “untrusted”. In this state all information |
| | | provided by this Client is or GDOI multicast group |
| | | considered to be untrusted by the Client and any EPS |
| | | Cyber System Application using the data. |

### 1.4.4.1 Example QoT Policy

The events a Client processes and the actions it performs that drive it to different QoT designations for its peer Clients are policy driven at deployment time. The policy can change from Client to Client depending on the deployment location and/or application. This section describes an example of one policy.

TABLE 0-7
Example QoT Policy

| | designate | | |
|---|---|---|---|
| Event | QOT_T | QOT_Q | QOT_U |
| TA_XPIR | A1 | A0 | A0 |
| TA_RVOK | A2 | A2 | A0 |
| TA_UPDT | A0 | A3 | A3 |
| IDC_XPIR | A4 | A0 | A0 |
| IDC_RVOK | A5 | A5 | A0 |
| IDC_UPDT | A0 | A6 | A6 |
| BoH | A7 | A7 | A0 |
| TEK_CPX | A10 | A0 | A0 |
| TEK_CRO | A11 | A12 | A12 |
| TEK_RKY | A12 | A13 | A12 |
| GSAK_CPX | A14 | A15 | A15 |
| GSAK_CRO | A14 | A15 | A15 |
| GSAK_RKY | A16 | A17 | A16 |

### 1.4.4.2 Example QoT Event State-Actions

The events a Client processes and the actions it performs that drive it to different QoT designations for its peer Clients are policy driven at deployment time. The policy can change from Client to Client depending on the deployment location and/or application. This section describes an example of one policy.

QoT Designations for peer Clients are calculated by a Client according to the Client's configured QoT policy. The doctrine for specific QoT policy can change from Client to Client depending on deployment location and application.

The QoT policy calculation can result in lowered QoT, raised QoT, or even termination of the SA with the peer Client.

All QoT events in the example table below can cause QoT to be re-calculated for a Peer Client.

TABLE 0-8
Example QoT Events

| Name | Description |
|---|---|
| NEW_SA | The Client sets up a new SA with a peer client or with a |
| | GDOI multicast group |
| TA_UPDT | The Client's Trust Anchor certificate updated. This |
| | affects all SAs that use the TA. |
| TA_XPIR | The Client's Trust Anchor certificate expired. This |
| | affects all SAs that use the TA. |
| TA_RVOK | Trust Anchor credential revoked (DDS). This affects all |
| | SAs that use the TA. |
| IDC_UPDT | The Client obtained a new Identity certificate for the |
| | peer Client. |
| IDC_XPIR | The peer Client's Identity certificate expired. |
| IDC_RVOK | The peer Client's Identity certificate revoked. |
| BoH_UPDT | The Client obtained a new Bill-of-Health Certificate |
| | for the peer Client (DDS) |
| BoH_XPIR | The peer Client's Bill of Health expired. |
| TEK_CPX | The Traffic Encryption Key crypto period expired. |
| TEK_CRO | The Traffic Encryption Key Counter rolled over. |
| TEK_RKY | The Traffic Encryption Key rekeyed. |
| GSAK_CPX | The Group SA Key crypto period expired. |
| GSAK_CRO | The Group SA Key counter rolled over. |
| GSAK_RKY | The Group SA Key rekeyed. |
| DEAD_PEER | Client has lost contact with the remote peer Client (IPsec) |
| CYB_ALRT | Cybersecurity monitoring sensors generated a |
| | cybersecurity alert against the peer Client or the GDOI |
| | multicast group (DDS) |
| QoT_OVER | Operator overrides the Client's QoT calculation or |
| | Operator declares “fail-safe mode” for an EPS |
| | application (one or more clients and/or GDOI multicast |
| | groups) (DDS) |
| OP_MODE | Operator declares an end to the “fail-safe mode” or |
| | QoT override (DDS) |
| FAULT | Client or the installed EPS Cyber System Application |
| | detects an internal fault at the application layer. (DDS) |

TABLE 0-9
Example QoT Policy Actions

| ID | Action |
|---|---|
| A0 | No action is taken; the event has no meaning in this state. |
| A1 | 4. The peer Client shall meet the requirements specified for Trust Anchor Receipt |
| | processing. |
| | 5. The Client shall designate QoT Questionable (QOT_Q). |
| A2 | 6. The peer Client shall meet the requirements specified for Trust Anchor Receipt |
| | processing. |
| | 7. The Client shall designate QoT Untrusted (QOT_U). |
| A3 | 8. The Client shall meet the requirements specified for Trust Anchor Receipt |
| | processing. |
| | 9. If the Trust Anchor State is Trusted, |
| | 10. The Client shall designate QoT Trusted (QOT_T). |
| A4 | 11. The peer Client shall meet the requirements specified for Identity Certificate |
| | Receipt. |
| | 12. The Client shall designate QoT Questionable (QOT_Q). |
| A5 | 1. 1. The peer Client shall meet the requirements specified for Identity |
| | Certificate Receipt. |
| | 2. 2. The Client shall designate QoT Untrusted (QOT_U). |
| A6 | 13. The peer Client shall meet the requirements specified for Identity Certificate |
| | Receipt. |
| | 14. If the BoH State is HEALTHY, |
| | 15. If all IDC State is VALID |
| | 16. If all TEK States are KEY_VALID |
| | 17. If all GSAK States are SA_VALID |
| | 18. If Trust Anchor State is TRUSTED |
| | 19. The Client shall designate QoT Trusted (QOT_T). |
| A7 | 20. The peer Client shall meet the requirements specified for BoH Receipt. |
| | 21. If the BoH is HEALTHY, |
| | 22. If all TEK States are KEY_VALID |
| | 23. If all GSAK States are SA_VALID |
| | 24. If Trust Anchor State is TRUSTED |
| | 25. The Client shall designate QoT Trusted (QOT_T). |
| | 26. If the BoH is BAD, |
| | 27. The Client shall designate QoT Questionable (QOT_Q). |
| A10 | 28. The Client shall designate QoT Questionable (QOT_Q). |
| A11 | 29. The peer Client shall meet the requirements specified for TEK Event |
| | 30. The Client shall designate QoT Questionable (QOT_Q). |
| A12 | 1. 1. The Client shall meet the requirements specified for TEK Update Event |
| A13 | 31. The peer Client shall meet the requirements specified for TEK Event |
| | 32. If the BoH is HEALTHY, |
| | 33. If all TEK State is KEY_VALID |
| | 34. If all GSAK States are SA_VALID |
| | 35. If Trust Anchor State is TRUSTED |
| | 36. The Client shall designate QoT Trusted (QOT_T). |
| A14 | 37. The peer Client shall meet the requirements specified for Group SA Key Event |
| | 38. The Client shall designate QoT Questionable (QOT_Q). |
| A15 | 39. The Client shall meet the requirements specified for Group SA Key Event |
| A16 | 40. The Client shall meet the requirements specified for Group SA Rekey Event |
| A17 | 41. The peer Client shall meet the requirements specified for Group SA Rekey Event |
| | 42. If the BoH is HEALTHY, |
| | 43. If all TEK State is KEY_VALID |
| | 44. If all GSAK State is SA_VALID |
| | 45. If Trust Anchor State is TRUSTED |
| | 46. The Client shall designate QoT Trusted (QOT_T). |

### 1.5 Capability Requirements

This section is divided into sub-sections to itemize the requirements associated with each capability of the system.

### 1.5.1 Electric Power Cyber System Application Security Model

### 1.5.1.1 Integrity and Availability

EPS Cyber System Application traffic flow to and from Clients (commands and data, i.e., control loops) should not be halted or blocked by Clients due to an integrity failure. CCS Clients are designed to boost integrity, trust and non-repudiation of devices participating in EPS Cyber System Applications. Clients use integrity measurement (metrics) to prove their integrity to the Central Security Integrity Measurement Authority (IMA). The integrity evaluation done by the IMA is expressed as a Bill of Health for the Client. The BoH is a signed binary object that is bound to the PKI system and the Clients digital identity. A Client's BoH is a public certificate issued by the IMA and is widely distributed throughout CCS. Peer clients obtain the Client's BoH and make Quality of Trust decisions based directly on the Bill of Health EPS Cyber System Applications that consume data from remote Clients thus obtain security information about their peers on the network. Armed with real-time security knowledge, EPS Cyber System Applications can mark their data with security markings during processing, visualization, and storage and they can take algorithmic steps to survive in the presence of untrusted data or clients.

### 1.5.1.1.1 Integrity Measurement

System Integrity considers the following integrity issues:
1. Integrity Measurement:
   a. How does a device detect modifications to its code and configuration?
   b. How does a device determine the state of its code and configuration, in order to compare to some known-good state?
2. Integrity Attestation: How does a device demonstrate to an authority that its code and configuration are in a known-good state?
3. Integrity Demonstration: How does a device convince itself that the peers it communicates with are in a known-good state?

The functions of attestation and demonstration have been separated in time so that Clients verify each other's integrity without needing to have real-time access to the IMA.

In the context of the Trusted Network Connect (TNC) Architecture (see FIG. 6) the Client performs the Access Requestor (AR) role and the Central Security Integrity Measurement Service performs the Policy Decision Point (PDP) role. The role of the AR is to seek an integrity attestation decision from the PDP. The role of the PDP is to take the AR's integrity measurements and perform the verification process and make an attestation decision.

The decision to make this separation was to facilitate centralization of the attestation/verification process. Verifying a device's integrity may require a lot of specialized information, i.e. hashes of bootloaders and kernels, software version numbers, hashes of configuration files, public keys for Hardware Security Modules (HSMs) (e.g. Trusted Platform Monitor (TPM) chips), and so on. The device version and model, from each vendor, will have the Client's own set of verification information and policies. It would be an excessive burden to securely distribute all of this verification information to all Edge devices. Instead, all verification information stays on the central Integrity Measurement Authority, where system administrators can manage it.

In the context of the TNC architecture the Integrity Measurement Collectors (IMCs) and Integrity Measurement Verifiers (IMVs) are complimentary architectural elements that support the Integrity Measurement Authority provided by the CCS.

The IMCs gather integrity measurements and communicate them to IMVs. Software, firmware and hardware components that make up the IMCs on the Client are expected to report status information to the IMV software components that make up the Integrity Measurement Authority which stores these measurements in the Central Security Repository.

In the context of the TNC architecture, the Clients perform the Access Requestor and TNC Client functions while the IMA performs the Policy Decision Point and TNC Server functions. Bill of Health generation by the IMA replaces the Network Access Authority function.

It is envisioned that different types of clients (i.e., Phasor Measurement Units (PMUs)), Phasor Data Concentrators (PDCs), etc.), from different vendors, in different installations, would require different ways to collect integrity related measurements.

SCE requires that for each device design, the vendor will provide the measurements needed by SCE's integrity policy for that device.

Vendors can also provide a custom IMC/IMV to measure their device's integrity in a unique way. In order to accomplish this, the vendor will have to provide a design for the IMC and IMV, as well as enough of the device design that the custom integrity measurement can be understood and evaluated.

Assurance level requirements include required integrity measurements, i.e., ‘Assurance Level 1’ requires implementing at minimum, PTS over IF-M. This IMV is already built into CCS. It is designed to verify the hashes of static files such as executables, libraries, and static configuration files; while ‘Assurance Level 3’ requires trusted boot verification (like TPM) of bootloader, kernel, all configuration files, etc.

### 1.5.1.2 Loss of Central Cybersecurity Services

Distributed Grid Protection Systems must continue to operate autonomously when central cybersecurity services are unreachable. Clients must prove their integrity to each other without access to a central verification point. Clients must process authorization attributes from each other without access to a central decision point. Expired authentication and authorization credentials and cryptographic keys are retained on Clients and used past the expiration date until Central Security can be reached. In EPS Cyber System Applications availability and integrity is more important than confidentiality.

### 1.5.1.3 Internal Security Breach Defense

Community of Interest (COI) network segmentation is an effective technique to contain a security breach to a small area. Clients can provide one or more Electronic Security Perimeter (ESP) access points. Clients may include a firewall with a Deep Packet Inspection (DPI)/Intrusion Detection System (IDS) capability and/or perform as EPS Cyber System Application gateways. Within a network segment Clients can bind application network sockets (or route application traffic) into a SA or onto a Multi-Protocol Label Switching (MPLS) VLAN.

Clients must implement on-device security kernel reference monitors that logically isolate processing according to security policy, such as with VxWorks, SE Linux, VMWare, and others commonly known in the art. The security kernel policy typically groups processing tasks with the same security needs into levels, types, groups, containers, virtual machines, etc. forming logical security perimeters within the device that help to contain security breaches. On-device security perimeters are logically extended via communications path selection (MPLS) and security association (Transport Layer Security (TLS) and IPSec). One of the benefits of extension via cryptography is the opportunity for robust access control and authentication. Logical security perimeters extended via path selection (MPLS) assume that the path is trusted and do not offer authentication or access control.

### 1.5.1.4 Cyber Attack Observe Orient Decide and Act (OODA) Loop

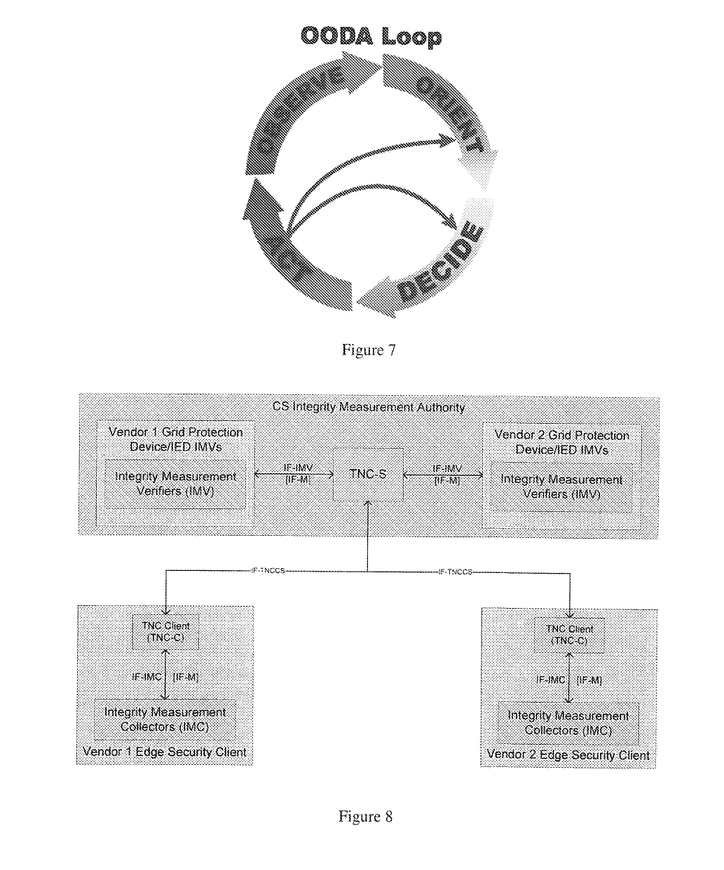

Clients must detect and report security incidents in a timely manner. That is, within SCE's security incident Observe, Orient, Decide, Act (OODA) loop. This loop is shown in FIG. 7. The time span of the OODA loop is set by SCE security policy for each grid protection application.

If the time span of the loop is too large or the attacker goes undetected they can cause damage to the grid before SCE can react.

Technical measures that system designers can take to assist SCE's OODA Loop are mainly techniques to slow down an attacker and give SCE more time to observe a breach:
Network segmentation and logical segmentation help to limit what an attacker can do and slows them down and gives SCE more time to detect a breach.
Client heartbeats can give a continuous indication that a Client is OK. If a Client goes missing from the network (no heartbeat) it is reported as a security incident (within seconds). If an attacker has to avoid interrupting Client heartbeats this can slow down an attacker and give SCE more time to observe a breach.
If a Client gets a bad Bill of Health from the Integrity Measurement Authority (IMA) it is reported as a security incident. If an attacker has to take extra measures to avoid triggering a bad Bill of Health this will limit what an attacker can do and also slows them down.
Clients verify identities, Bill of Health and heartbeats from each other without accessing CCS. This will improve the resilience of substation networks in the face of a coordinated attack involving Client breaches and bringing down the SCE wide area network.
Clients form security associations with each other and with CCS and do not allow any network traffic that does not come through a valid security association. This limits the possible entry points for a cyber-attack.
Clients with higher assurance needs protect critical keys and other security variables using Hardware Security Modules (HSM).
Clients use all available local and remote CCS security inputs to calculate the Quality of Trust they have in each other. This allows the local EPS components in a substation to take independent protective actions during a cyber-attack, even if the cyber-attack cuts them off from CCS.

### 1.5.2 Security Configuration Services on the Client

This capability defines the requirements for filter rules, local credential administration, COI group membership, peer and group security associations, and local inspection management (integrity checking, software checking, and message integrity if non-cryptographic).

### 1.5.2.1 Security Configuration Management

Security configuration management uses the NETCONF protocol to configure the Client.

### 1.5.2.2 Boundary Enforcement Configuration

This section defines requirements for Clients to provide local Electronic Security Perimeter and local separation of duties. Boundary enforcement covers the following:
Ports and Protocols enforcement across the boundary at TCP/IP layer 3.
TCP/IP Layer 7 deep protocol inspection for critical protocols across the boundary.
Intrusion Detection/Protection at the boundary.
Protocol proxy functions such as substation gateway functions.

Boundary Enforcement includes both physical and electronic security boundaries for the Clients. The establishment of security boundaries includes specifying mandatory security requirements for components that reside within a given boundary.

Any connection between Client or CSMA security domains and entities outside the security perimeters occurs through managed interfaces (e.g., proxies, gateways, routers, firewalls, guards, encrypted tunnels).

### 1.5.2.2.1 Substation Management and Configuration

Since substation Gateway functions enforce security policies at multiple enforcement points, it is important that gateway functions can be monitored from the Grid Control Center (GCC) and that their configuration can be controlled from the GCC. All substation gateway configuration settings must be capable of being monitored from a security management function located in the GCC. All substation gateway configuration settings must be capable of being set from a security management function located in the GCC. This includes the ability to download a complete gateway policy configuration in one action.

The CCS supports policy management tools that assure the consistency of security configuration settings (e.g., Security Association Access Control Lists (ACLs)) across multiple substations and across multiple devices within a substation.

1.5.2.3 Audit & Reporting

Local audit support in the Human Machine Interface (HMI) is vendor-specified. Client audit support to Central Security (CS) Security Information and Event Management (SIEM) service is specified in section 1.5.3.9 Audit.

### 1.5.2.4 Client Procurement and Provisioning

The goals of trusted procurement and provisioning are to increase the assurance that there is no malicious software loaded on the Client and to add the SCE Trust Anchor certificates and Client identity credential and public-private keys in a trusted manner. The Single-use Provisioning Passphrase (SPP) Process consists of: The Client authenticating itself to the CSRA using a Single-use Provisioning Passphrase (SPP). Then the Client obtains a signed identity certificate from CSRA without intervention from utility personnel. The following paragraphs describe the Client planning, procurement and provisioning processes.

### 1.5.2.4.1 Planning and Procurement Step 1

The Client vendor (or a 3^{rd} party) provides a formally released:
1. Client software image,
2. Integrity Measurement Verifiers and/or configuration for a standard verifier (includes measurement expected-result data sets and/or verification policy).

### SCE Engineers:

1. Verify the correctness of the Client software image through inspection and testing.
2. Sign the software image using a CCS-issued signing certificate. The signatures are recorded in the CS Repository.
   47. Communicate the signed software back to the Client software vendor.

### 1.5.2.4.2 Planning and Procurement Step 2

If the device(s) contain(s) an electronic serial number the device vendor provides a serial number or list of serial numbers to SCE personnel. SCE personnel enter the serial number data into CCS Repository for use in planning and procurement step 3.

Electronic serial numbers are assigned by the device vendor to each device and must never repeat.

### 1.5.2.4.3 Planning and Procurement Step 3

In this step SCE engineers:
1. Assign a Vendor ID to the device vendor if not already assigned.
2. Assign a Model Number ID to the devices
3. Assign a 61850-Logical Device Name and a vendor-supplied serial number to each Client

CCS assigns a Globally Unique Identifier (GUID) and generates an SPP for each device and stores them in the CS Repository.
The GUID is made up of a 16-bit Vendor ID, a 24-bit device model number, and a 24-bit serial number.

### 1.5.2.4.4 Planning and Procurement Step 4 (Optional)

In this step, SCE engineers assign TCP/IP address information to each device. This is done only if SCE is not using DHCP to provide TCP/IP address information to devices at boot time.

### 1.5.2.4.5 Planning and Procurement Step 5

SCE personnel authorize a GUID or list of GUIDs for installation. CCS loads the device information into the CSRA.

### 1.5.2.4.6 Planning and Procurement Step 6

SCE engineers generate a provisioning manifest of authorized device serial numbers and SPPs for installation. The file contains several items of data:
(If not using DHCP) List of pre-configured TCP/IP address information (address, mask, default GW, VLAN tag, etc.), one or more assigned to each serial number.
Common Name (contains GUID), one per serial number.
A list of SPPs, one per serial number.
A set of CCS trust anchor root CA certificate chains.
IP address of the appropriate DDS discovery node for the DDS domain.
URLs for the CSRA for the CA root chain download and PKI registration processes.

### 1.5.2.4.7 Planning and Procurement Step 7

SCE follows one of several paths depending on the capabilities of the device:
Devices that require manual data provisioning during installation:
   SCE engineers provide the provisioning file to field technicians.
   Field technicians follow manufacturer procedures to install and provision each device.
Devices that are programmed with provisioning data at the factory:
   SCE generates a provisioning file for the Client vendor.
   The Vendor provisions the information into each device at the factory.
   The Vendor ships the devices to SCE using a secure shipping process.
Devices that are programmed with SIM cards:
   SCE programs a batch of SIM cards and gives them to field technicians.
   Field technicians load the SIM card into the device during installation.

### 1.5.2.4.8 PKI Enrollment Process

48. SCE field technicians install the devices in the field.
49. SCE field technicians follow the manufacturer process to enroll the devices with the CCS PKI.
50. The device connects to the CSRA via HTTP and downloads trust anchor root CA certificate chains.
51. The device generates public and private keys and adds the public key and device information to an identity certificate signing request.
52. The device connects to the CSRA via HTTP and sends the certificate signing request.
53. The CSRA sends back the signed SCE device identity certificate.
54. The Client disconnects from the CSRA and stores its new SCE identity certificate.

### 1.5.2.4.9 Client In-Service Process

1. The Client authenticates itself to the control plane DDS using its new ID certificate.
2. The Client communicates with CS to inform CS of its in-service status and receive its configuration files. (if not using vendor provided configuration tools)
3. The Client goes online and makes security associations with configured peers.

### 1.5.3 Automated Security Services

### 1.5.3.1 Configuration over the Network

This section describes the secure mechanisms used to configure Clients over the network.

### 1.5.3.1.1 Design Overview

This section describes the various Client and Central Security components that are involved in the NETCONF configuration process. The secure transport protocols suggested in section 2 of RFC 6241 will not be used. Instead, the messages specified in RFC 6241 section 4 will be sent over two secure authenticated DDS Topics, one that publishes the “client” Remote Procedure Call (RPC) commands from the management station and another that publishes the “server” RPC responses from the Client.

The Client needs provisioning information to attach to the Control Plane DDS before NETCONF over DDS can be used. This includes at a minimum an identity certificate, trust anchors, and the TCP/IP address of the appropriate Control Plane DDS discovery node for the DDS domain.

NETCONF requirements for a “username” will be met by adding a username to the NETCONF DDS messages.

### 1.5.3.1.1.1 Central Security Configuration Management (CSCM)

The CSCM is a Central Security Service that performs the functions of the network manager, or “client” specified in RFC 6241. The CSCM will publish XML RPC Command documents conforming to RFC 6241 to the NETCONF RPC Command DDS Topic over the Control Plane Domain. The CSCM will subscribe to RPC responses from Clients on the NETCONF RPC Response DDS topic.

### 1.5.3.1.1.2 Client

The Client performs the “server” or “device” functions specified in RFC 6241, publishing <rpc-reply> messages in the form of XML documents conforming to Configuration Model specified in RFC 6241 section 5. The Client publishes <rpc-reply> to the NETCONF RPC Response DDS topic and subscribes to <rpc> request messages from CS CM on the NETCONF RPC Command DDS topic. The Client will perform the processing defined in the following table.

### 1.5.3.1.1.3 Configuration Data Model

NETCONF carries configuration data inside the <config> element that is specific to the Client's data model. The protocol treats the contents of that element as opaque data. The Client uses NETCONF capabilities to announce the set of data models that the Client implements. The capability definition details the operation and constraints imposed by the data model. The capability definition is vendor-specified. Commonly, the YANG (not an acronym) configuration modeling language (RFC 6020) is used and is specified as a preferred configuration language for device configuration using NETCONF.
YANG strikes a balance between high-level data modeling and low-level bits-on-the-wire encoding. The reader of a YANG module can see the high-level view of the data model while understanding how the data will be encoded in NETCONF operations.

To meet configuration trusted path requirements all configuration changes sent over NETCONF must be signed by CSCM and the signature verified by the Client before the configuration change is accepted.

It is desirable to extend the 61850 parts 6 and 7 data models to include the security configuration for Clients and then map the extensions and the rest of the 61850 parts 6 and 7 into NETCONF data sets. Currently the Client NETCONF data model covers only Client-specific configured properties.

### 1.5.3.1.1.4 Recovery

Client side recovery shall be accomplished using NETCONF locking and recovery behaviors. This behavior is vendor-specified.

### 1.5.3.2 Integrity Measurement

This capability defines the Client requirements for Integrity Measurement Collection as defined by the TNC Architecture.

Each Client communicates with a Central Security Integrity Measurement Authority (IMA) to prove its integrity. If the Client can prove its integrity, the IMA will give it a credential (X.509v3 Attribute Certificate) called a Bill of Health (BoH). The IMA publishes the BoH to the DDS on behalf of the Client. Before remote Clients begin communicating with their Client(s), they retrieve the Client's BoH from DDS. Peer Clients use the Client's BoH during QoT policy calculations.

### 1.5.3.2.1 High Level Design

This section describes the various components that are involved in the process of integrity management within the context of the CCS and the TNC architecture. FIG. 8 is a top level view depicting TNC interfaces between Clients and the Central Security Integrity Measurement Authority including the IMCs, described below in Section 1.5.3.2.1.1, and Integrity Measurement Verifiers (IMVs), described in Section 1.5.3.2.1.2. IMCs reside in the Clients while IMVs reside on the Central Security Integrity Measurement Authority, which is detailed in Section 1.5.3.2.1.2.

### 1.5.3.2.1.1 Client Integrity Measurement

Integrity measurement means collecting information about the state of a system (i.e. Client), with the goal of determining that its configuration has not been modified from some known-good state. It usually means collecting hashes of configuration elements, and comparing them to expected values stored on the IMA.

There are many aspects of integrity that may be checked, such as:
Measured Boot: booting the system and fingerprint (i.e., calculate cryptographic hash over the executable image) the BIOS, bootloader, and kernel. Each step of the boot process records the hash of the next step: the BIOS records the bootloader's hash, the bootloader records the kernel's hash, etc. The Trusted Computing Group's TPM and the many standards relating to it are one implementation of measured boot. During the measured boot process, the BIOS, the bootloader, and the kernel all extend hashes into the TPM's Platform Configuration Registers (PCR). The PCR's final value can be compared to an expected value representing a known-good system.
File system integrity: collecting information about the state of a system, with the goal of determining that its code and configuration have not been modified from some known-good state. It usually means collecting hashes of code and configuration, and comparing them to expected values that are stored with the IMA.
Querying the device's trust anchor store to be sure it is trusting the proper root certificates and certification authorities:
   Verify that the device's identity certificate was actually issued to this device (perhaps by comparing a hardware-based unique ID)
Kernel-level security modules (e.g. SELinux), in addition to prohibiting programs from attempting to do things they are not permitted to do, log failed attempts. Unusual failed attempts may be a sign that the system's integrity has already been partly compromised, e.g., by remote exploits of application code.
Hypervisor-based in-memory checks of kernel and executable memory integrity.
Built-in Self-checks according to security requirements well-known in the art in cryptographic and security modules.
Other platform-specific methods.
Vendor-specific methods.

Some of these integrity measurement methods only make sense during device boot; others may be re-measured continuously or periodically during operation, or when requested by SCE administrators.

In general, the specific mechanisms used to measure integrity are platform-specific and vendor-specific. Client device vendors are expected to analyze their platforms and create software to measure integrity as they deem appropriate. From the CCS standpoint, a Client device's specific integrity measurement scheme will be specified by SCE and the vendor.

### 1.5.3.2.1.2 Integrity Attestation or Re-Attestation

Integrity attestation (aka remote attestation) means providing integrity measurements to a trusted central authority, i.e., the IMA.

The protocols for remote integrity attestation include the TNC family of protocols from TCG. TNC is a common set of protocols that lets a client attest its integrity to a server. During one TNC session, many different methods of integrity verification can be run (based on policy). The final integrity decision (“Healthy” or “Unhealthy”) is calculated using a configurable policy decision tree within the IMA.

The following sequence describes the high level attestation process including PTS over IF-M.
1. Client initiates IKEv2 with IMA.
2. IMA responds with EAP initiation describing TNC protocol as the EAP method.
3. Client and IMA communicate using IF-TNCCS over EAP.
4. Client IMC dialogs with IMA IMV using PTS-IMC and PTS-IMV messages over PTS binding to IF-M protocol.
5. IMA terminates the IKEv2 session with the Client using an IKE INFORM message.

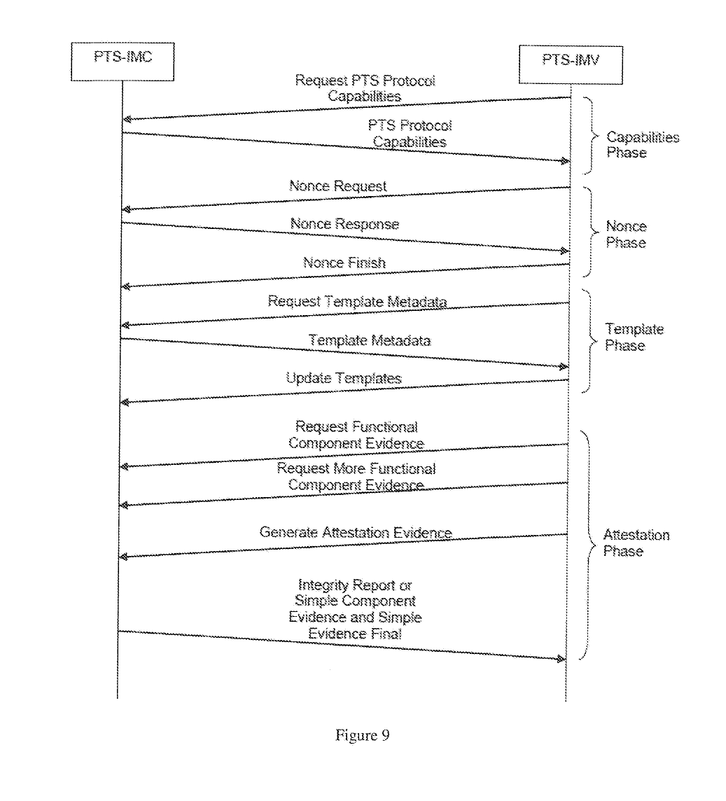

The sequence diagram in FIG. 9 illustrates the integrity attestation process when using PTS over IF-M.

A Client automatically begins the integrity attestation process by contacting the Integrity Measurement Authority using IKEv2. The Client and IMA communicate with each other using the TNC protocols within an IKEv2-EAP transaction. One or more IMCs may execute on the client exchanging messages with their counterpart Integrity Measurement Verifiers (IMVs) on the server.

The server side can optionally initiate further exchanges where more information is exchanged. Extra exchanges, if needed, are vendor-specified. Once an IMV has collected the required measurements, it will make action recommendations to the IMA. If the IMA does not receive all of the required measurements or receives invalid measurements, a negative decision is made.

Upon successful or unsuccessful integrity attestation, the IMA will generate the Client's Bill of Health (healthy or unhealthy), which is a credential proving this Client's integrity has been checked. See Section 1.5.3.2 for more about Bills of Health.

The IMA/TNC Server publishes the Bill of Health through DDS.

### 1.5.3.2.2 Client Integrity Measurement Collectors

Different client implementations, from different vendors, in different installations, at different security levels, may have different measurement policies. The number, type, and implementation of measurement collectors are vendor-specified.

The integrity policy for a Client device is dependent upon the security capabilities it provides and the vendor therefore will need to define an integrity policy and the set of measurements that will execute on their Client device. Each device must provide the measurements required by the IMA integrity policy for that device.

### 1.5.3.2.3 Repository for Integrity Management

Client vendors will supply SCE with vendor-specified integrity data that is needed by the IMA. i.e. hash databases. These are loaded into the IMA repository prior to Client deployment.

### 1.5.3.2.4 Bill of Health Attribute Certificate (BoH AC)

The Bill of Health is an X.509v3 Attribute Certificate. It is constructed differently from typical public key certificates in that it contains no public key and has a “holder” field specifying a Public Key Certificate (PKC). Additionally, it contains an attribute that indicates “Healthy” or “Unhealthy”.

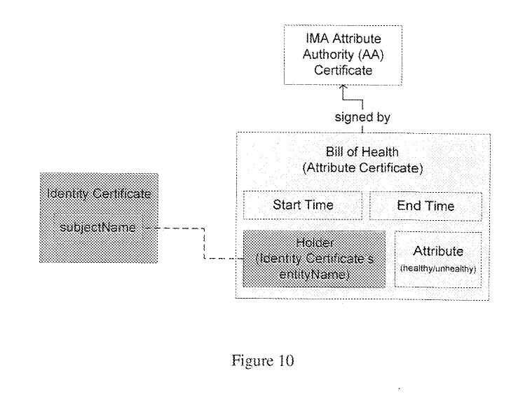

FIG. 10 shows that the Bill of Health certificate is signed by the IMA (Attribute Authority) and bound to the identity of the device through its entity name and the Identity Certificate. This proves the authenticity of the Bill of Health.

The AC itself specifies the Bill of Health's validity period and an attribute that indicates the health status (Healthy or Unhealthy).

FIG. 10 depicts the logical construction of the Attribute Certificate.

The BoH ACs are published to DDS by the IMA.

The mechanism chosen to bind the Bill of Health AC to the Client's identity is discussed in section 1.5.3.3 PKI Credential Management.

### 1.5.3.3 PKI Credential Management

The following paragraphs describe the PKI architecture that will be deployed to support PKI material distribution and credential management. The terminology used in this specification is consistent with the RFCs related to PKI.

### 1.5.3.3.1 PKI Hierarchy

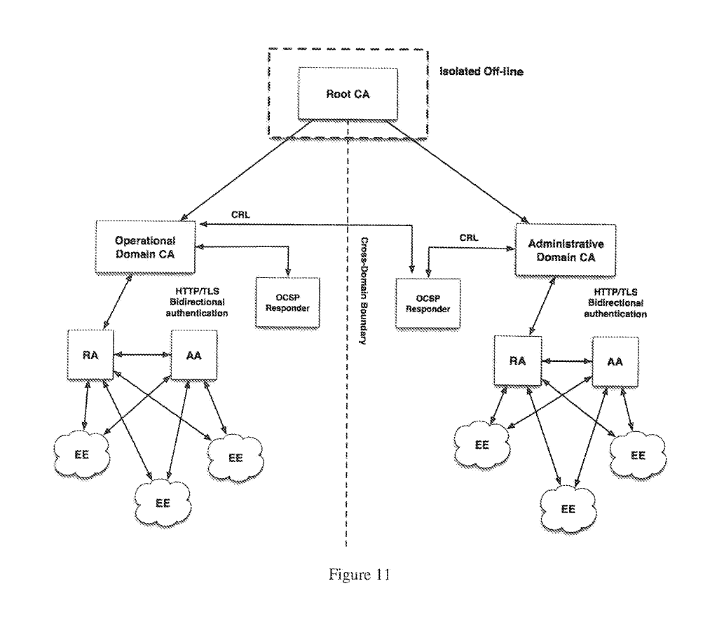

FIG. 11 depicts the two-tier PKI architecture used by the CCS.

The following paragraphs describe the components of the PKI that will be provided by the CCS.
Root Certificate Authority (CA): This is the top of the certificate hierarchy, and is the only self-signed certificate in the infrastructure. The CA's primary purpose is to certify subordinate CAs as they are needed within the infrastructure.
Operational and Administrative Domain CAs: The Operational and Administrative Domain CAs are Subordinate CAs that handle day-to-day certificate issuance and revocation actions of End Entities (EE). They are network accessible to a limited degree with the caveat that End Entities are not able to access the CAs directly. Instead, they will make use of a Registration Authority (RA) which can in turn talk to the CAs.
Registration Authority: A registration authority (RA) is an authority in a network that verifies user requests for a digital certificate and tells the certificate authority (CA) to issue it. RAs are part of a public key infrastructure (PKI), a networked system that enables companies and users to exchange information safely and securely. The digital certificate contains a public key that is used to encrypt and decrypt messages and digital signatures.
(Integrity Measurement) Attribute Authority: This AA handles all Bill of Health certificate creation for the End Entities. Bill of Health Attribute Certificates hold a single statement of integrity.
End Entity (EE) (aka Client): An end entity is any Client that requires an X.509v3 certificate. All Clients require at least one X.509v3 identity certificate to communicate with CCS.
OCSP Responder: The Online Certificate Status Protocol (OCSP) is an Internet protocol used for obtaining the revocation status of an X.509v3 digital certificate. It is described in RFC 2560 and is on the Internet standards track. Messages communicated via OCSP are encoded in Abstract Syntax Notation One (ASN.1) and are usually communicated over HTTP.

Submissions for certificate enrollment and renewal will happen between the Clients and the RA. For revocation operations, authorized SCE personnel will use the RA directly to begin the revocation process. Authorized SCE personnel also initiates a zeroize operation of the Client in the event of a compromise. The zeroize operation initiates deletion of keys and certificates associated entity credentials that have been revoked.

### 1.5.3.3.2 Certificate Profiles

Certificate Profiles define the various X.509v3 certificates and constructs used within the context of the CSS PKI. The field names and attributes referenced are defined in RFC 5280 for public-key certificates and RFC 5755 for attribute certificates.

### 1.5.3.3.3 PKI Certificate Enrollment and Revocation

### 1.5.3.3.3.1 Certificate Management Over CMS (CMC)—Enrollment

This section covers the certificate enrollment protocol that enables Clients to request certificates from certificate authorities. The protocol provides an interface to the public key certification products and services based on Cryptographic Message Syntax (CMS) and Public Key Cryptography Standards (PKCS) #10.

The protocol is request and response based. Client End Entities will generate a new public and private key and then send a Request Cert Message in PKCS#10 to the Certificate Authority, and the Certificate Authority will send the response message. In this particular PKI, Clients will need to send their requests through Registration Authorities. The CMC protocol will use HTTPS/TLS to transport protocol messages.

The certificate renewal follows the enrollment process defined in RFC 5272.

For this design, PKCS#10 Certification will be used in the PKIData portion. The process by which a certification request is constructed involves the following steps:
1) A CertificationRequestInfo value containing a subject distinguished name, a subject public key, and optionally a set of attributes is constructed by an entity requesting certification.
2) The CertificationRequestInfo value is signed with the subject entity's private key.
3) The CertificationRequestInfo value, a signature algorithm identifier, and the entity's signature are collected together into a CertificationRequest value, defined in RFC 2986.

### 1.5.3.3.3.2 CMC Revocation

In the case a Client's key or certificate is compromised, the administrator will need to be able to request that the Client's certificate be revoked. The request goes to the RA, which interacts with CA to perform revocation, generate a new CRL, and push it to OCSP responder. The Client's certificate will be maintained in a certificate revocation list by the Certificate Authority.

### 1.5.3.3.4 OCSP

The OCSP enables applications to determine the revocation state of an identified certificate. OCSP is used to satisfy some of the operational requirements of providing more timely revocation information than is possible with CRLs and is used to obtain additional status information. An OCSP Client issues a status request to an OCSP responder and suspends acceptance of the certificate in question until the responder provides a response.

### 1.5.3.3.5 Certification Paths

An End Entity (Client) verifies the binding between a subject distinguished name and a subject public key, as represented in the end entity certificate, based on the public key of the trust anchor. The path validation process follows RFC 5280.

### 1.5.3.3.5.1 Path Validation (Attribute Certificates)

The basic validation approach for an AC verifier is as follows:

### Pre-Requisite:

The AA signing certificate will exist as a Trust Anchor in the AC verifier's trust anchor store. This kind of certificate doesn't fall strictly into an identity or management TA type, but fits closer to the intent of an identity TA.
Where the PKC is presented for identity purposes, the end-entity ID certificate must be validated through the authority chain: EE PKC, Subordinate CA, and Root CA (detailed above in section 6.3.4).
AC signature must decrypt correctly using AA certificate public key, and the hash value contained inside must match the independent hash over the contents of the AC.
AA Signing cert must conform to the correct cert profile (e.g. must assert digitalSignature in Key Usage, must not assert basicConstraints CA=true, etc.)
Presented AC must be within its validity period.

In the case where both public key certificates and ACs are fully validated there will be 7 2048-bit RSA public key operations, along with the overhead of other cert validation processes at each step during path validation.

### 1.5.3.3.6 Sequence Diagrams for PKI Component Interactions

The following subsections contain sequence diagrams show the interaction between End Entities, the RA and CA for enrollment, reissuance, and revocation actions.

### 1.5.3.3.6.1 Certificate Enrollment

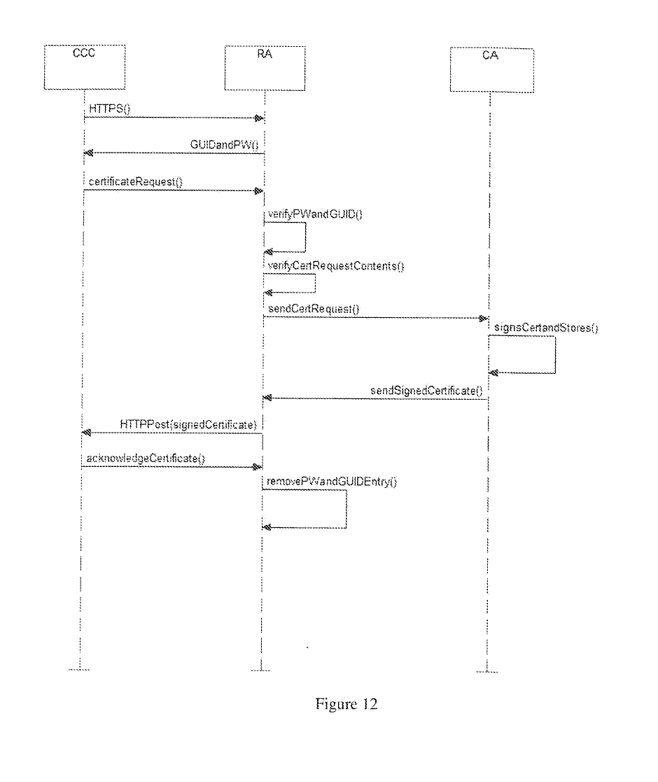

For certificate enrollment, an SCE technician activates a vendor-defined process on a Client to begin the enrollment process. The Client generates an RSA key pair and crafts a certificate request (e.g., PKCS#10). The request message is then sent to the RA, where the PKCS#10 message is validated according to established policies (proper key type and length, correct key components, proper naming structure, correct Client ID, etc.). Once validated, it passes the request on to the CA for certificate issuance. Once issued, the certificate is returned to the RA so it may be picked up by the Client. A status response is sent back to the CS informing it of the successful issuance. At that point the CS can send a command to the Client telling it to pick up the certificate. Once contacted, the RA returns the certificate to the Client. The sequence diagram in FIG. 12 illustrates the Certificate Enrollment process.

### 1.5.3.3.6.2 Certificate Renewal

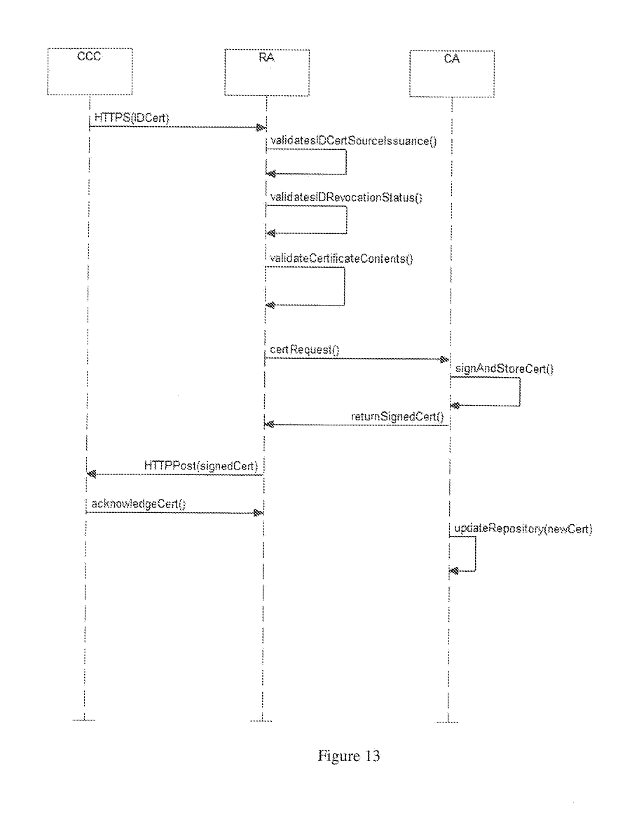

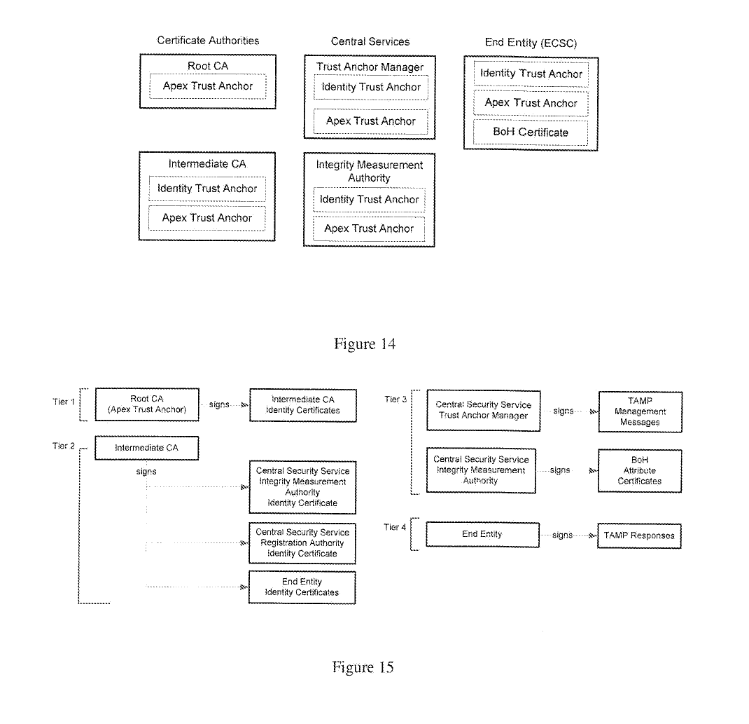

Certificate renewal will occur within a predetermined time period prior to the expiration of the current certificate held by the End Entity. Renewal will involve the generation of a new key pair, but the still-valid credentials must not be overwritten. The request message for renewal must be signed with the old key to provide a binding between the old, still trusted identity and the new key and certificate request. The sequence diagram in FIG. 13 illustrates the Certificate Renewal process.

### 1.5.3.3.6.3 Certificate Revocation

Certificate revocation occurs in response to key compromise or in situations where the identity of the Client or person needs to change. Certificate revocation is an exchange between SCE Personnel and the RA, which would forward the revocation request to the CA after validating it. In addition, a new CRL will be generated and provided to the RA. Also the OCSP Responder's CRL will be updated so it has the latest view of revocation status from the CA.

### 1.5.3.4 Trust Anchor Management (TAM)

This section covers the CCS Public Key Infrastructure (PKI) services and the Trust Anchor Management Protocol (TAMP) design and the TAM protocol.

### 1.5.3.4.1 Overview

A PKI is the most common authentication approach for obtaining a variety of assurances: assurance of integrity, assurance of domain parameter validity, assurance of public key validity, and assurance of private key possession. In a PKI, the infrastructure establishes the entity's identity and the required assurances to provide a strong foundation for security services in PKI-enabled applications and protocols, including IPsec and Transport Layer Security (TLS). The assurances are signed by trusted 3rd party credentials that are loaded into all security system participants, called TAs. Trust Anchor credentials are also managed objects.

### 1.5.3.4.2 Trust Anchor Management Protocol Design

The protocol manages trust anchors in any Client that uses digital signatures. A TA is an authoritative entity represented by a public key with associated information. Trust Anchors are used for certification path validation and verification of signed objects like firmware, timestamps, OCSP responses and keys. Trust anchors are maintained in trust anchor stores, which are sets of one or more trust anchors.

### 1.5.3.4.2.1 Terminology

Trust Anchor (TA): A trust anchor contains a public key that is used to validate digital signatures.
Trust Anchor Management Protocol (TAMP): TAMP is used to manage the trust anchors and community identifiers in any Client that uses digital signatures.
Cryptographic Message Syntax (CMS): CMS is the IETF's standard for cryptographically protected messages. It can be used to digitally sign, digest, authenticate or encrypt any form of digital data.
Cryptographic Module: A cryptographic module supports the secure storage of a digital signature private key to sign TAMP responses and either a certificate containing the associated public key or a certificate designator. The module also supports at least one-way hash function, one digital signature validation algorithm, one digital signature generation algorithm, and one symmetric key unwrapping algorithm.
Trust Anchor Store: Trust Anchor Stores maintain trust anchors. The trust anchor store should have a unique name, and securely store one or more community identifiers. A community identifier is an Object Identifier (OID) that represents a collection of cryptographic modules that can be the target of a single TAMP message or the intended recipients for a particular management message. They allow trust anchor stores to be aggregated into groups.

### 1.5.3.4.2.2 Three Trust Anchor Roles

1. Apex Trust Anchor
Apex trust anchor is the ultimate authority. It has 2 public keys, the operational and the contingency public key. The operational public key is used in normal usage situations—just like the other trust anchors. The contingency public key is used to update the apex trust anchor. The contingency key is useful if the operational key is compromised or lost. It may use a different algorithm than the operational key.

2. Management Trust Anchor
Management trust anchors are used in the management of cryptographic modules. Management trust anchors enable authorization checking for management messages.

3. Identity Trust Anchor
Identity Trust Anchor validates certification paths, represents trust anchor for a PKI, and validates certificates associated with no management applications. An Identity Trust Anchor is also required to identify the Attribute Authorities to authenticate the Attribute Certificates.

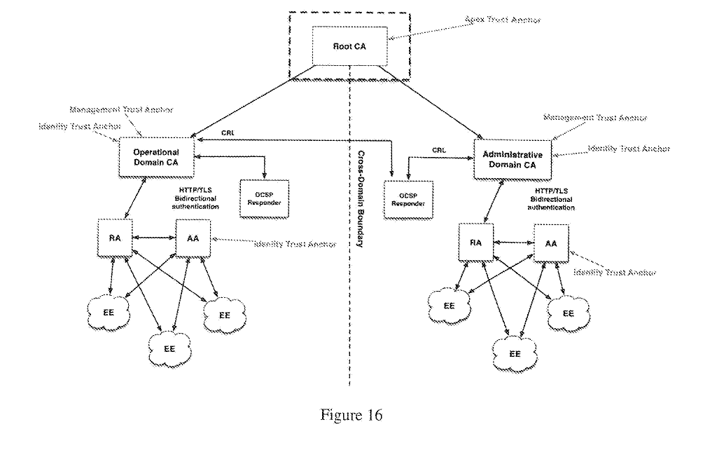

FIG. 14 depicts the distribution of TAs throughout the various CCS elements.

FIG. 15 depicts the use of the various TAs distributed throughout the various CCS elements.

### 1.5.3.4.2.3 Trust Anchor Formats

TAMP recognizes three formats for representing trust anchor information: Certificate [RFC5280], TBSCertificate [RFC5280], and TrustAnchorinfo [RFC5914], which are described in the following paragraphs. However the CCS PKI only use the Certificate format.
Certificate [RFC 5280] The Certificate structure is commonly used to represent trust anchors. Certificates include a signature, which removes the ability for relying parties to customize the information within the structure itself.

### 1.5.3.4.2.4 TAMP Messages

The TAMP messages are presented here for reference purposes.
TAMP Status Query (CCS): The TAMP Status Query message is used to request information about the trust anchors that are currently installed in a trust anchor store, and for the list of communities to which the store belongs.
TAMP Status Query Response (CCS): The TAMP Status Response message is a reply by a trust anchor store to a valid TAMP Status Query message. The TAMP Status Response message provides information about the trust anchors that are currently installed in the trust anchor store and the list of communities to which the trust anchor store belongs, if any.
Trust Anchor Update (CCS): The Trust Anchor Update message is used to add, remove, and change management and identity trust anchors. The Trust Anchor Update message cannot be used to update the apex trust anchor.
Trust Anchor Update Confirm (CCS): The Trust Anchor Update Confirm message is a reply by a trust anchor store to a valid Trust Anchor Update message. The Trust Anchor Update Confirm message provides success and failure information for each of the requested updates.
Apex Trust Anchor Update (CCS): The Apex Trust Anchor Update message replaces the operational public key and, optionally, the contingency public key associated with the apex trust anchor. Each trust anchor store has exactly one apex trust anchor. No constraints are associated with the apex trust anchor. The public key identifier of the operational public key is used to identify the apex trust anchor in subsequent TAMP messages. The digital signature on the Apex Trust Anchor Update message is validated with either the current operational public key or the current contingency public key per the RFC.
Apex Trust Anchor Confirm (CCS): The Apex Trust Anchor Update Confirm message is a reply by a trust anchor store to a valid Apex Trust Anchor Update message. The Apex Trust Anchor Update Confirm message provides success or failure information for the apex trust anchor update.
Community Update (Not Required For CCS): The trust anchor store maintains a list of identifiers for the communities of which it is a member. Communities are collections of identifiers that represent trust anchor stores. The Community Update message can be used to remove or add community identifiers from this list.
Community Update Confirm (Not Required For CCS): The Community Update Confirm message is a reply by a trust anchor store to a valid Community Update message. The Community Update Confirm message provides success or failure information for the requested updates. Success is returned only if the whole batch of updates is successfully processed.
Sequence Number Adjust (Not Required For CCS): The trust anchor store maintains the current sequence number for the apex trust anchor and each management trust anchor authorized for TAMP messages. The Sequence Number Adjust message can be used to provide the most recently used sequence number to one or more targets, thereby reducing the possibility of replay.
Sequence Number Confirm (Not Required For CCS): The Sequence Number Adjust Confirm message is a reply by a trust anchor store to a valid Sequence Number Adjust message. The Sequence Number Adjust Confirm message provides success or failure information.
ERROR (CCS): The TAMP Error message is a reply by a trust anchor store to any invalid TAMP message. The TAMP Error message provides an indication of the reason for the error.

### 1.5.3.4.2.5 Trust Anchor Identity Assignments in the PKI

FIG. 16 depicts the trust anchor assignments in the public key infrastructure that are stored in each End Entity Client that uses digital signatures. The TAM Protocol enables the identities assigned to each PKI component to change. The protocol message TA Update Request, is the primary message that will be used to add, change or remove TAs.

FIG. 16 identifies the trust anchors and trust anchor storage on each End Entity that may be updated.

### 1.5.3.4.2.6 TAMP Over DDS

All TAMP messages will be communicated over DDS using Datagram TLS (DTLS). A vendor-specified function will wait for a DDS message or for a command from the CS CM. Once a TAMP message or command is received, it is determined to be a valid TAMP message by verifying the signature and verifying the certificate chain.

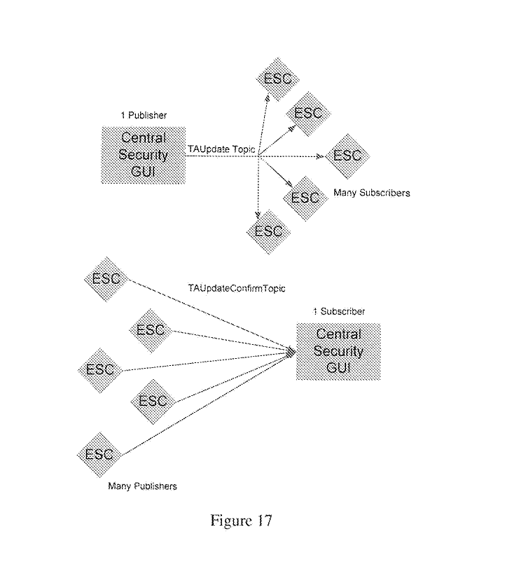

FIG. 17 illustrates how the TAMP messages are distributed throughout the DDS infrastructure. Each time Authorized SCE Personnel initiate a Trust Anchor Update event, the message will be propagated over DDS. Once the Central Security GUI sends out the actual trust anchor update message detailing the list of affected trust anchors, the message will be published to the TAUpdate DDS Topic. The Clients then subscribe to the TAUpdate DDS Topic and process the message.

When the Clients process the message, the response is then published to the TAUpdateConfirm DDS Topic and the CSG is the only subscriber to the TAUpdateConfirm topic. As each Client responds, the CSG updates the Client status in the GUI.

Certificates from the old and new trust anchors will be differentiated by a numeric designation (1) for the original and (2) for the new.

### Example

The original trust anchor would be SubCA(1) and the new one SubCA(2). The EE certs: EE(1) for original, EE(2) for new, and so forth.
1. CA rollover will occur before the end of the validity period. Due to nesting requirements, this may happen sooner.
2. Certificates in existence before roll over:
   a. SubCA(1): Original subordinate CA signing cert
   b. RA-ID(1): Original identity cert for RA
   c. RS-TLS(1): Original TLS certificate for RA communications to/from EEs
   d. Admin-ID(1): Administrator ID cert, used to sign messages from CSG pushed through DDS to EEs (Client machines).
   e. AA-ID(1): Used to sign Attribute Certificates
   e.1.—ID(1): Used to sign OCSP responses
   f. OCSP-TLS(1): Used to secure communications with OCSP responder
   g. EE-ID(1): End entity ID certificates, used in IKE negotiations, etc.
3. CA rollover process will be manual. The span of the rollover process is allowed to span enough time to accommodate Client platforms that may not be online all the time. Old keys may not be replaced immediately following the instantiation of a new subordinate CA. Client enrollment is intended to be an automated process; with a manual fallback process in the event on-line enrollment cannot be performed.

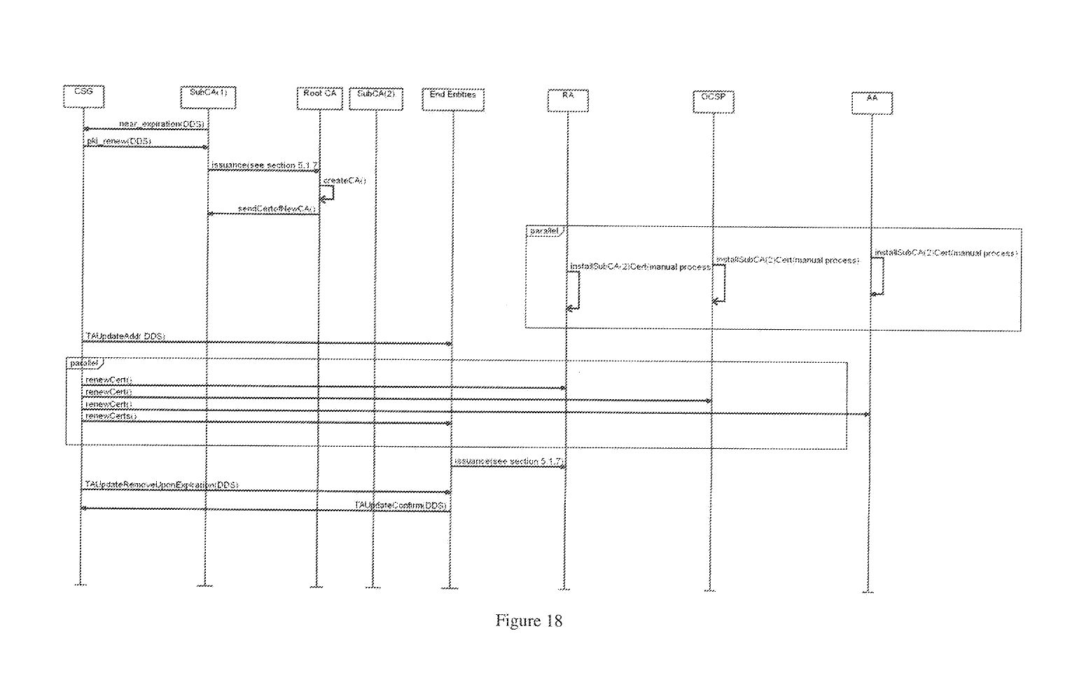

The sequence diagram in FIG. 18 illustrates the Rollover process.

The following text describes the Rollover Process Sequence.
55. CA generates new key pair and PKCS#10. PKCS#10 taken to Root CA machine (offline) and new signing certificate is created: SubCA(2). SubCA(2) certificate is installed in CA. All new certificates will be issued by SubCA(2) from this point forward. SubCA(1) retained until it expires.
56. SubCA(2) certificate distributed as a trust anchor manually to RA, OCSP responder, AA.
57. TAMP Trust Anchor Update message sent to End Entities over DDS. TAMP message will deliver the new certificate as part of an “add” message. The message will be signed with Admin-ID(1).
58. Note: For off-line Clients during this rollover period, an out-of-band method for adding SubCA(2) will be used.
59. Path Validation in End Entities will chain up through TA SubCA(1) and should properly validate. End Entities will now have SubCA(1) and SubCA(2) in their trust anchor stores, effectively allowing signatures from either CA signing to properly validate while still within effective lifetimes.
60. Once all End Entities have SubCA(2), infrastructure certificates like the RA, OCSP, and Attribute Authority should go through recertification. This would create new certs (e.g. RA-TLS(2), AA-ID(2), OCSP-TLS(2), Admin-ID(2), etc.).
61. Note: For AA-ID(2), as soon as that has been issued to the AA, all new ACs will be signed by AA-ID(2). It is possible that during the rollover period a situation can occur where AttCert(2) is obtained using EE-ID(1). In this case, AttCert(2) will only be usable while EE-ID(1) is still valid.
62. Once EE-ID(2) is issued, a new AttCert(2) will need to be obtained. This is because the Attribute Certificate's Holder field is tied to EE-ID's serial number and issuer. One or both of these will differ between EE-ID(1) and EE-ID(2).
63. The Admin, using Admin-ID(2), can now issue enrollment commands to all on-line Clients through a DDS message signed with Admin-ID(2). Clients can generate new keys and submit a new PKCS#10 to the RA over a TLS session protected by RA-TLS(2). End Entities would be issued EE-ID(2).
64. Software/firmware components may be re-signed using a new code signing certificate CodeSign(2).
65. After the SubCA(1) TA reaches its expiration date, the administrator can issue the TAMP Update message to perform a “remove” operation, providing the public key (SubjectPublicKeyInfo) of SubCA(1). Recipients of the TAMP Update message would remove the TA and issue the corresponding response message.

### 1.5.3.4.2.7 Update Online TAs Scenario

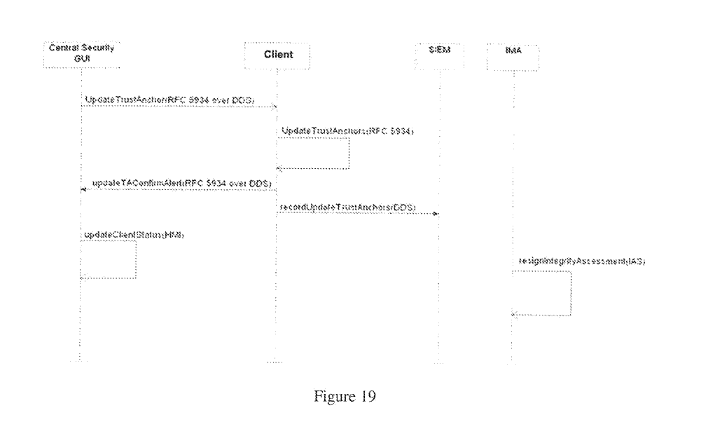

The sequence diagram in FIG. 19 illustrates the process for Online Updating of Trust Anchors.

Certificates from the old and new trust anchors will be differentiated by a numeric designation (1) for the original and (2) for the new.

The following text describes Updating Trust Anchors on Online Client Process Sequence.
1. SCE Personnel on the Central Security GUI invokes the process to renew a Client trust anchor certificate. [RFC 5934]
2. The CSG sends TAMP message to all Clients using the security alert publish/subscribe service. [RFC 5934 over DDS]
3. Clients receive the TAMP message from the published message. [RFC 5934 over DDS]
4. Clients record the event to the Security Information and Event Manager (SIEM). [DDS]
5. Clients send a message to the CSG over DDS topic that the update occurred. [DDS]
6. CSG updates the status of all Clients that loaded the new TA. [HMI]
7. IMA re-signs its integrity assessment and software image hash repositories. [IMA]

### 1.5.3.4.2.8 Update Offline Trust Anchors

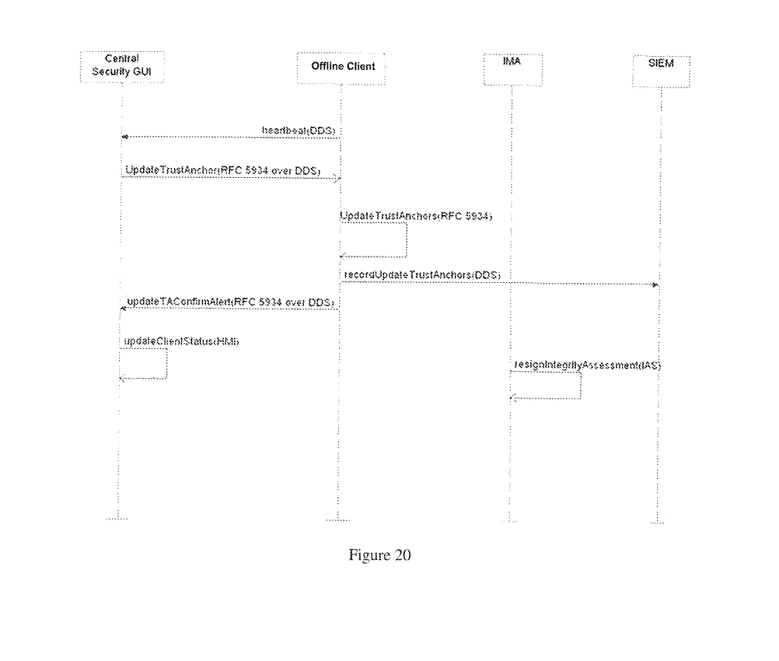

The sequence diagram in FIG. 20 illustrates the process for Offline Updating of Trust Anchors.

The following text describes Updating Trust Anchors on Offline Client Process Sequence.
1. Since some CC Components may not be online, the SCE Personnel at the CSG manually chooses a time to initiate a re-sign of all credentials and/or hash repositories in the system with the new TA. [RFC 5934]
2. The CSG would then wait for a DDS published heartbeat from the CC Components that were offline. [DDS]
3. The CSG sends TAMP message to all CC Components using the security alert publish/subscribe service. [RFC 5934 over DDS]
4. CC Components receive the TAMP message from the published message. [RFC 5934 over DDS]
5. CC Components record the event to the STEM. [DDS]
6. CC Components send a message to the CSG over DDS topic that the update occurred. [DDS]
7. CSG updates the status of all CC Components that loaded the new TA. [HMI]
8. IMA re-signs its integrity assessment and software image hash repositories. [IMA]

### 1.5.3.5 Cryptographic Enforcement with IKE

IKEv2 (RFC 5996) has been chosen for authentication and authorization between two Clients. This section describes how IKEv2 is tailored to satisfy the cryptographic enforcement requirements for a Client.

The IKEv2 Child SAs are used to exchange operational data between Clients. In the case where a group of Clients exchange data over multicast SAs and are keyed by the Group Key Distribution Center (GKDC) using the Group Domain of Interpretation (GDOI) protocol, IKEv2 will still be used for authentication and authorization but GDOI will be used to supply Clients with the pre-placed keys to encrypt/decrypt data sent/received over multicast SAs.

### 1.5.3.5.1 Device Authentication: IKEv2 Exchange Overview

RFC 5996 describes the normal IKEv2 protocol with Child SA creation. RFC 6023 describes a “Childless” version of the protocol where IKEv2 is used only for authentication purposes. CCS Clients shall support the childless IKEv2 mechanism. The Peer Authentication decision, peer authorization decision, and QoT calculation are performed during the Childless IKE process. This establishes Security Associations with peer Clients. At a later point in time a separate process for Child SA creation is performed. During Child SA creation an authorization decision is made based on QoT policy, and then a tunnel/transport decision is made based on configuration.

### 1.5.3.5.1.1 IKEv2 Child SA creation

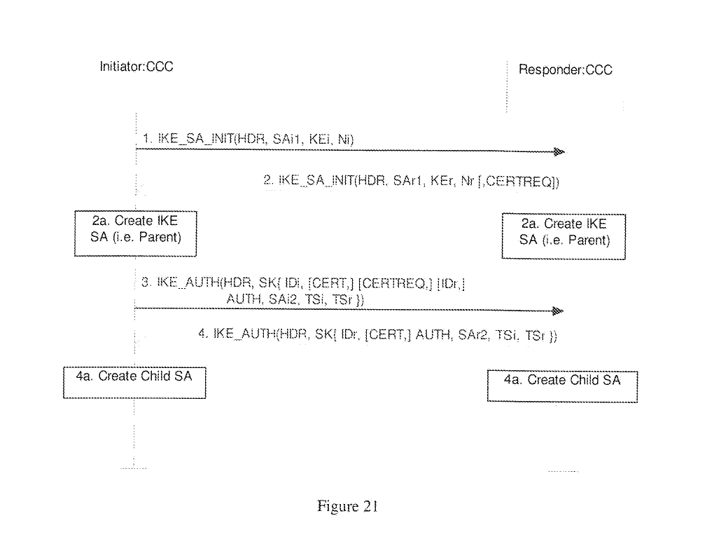

The sequence diagram in FIG. 21 illustrates a generic IKEv2 exchange which results in creation of a Child SA for operational traffic.

### 1.5.3.5.1.2 IKEv2 without Child SA Creation

In some cases, the Child SA created at the end of an IKEv2 exchange is not needed as another type of SA must be created for operational traffic (e.g. see 1.5.3.7 Group Multicast Communications with GDOI). In this case, the messages don't include the SA payload or traffic selector payloads which are only needed for Child SA creation. The IKEv2 Responder:Client sends a CHILDLESS_IKEV2_SUPPORTED notification payload in the IKE_SA_INIT response to indicate a Child SA won't be created. The IKEv2 Initiator:Client then knows not to send the SA and TS payloads used for Child SA creation.

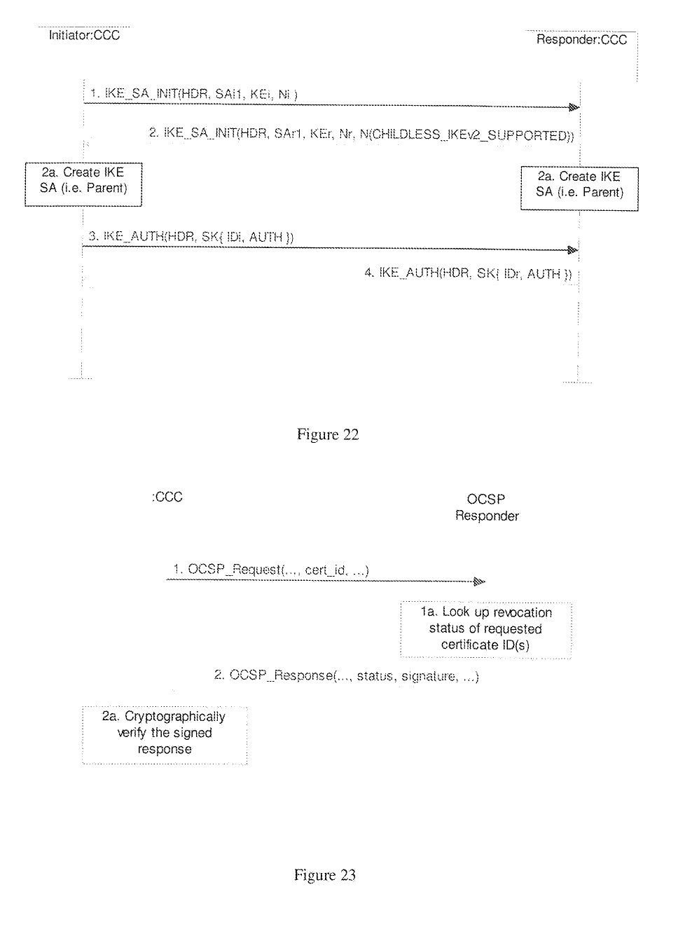

The sequence diagram in FIG. 22 illustrates a generic IKEv2 exchange without creation of a Child SA for operational traffic.

### 1.5.3.5.2 Verification of Additional Credentials

Additional verification is policy-driven, as not all Clients will support Bill of Health attestation. Bill of Health Attribute Certificates are published over DDS as they are generated. During IKE v2 setup the ACs from each peer in the SA are retrieved from DDS by the opposite peer and validated according to policy.

### 1.5.3.5.2.1 OCSP Assertions

OCSP is used to obtain the revocation status of an X.509 digital certificate. The OCSP response is an ASN.1 encoded message that contains the revocation status of the requested certificate. The OCSP response will be used to check the revocation status of the Identity certificate.

The first option is for each CCC to request their peers OCSP response from the OCSP responder during the IKEv2 SA negotiation.

The second option is to use OCSP stapling (i.e. in-band exchange in the IKEv2 CERT payload). This option has the benefit of not having to perform a timely exchange with the OCSP responder each time a security association is established.

In order to send the OCSP responses in band each CCC must retrieve their own OCSP response from the OCSP responder at an earlier time. The CCC will check for the existence of its valid OCSP response during boot up and if it is not found the CCC will request it from the OCSP responder.

IKEv2 allows CRLs to be exchanged in-band via the CERT payload. This is the traditional means of determining revocation status. However these lists can get very large. So OCSP will be used instead. OCSP is used for in-band signaling of certificate revocation status within the IKEv2 exchange. OCSP responses are bounded and small. CERTREQ and CERT payloads contain the OCSP content.

To mitigate the risk of the OCSP Authority being inaccessible by the Client at time of connection, Clients can retrieve OCSP assertions for all configured peers (1) at boot-up, (2) when a new peer is configured, (3) when connectivity to the OCSP Authority is restored, and (4) periodically as the OCSP assertions are about to expire.

OCSP Stapling is then used for checking the revocation of X.509v3 digital certificates as described in RFC 4366 section 3.6

### 1.5.3.5.3 Extending the IKEv2 Standard With CCS-Specific Security Policies

The IKE standard provides a great deal of leeway in defining the security policy for a trusted peer's identity, credentials, and the correlation between them, and cryptographic policy such as SA rekey. Having such security policy defined explicitly for CCS is essential to a secure implementation of IKE and IPsec. The following paragraphs describe the extensions to the standard IKEv2 in order to support CCS policy for availability, authorization.

### 1.5.3.5.3.1 Peer SA Authorization Lists

Clients are configured by CCS with a list of authorized peers for SA establishment. Any time a Client receives an IKE initiation and before a Client initiates IKE itself, it must verify the GUID of the intended peer is in its Authorized Peer SA list. This list is pre-calculated for each Client by CCS from role and group information CCS knows about all Clients. The list must persist in the Clients configuration until it is changed by CCS.

### 1.5.3.5.3.2 Rekeying

Rekeying of SAs should be seamlessly done in the background and not affect the data channels. Latency and jitter should be mitigated. If rekeying fails, traffic over the Child SA must not stop. The old keys must continue to be used but the data processed will be marked with a lower quality of trust. This is a deviation from the specified IKEv2 protocol which will tear down the child SA if keys expired and cannot be renewed. This is a deviation from the specified IKEv2 protocol which will tear down the child SA if keys expired and cannot be renewed.

### 1.5.3.5.3.3 Availability

In a standard IKEv2 implementation, the expiration of the credentials used to establish an SA would require that the connection be closed and the SA re-established. However due to the priority of availability if credentials expire, it may be required (dependent upon policy) that SAs remain established anyway but the EPS Cyber System Applications are informed and use the data that is of a lower quality of trust in accordance with the policy defined by the EPS Cyber System Applications themselves.

### 1.5.3.5.4 Connecting/Disconnecting from Peers

A connection between Clients may be initiated in one of three ways:
8. A command sent from the CS which is initiated by the user.
9. Upon boot-up or
10. When given a new configuration file the Client will initiate connections to peers specified in the configuration file.

An existing SA with a Peer Client may be disconnected in one of three ways:
11. The CSG sends a DDS command to the Client to disconnect with a peer.
12. A Peer Client disconnects from a Client.
13. A Peer Client's QoT is lowered and the local Client's QoT policy requires the Client to disconnect from the peer.

The following paragraphs provide further details regarding the connection and disconnection scenarios.

### 1.5.3.5.4.1 Administrator Initiated Connection Scenario

An administrative user can command SA establishment between two Clients by publishing to the Client IKEv2 Authenticate Command DDS Topic to command an IKEv2 Childless authentication exchange. Then to create the child SA connection for exchanging secure operational data, the user can publish to the SA Connect Command DDS Topic. It is within the IKEv2 specification to be able to combine the authentication and child SA creation exchange into one exchange and this shall be supported in the boot-up scenario described later in this section. However here it is described as two different commands initiating two separate exchanges because while the IKEv2 authentication is required between two Client's before they can exchange data, the exact method of child SA creation may differ depending on the type of devices the Client software is residing on and what type of data may be exchanged. For example, multicast groups of Clients (e.g., a PMU and one or more PDCs) will use the GDOI protocol for creating child SAs.

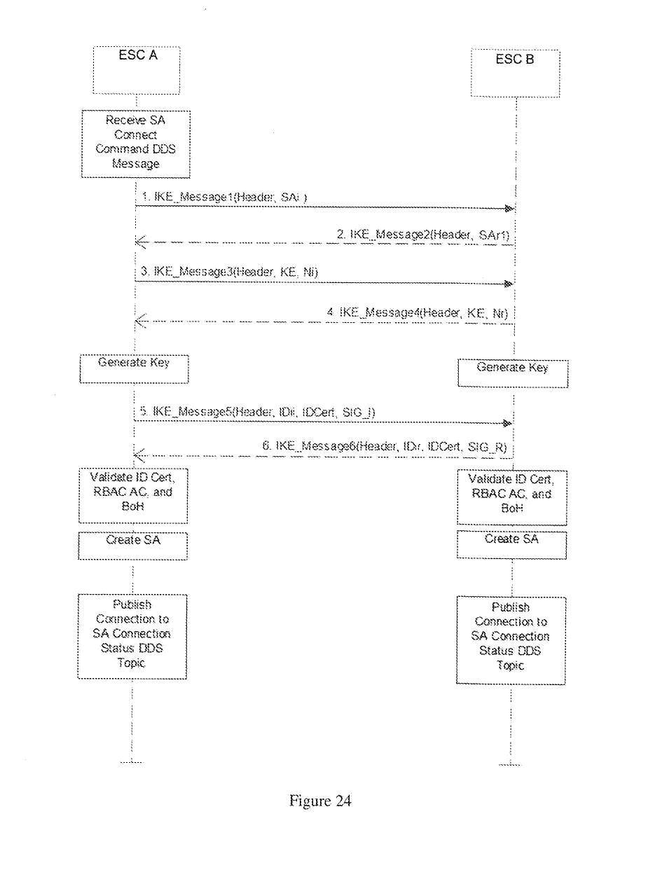

The sequence diagram in FIG. 24 illustrates the Administrator Initiated SA Connect Scenario.

### 1.5.3.5.4.2 Client Boot-Up Configuration Connection Scenario

When a Client boots up, it reads its Community Of Interest (COI) configuration file contains the list of peers that the Client should automatically initiate an IKEv2 authentication and establish a child SAs with. The configuration file will specify what type of child SA creation should take place (e.g. IKEv2 child SA, GDOI).

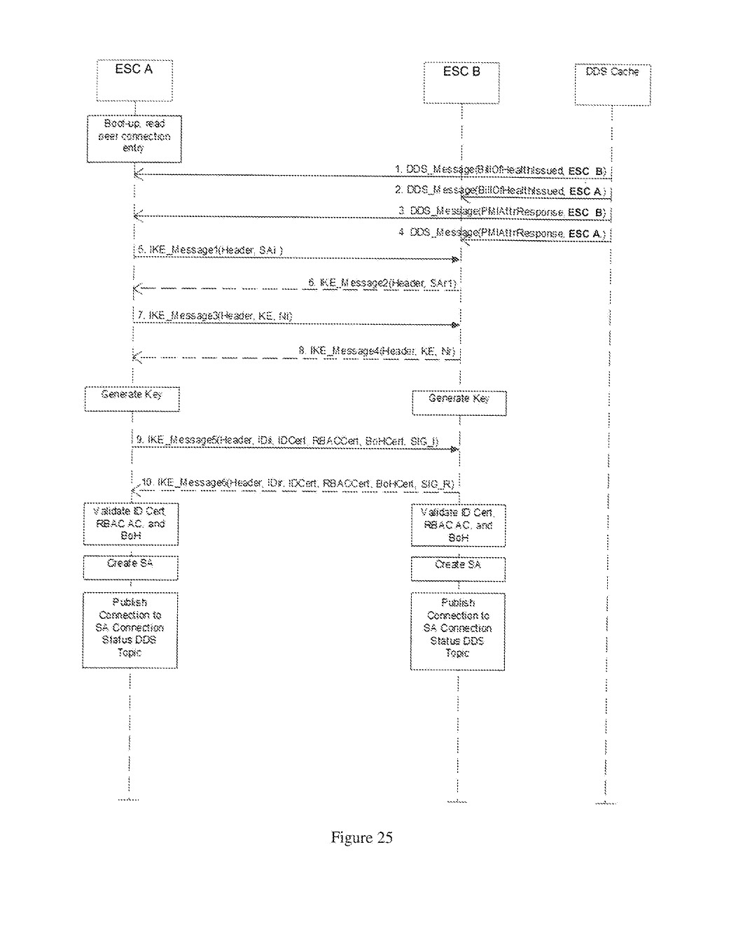

The sequence diagram in FIG. 25 illustrates the Boot-Up Configured SA Connection Scenario which describes IKEv2 authentication with IKEv2 child SA creation.

### 1.5.3.5.4.3 Administrator Initiated Disconnection Scenario

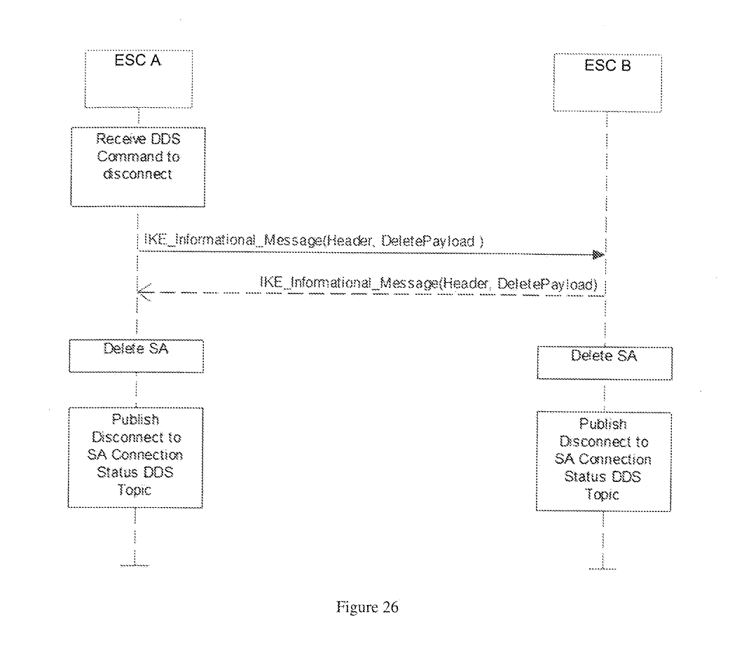

An administrative user can command two Clients to disconnect via the DDS interface by publishing to the SA Connection Command DDS Topic. The sequence diagram in FIG. 26 illustrates the Admin Initiated Disconnection Scenario.

### 1.5.3.5.4.4 Peer Initiated Disconnection Scenario

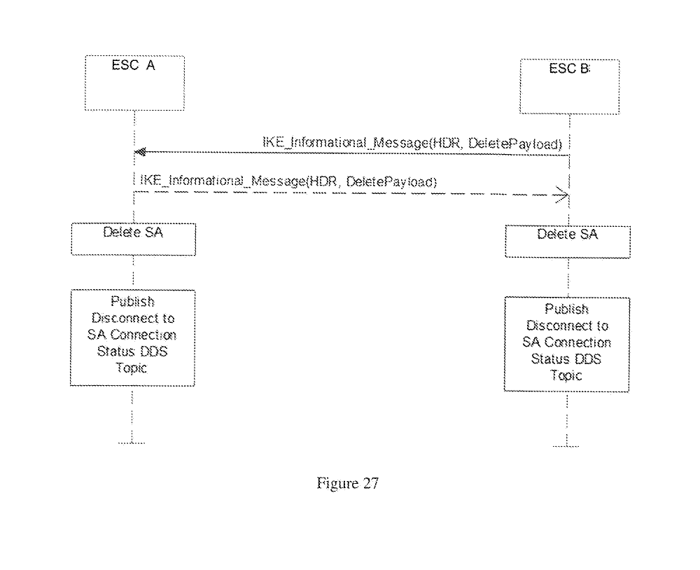

The sequence diagram in FIG. 27 illustrates the Peer Initiated Disconnection Scenario.

### 1.5.3.6 Quality of Trust (QoT)

This section describes the trust information exchanged within the Common Cybersecurity Service network referred to as the QoT capability. It contains important design decisions, a high level design overview, and some low level design details.

### 1.5.3.6.1 Overview

It is important that the Client software and Common Cybersecurity Service network not inhibit the transfer of critical data necessary for proper EPS operation. During a cyber-attack or cyber disaster the security of CCS Clients in certain locations may be lowered, which inversely raises the risk to EPS. In certain cases, Clients under direct attack, may not be able to connect to Central Security Services or Attribute Authorities for extended periods of time and their identity, integrity, and authorization credentials may expire. Also external security alerts may occur that need to be automatically handled by CCS Clients.

In these specific situations, instead of disallowing connections and data transfer between Clients, it is more desirable to allow the connection to be maintained even with the expired credentials or during an undesirable security event. In these cases, the EPS Cyber Systems Application must label (or “tag”) the data with a lower level of trust so that grid protection applications subscribing to that data will be able to incorporate the less trusted data appropriately. This section describes scenarios where QoT changes should be communicated, how QoT changes are communicated, and the associated security notifications regarding QoT changes.

It is important, however, that real cyber-attacks are properly identified and handled in a manner preventing unauthorized access to data. Thus it is necessary to resolve security events in a timely manner regardless of the presence of the QoT capability.

### 1.5.3.6.2 Design Overview

This section provides an overview of the QoT scenarios when data should be labeled, how data will be labeled, and the messages that are exchanged when data needs to be labeled.

### 1.5.3.6.2.1 Methods of Communicating Trust

The SCE Wide Area Situational Awareness (WASAS) Design System Design Document section 3.6.2.3 describes the levels of trust that should be used to label trust:
“Trusted: The data meets all predetermined criteria and is displayed and/or incorporated normally. The operator retains the ability to manually override the decision.
Questionable: The data meets some but not all criteria or falls within a designated window whereupon the WASAS warns the operator of the condition and prompts for data inclusion.
Untrusted: The data fails to meet predetermined criteria and is not displayed or incorporated in calculations. The operator retains the ability to manually override the decision, however the system will indicate it is in an override condition.”

Quality of Trust (QoT) of data is defined in terms of these levels. If the EPS Cyber System Application doesn't have an associated QoT with one of the methods described in this document, it shall be assumed to be trusted. The EPS Cyber System Application will mark data at QoT levels according to the security policy of the Client.

The default policy of the Client will be to communicate QoT as questionable if the peer Client can still be authenticated/authorized but is using an expired key. Any expiration/revocation of credentials or tamper events will cause the peer Client QoT to be communicated as untrusted.

### 1.5.3.6.2.2 QoT Designation

Labeling each data packet could be difficult to implement since all possible types of data that could be transferred in the future cannot be predicted. Thus it is more practical to mark Peer Clients with QoT values. The EPS Cyber System Applications receiving data from those Peer Clients or from hosts/applications behind those Peer Clients, are notified of the level of trust and can mark the data in storage and/or mark data packets within the constraints of their own protocols. This essentially leaves the handling of marked data up to EPS Cyber System Applications. Peer Client QoT changes are communicated up to the EPS Cyber System Applications on the Local Client.

The method of communication between the Client Software and EPS Cyber System Applications on a Client is vendor implementation specific. EPS Cyber System Application(s) needs to be notified of a peer QoT change. The Client software need only publish the information about the peer Client needed for an on-board EPS Cyber System Application to recognize that QoT changed on its data channel and the EPS Cyber System Application can mark its own data and modify its data handling algorithms appropriately.

### 1.5.3.6.2.3 Labeling Individual Messages

EPS Cyber System Applications must implement a way to mark messages in a manner that the relevant applications listening on the other end can process the information.

### 1.5.3.6.2.4 Example Scenario

### Expired Credentials

QoT scenarios are policy-driven and defined by SCE at device deployment time.

The following is an example:

The QoT of a Client is lowered in accordance with policy. If the Client doesn't have connectivity to the CCS RA at the time of certificate expiration, it must still maintain communication with its peers but they will designate a lower QoT in accordance with policy. Also new connections with new peers are allowed but the peers will also designate a lower QoT in accordance with policy. The client should detect it is using an expired identity certificate and lower its own QoT in accordance with policy. If any other credential verification fails, the SAs with peers may be terminated/disallowed in accordance with policy.

The end result is that EPS Cyber System Applications on the client and on peer clients will be notified of the lowered QoT. The CCS administrators will be informed through QoT alerts that the Client and its peers have all lowered QoT because of the expired identity certificate.

The sequence below illustrates IKE authentication with another Client when the credentials of the Client are expired. Credentials of Client are expired upon IKE authentication with another Client:
1. Client A QoT Service registers as a publisher to the Peer Client QoT DDS Topic.
2. Client A EPS Cyber System Application registers as a subscriber to the Peer Client QoT DDS topic.
3. Client A initiates an IKE exchange with Client B.
4. Client B responds with IKE_INIT response.
5. Client A sends credentials in IKE_AUTH message.
6. Client B sends expired credentials in IKE_AUTH response message.
7. Client A calculates a lowered QoT for Client B.
8. Client A publishes the QoT of Client B to the DDS QoT Update topic.
9. Client A EPS Cyber System Application receives the lowered QoT notification and labels data from Client B appropriately.

IKE authentication with expired credentials may happen when two Clients (Client A and Client B) have already established a secure connection and the credentials on one Client (Client B) expire. In this case, Client A must know of Client B's lower QoT and notify the appropriate EPS applications. Client A can't trust Client B to notify it of the lower QoT. So Client A must detect the expired credentials on its own. When the original IKEv2 authentication exchange happens, Clients must store the credentials of their peer and detect when those credentials expire.

### 1.5.3.6.2.5 Example

### Tampered Device

When a device is physically tampered and it has the ability to detect it, it must send a QoT Alert out to DDS.

The sequence below illustrates the process for changing QoT after tamper detection.
1. Client B hardware detects a physical tamper event (case opened).
2. Client B QoT Service publishes the tamper event to DDS.
3. Client A receives the Client B tamper event from DDS.
4. Client A calculates a lowered QoT for its SA with Client B.
5. Client A publishes the QoT update message to DDS.
6. Client A EPS Cyber System Application receives the QoT update event.

### 1.5.3.6.3 Client QoT Responsibilities

Each Client has the following responsibilities:
1. Monitor Peer Clients for QoT events (DDS)
2. Publish QoT Status updates when QoT policy requires a change in QoT for a peer Client (DDS).
3. Send QoT updates to EPS Cyber System Applications (vendor defined)
4. Respond to QoT Override events from CS (DDS)

QoT is primarily associated with a particular Client rather than a data packet. Any data being sent from or through a Client is considered to have the same QoT as that of the sending Client. The Client receiving data is responsible for maintaining a list of QoT values of its peers and notifying resident EPS Cyber System Applications of the QoT of the peer Clients.

### 1.5.3.7 Group Multicast Communications with GDOI

The Internet Security Association and Key Management Protocol (ISAKMP), GDOI, Logical Key Hierarchy (LKH) and IKEv1 standards are required and the design decisions derived from each are discussed below. The IEC 61850-90-5 specification is also required and its use of the Group Domain of Interpretation (GDOI) protocol is also analyzed.

### 1.5.3.7.1 Overview

In the near term, Group keying is used to protect the transmission of synchrophasor information according to IEC 61850-90-5 from senders to receivers. In this system the senders are Phasor Measurement Units (PMUs) and the receivers can be any interested group member (e.g. Phasor Data Concentrators (PDCs), data historians, relay supervisor, etc.).

The Group Key Distribution Center (GKDC) is the group manager and controls the following functions:
Group setup
Group keying (including re-key)
Group member expulsion
Group teardown

In this system there is one GKDC (not counting redundant locations).

When an IED integrated with Edge Security Services is in the “Trusted” mode (see paragraph 1.4.2) it is able to establish an IKEv2 SA with the Integrity Management Authority (IMA). Key exchange, authentication, identification, integrity, and permissions are negotiated during this SA establishment. This SA must be in place to proceed with group key management. See section 1.5.3.5 Cryptographic Enforcement with IKE.

A group is created when the first Client requests membership from the GKDC. This Client may be the PMU data sender or it may be a PMU data receiver. Both the Client and the GKDC will establish SAs with each other using IKEv1 (chosen to meet the IEC 61850-90-5 specification).

Group identifiers, multicast IP addresses, memberships and permissions are all preplanned. Note that support may be needed for Internet Group Management Protocol (IGMP3) for initiating multicast routing infrastructure support when multicast groups are started. Support for IGMP, GRE Tunnels, MPLS, and other infrastructure protocols in support of multicast is vendor specified

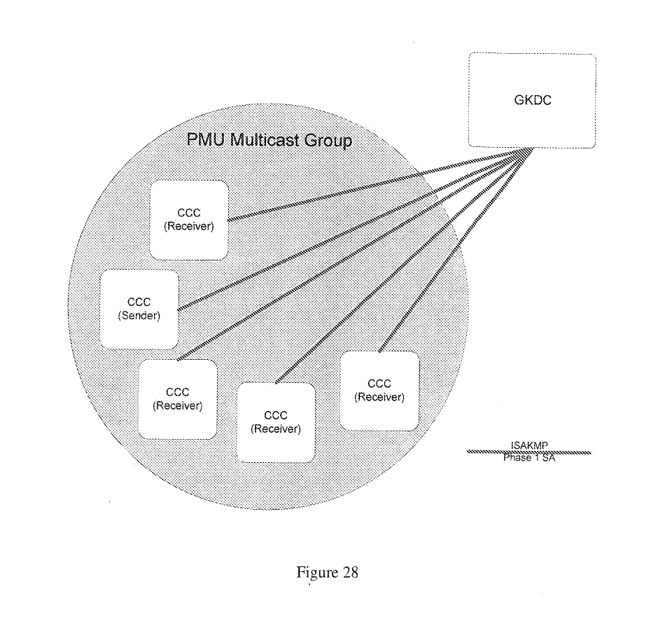

The diagram in FIG. 28 illustrates Parent SA connection between the Clients and the GKDC.

Each PMU that sends data will cause the creation of a new group. Thus for each sending PMU there exists a corresponding preplanned group. A Client may be a member of multiple groups (e.g. sending to one group, receiving on several others).

Once the Parent SA is established, two additional IKEv1 Phase 2 SAs will be established using the GDOI protocol. The first GDOI SA is for the protection of key/re-key data. This is a two-way SA between the Client and the Group Key Distribution Center (GKDC) that is used for GROUPKEY-PUSH/GROUPKEY-PULL GDOI messages. The second GDOI SA is for protection of group data. This is a one-way SA established by the Client with the multicast group.

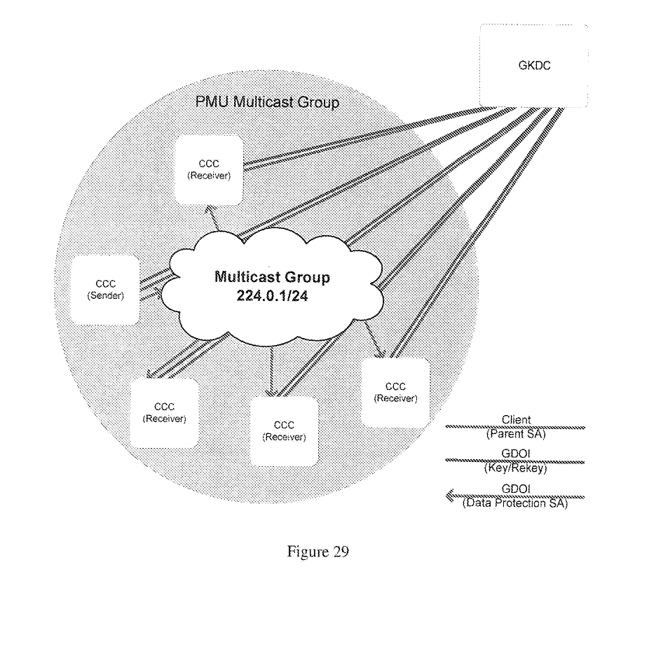

The diagram in FIG. 29 illustrates Parent SA, GDOI Key/Re-Key SA, and the GDOI Data-Protection SA connection between the Clients and the GDC, all SAs are in place and the system is ready to pass multicast traffic.

### 1.5.3.7.2 Document Mapping

The following diagrams show how the group key management documentation relates to each other.

### 1.5.3.7.2.1 IEC 61850-90-5 Related

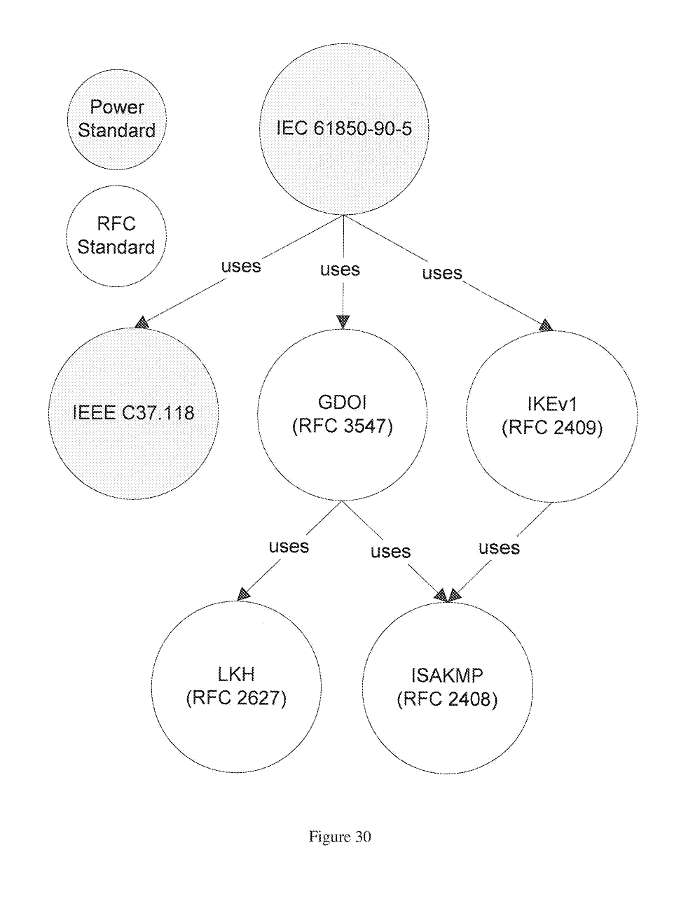

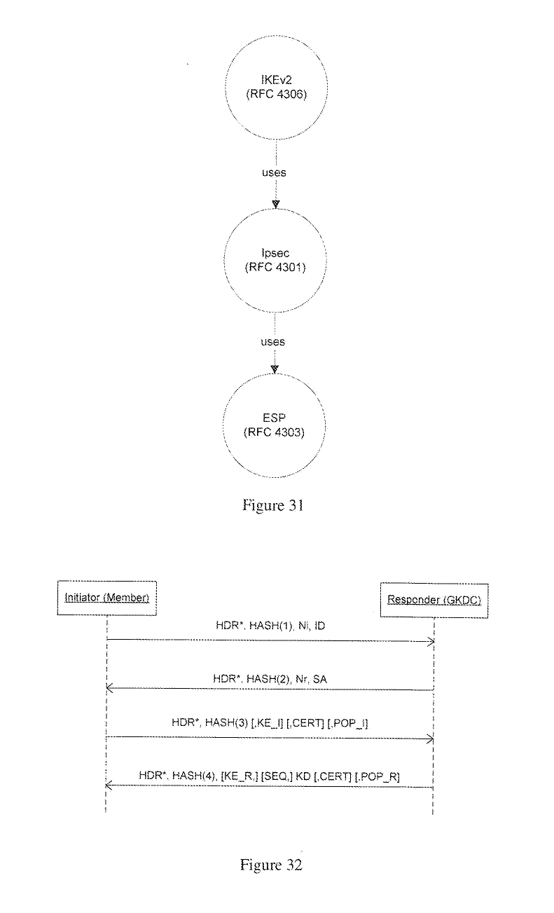

FIG. 30 illustrates the relationships between IEC 61850-90-5 and the standards it is dependent upon.

### 1.5.3.7.2.2 IKEv2 Related

### 1.5.3.7.3 Group Key Generation

As per IEC 61850-90-5 section 10.1.1.2.3.3 (Table 0-10):
The Security Algorithms field is a two (2) octet field. The most significant octet shall be reserved to indicate the type of encryption provided.

TABLE 0-10
IEC 61850-90-5 Security Algorithms

| | | National Institute of |
|---|---|---|
| | | Standards and |
| | | Technology |
| | Key Size | (NIST) SP 800-131A |
| Algorithm | in Bits | Recommendation |
| AES-128 Encryption and Decryption | 128 | Acceptable |
| AES-256 Encryption and Decryption | 256 | Acceptable |

### 1.5.3.7.3.1 Terminology

The terms “approved”, “acceptable”, “deprecated”, “restricted” and “legacy-use” are used throughout this recommendation and are defined as follows:
14. Approved is used to mean that an algorithm is specified as recommended by FIPS or NIST.
15. Acceptable is used to mean that the algorithm and key length is safe to use; no security risk is currently known.
16. Deprecated means that the use of the algorithm and key length is allowed, but the user must accept some risk. The term is used when discussing the key lengths or algorithms that may be used to apply cryptographic protection to data (e.g., encrypting or generating a digital signature).
17. Restricted means that the use of the algorithm or key length is deprecated, and there are additional restrictions required to use the algorithm or key length for applying cryptographic protection to data (e.g., encrypting).
18. Legacy-use means that the algorithm or key length may be used to process already protected information (e.g., to decrypt ciphertext data or to verify a digital signature), but there may be risk in doing so. Methods for mitigating this risk should be considered.

### 1.5.3.7.3.2 HMAC Functions

As per IEC 61850-90-5 section 10.1.1.2.5:

The allowed HMAC functions are: HMAC-SHA1, HMAC-MD5, HMAC-SHA256, and HMAC-SHA3.

Additionally, the calculated HMAC value may be truncated, per RFC 2104 (HMAC). The allowed truncations are 80, 128, and 256 bits.

Therefore, the HMAC enumerated values, used in the Security Algorithm field shall be as defined in Table 0-11.

TABLE 0-11
IEC 61850-90-5 HMAC Functions

| Enumer- | | Number of | | Mandatory |
|---|---|---|---|---|
| ation | HMAC | HMAC | IEC 61850-90-5 | (m), |
| Value | Algorithm | bits | Designation | Optional (o) |
| 0 | None | None | HMAC-None | c1 |
| 1 | MD5 | 80 | HMAC-MD5-80 | c1 |
| 2 | MD5 | 128 | HMAC-MD5-128 | c1 |
| 3 | MD5 | 256 | HMAC-MD5-256 | c1 |
| 4 | SHA-1 | 80 | HMAC-SHA1-80 | c1 |
| 5 | SHA-1 | 128 | HMAC-SHA1-128 | c1 |
| 6 | SHA-1 | 256 | HMAC-SHA1-256 | c1 |
| 7 | SHA-256 | 80 | HMAC-SHA256-80 | m |
| 8 | SHA-256 | 128 | HMAC-SHA256-128 | m |
| 9 | SHA-256 | 256 | HMAC-SHA256-256 | m |
| 10 | SHA3 | 80 | HMAC-SHA3-80 | c2 |
| 11 | SHA3 | 128 | HMAC-SHA3-128 | c2 |
| 12 | SHA3 | 256 | HMAC-SHA3-256 | c2 |

c1—Cryptographically weak and therefore prohibited from use for Common Cybersecurity Services
c2—Provided for future use.

As per NIST SP 800-131A section 10 (Table 0-12):

TABLE 0-12
NIST SP 800-131A Message Authentication Codes

| MAC Algorithm | Use | |
|---|---|---|
| HMAC Generation | Key lengths ≧80 bits and | Prohibited from |
| | <112 bits | use for Common |
| | | Cybersecurity Services |
| | Key lengths ≧112 bits | Acceptable |
| HMAC Verification | Key lengths ≧80 bits and | Prohibited from |
| | <112 bits | use for Common |
| | | Cybersecurity Services |
| | Key lengths ≧112 bits | Acceptable |

### 1.5.3.7.3.3 Signature Hash Algorithm

Table 0-13 identifies the Signature Hash Algorithms for IEC 61850-90-5.

TABLE 0-13
IEC 61850-90-5 Signature Hash Algorithms

| SHA | | IEC 61850-90-5 |
|---|---|---|
| Algorithm | Number of SHA bits | Designation |
| SHA-1 | 160 | SIG_HASH_SHA1 |
| SHA-256 | 256 | SIG_HASH_SHA256 |

As per NIST SP 800-131A section 9 (Table 0-14):

TABLE 0-14
NIST SP 800-131A Hash Functions

| MAC | | |
|---|---|---|
| Algorithm | Use | |
| SHA-1 | Digital signature | Prohibited from use for Common |
| | generation | Cybersecurity Services |
| | Digital signature | Prohibited from use for Common |
| | verification | Cybersecurity Services |
| | Non-digital signature | Prohibited from use for Common |
| | generation applications | Cybersecurity Services |

| | |
|---|---|
| SHA-256 | Acceptable for all hash function applications |
| SHA-384 | |
| SHA-512 | |

### 1.5.3.7.3.4 Group Domain of Interpretation (GDOI) RFC 3547

GDOI is an ISAKMP Domain of Interpretation (DOI) for group key management to support secure group communications. GDOI is a group security association (SA) management protocol. All GDOI messages are used to create, maintain, or delete SAs for a group.

GDOI is defined as a Phase 2 protocol (i.e. an exchange on top of a Phase 1 SA) and must be protected by a Phase 1 SA. This Phase 1 protocol must provide for the following protection: peer authentication, confidentiality, message integrity. In the SCE smart grid system the Phase 1 SA will be formed using IKEv1.

### 1.5.3.7.3.5 GDOI Profile

This section describes the design decisions that were made based upon the RFC 3547 (GDOI).

### Message Support

GDOI extends ISAKMP with six new payloads (Table 0-15):

TABLE 0-15
GDOI Payloads

| Payload | Shortened | |
|---|---|---|
| Type | Name | Description |
| GDOI SA | N/A | Security Association for GDOI. |
| SA KEK | SAK | Contains security attributes for the Key |
| | | Encryption Key (KEK) method for a group and |
| | | parameters specific to the GROUPKEY-PULL |
| | | operation. |
| SA TEK | SAT | Contains security attributes for a single Traffic |
| | | Encryption Key (TEK) associated with a group. |
| Key | KD | Contains group keys for the group specified in the |
| Download | | SA Payload. Note that this payload may also be |
| Array | | used to send an LKH array (see RFC 3547 |
| | | (GDOI) section 5.5.3). |
| Sequence | SEQ | Provides an anti-replay protection for |
| Number | | GROUPKEY-PUSH messages. |
| Proof of | POP | This PDU is sent to prove that the imitator |
| Possession | | contains the private key associated with a |
| | | public certificate held by the receiver. |

GDOI extends ISAKMP with two new exchanges:
1. GROUPKEY-PULL. An exchange that creates Re-key and Data-Security protocol SAs. This exchange is initiated by the group member.
2. GROUPKEY-PUSH. A datagram that subsequently establishes additional Re-key and/or Data-Security Protocol SAs. This exchange is initiated by the GKDC. Note that the GROUPKEY-PUSH message is not supported (i.e. “out of scope”) in the 61850-90-5 specification.

The GDOI SA, SAK, SAT and KD payloads must be supported. The SEQ payload is required if we want to support the GROUPKEY-PUSH exchange. The POP payload is required if we want to support authentication through the use of public key cryptography.

### 1.5.3.7.3.6 GROUPKEY-PULL Exchange

Several items related to the GROUPKEY-PULL exchange are discussed in following paragraphs.

### Authorization

RFC 3547 (GDOI) section 3.1 states:
“There are two alternative means for authorizing the GROUPKEY-PULL message. First, the Phase 1 identity can be used to authorize the Phase 2 (GROUPKEY-PULL) request for a group key. Second, a new identity can be passed in the GROUPKEY-PULL request.”

As there is currently no need for a separate Phase 2 identity, this system will use the first option. The initial IKEv2 Parent SA has an established quality of trust associated with it. This established identity will be used with the GDOI Phase 1 IKEv1 SA.

### Support

IEC 61850-90-5 section 7.2 states:
1. “The KDC shall support clients requesting keys as opposed to publishing keys to an established group. The ability to publish the keys to a key group is out-of-scope of this specification.”

This implies that the GROUPKEY-PUSH exchange is not required. However, in order to use a hierarchical tree approach the GROUPKEY-PUSH exchange must be supported. Therefore in our system we will provide support for GROUPKEY-PUSH in anticipation of this being included in a later version of 61850-90-5.

### Messages

The sequence diagram (FIG. 32) describes a GROUPKEY-PULL exchange.

Table 0-15 is a key to the sequence in FIG. 32.

TABLE 0-16
GROUPKEY-PULL Exchange Sequence Diagram Key

| Term | Definition |
|---|---|
| * (asterisk) | When an asterisk is present all content in the PDU to the |
| | right of the asterisk is protected by the Phase 1 SA. |
| HDR | ISAKMP header payload that uses Phase 1 cookies and |
| | a message identifier (M-ID) as in IKEv2. |
| HASH | ISAKMP Hash payload |
| Ni, Nr | ISAKMP Initiator and Responder Nonce payload |
| | respectively |
| ID | GDOI Identification payload |
| SA | GDOI Security Association payload |
| KE | Key exchange payload (KE_I means initiator KE, KE_R |
| | means responder KE) |
| CERT | ISAKMP certificate payload |
| POP | GDOI Proof of possession payload (POP_I means initiator |
| | POP, POP_R means responder POP) |
| SEQ | GDOI Sequence payload |
| SKEYID_a | The “key” in the keyed hash used in HASH payloads. |
| | It is derived according to IKEv2 |

RFC 3547 (GDOI) section 3.2 states:
The GCKS returns only the SA policy payload before liveliness is proven. The HASH payloads prove that the peer has the Phase 1 secret (SKEYID_a) and the nonce for the exchange identified by message id, M-ID. Once liveliness is established, the last message completes the real processing of downloading the KD payload.

### 1.5.3.7.3.7 Perfect Forward Secrecy

RFC 3547 (GDOI) section 3.2.1 states:

If Perfect Forward Secrecy (PFS) is desired and the optional KE payload is used in the exchange, then both sides compute a DH secret and use it to protect the new keying material contained in KD.

PFS refers to the notion that compromise of a single key will permit access to only data protected by a single key. For PFS to exist the key used to protect transmission of data must not be used to derive any additional keys. IKEv1 can provide PFS for both keys and identities.

RFC 2409 (IKEv1) section 8 states:
To provide Perfect Forward Secrecy of both keys and all identities, two parties would perform the following:
19. A Main Mode Exchange to protect the identities of the ISAKMP peers. This establishes an ISAKMP SA.s
20. A Quick Mode Exchange to negotiate other security protocol protection. This establishes a SA on each end for this protocol.
21. Delete the ISAKMP SA and its associated state.

RFC 3547 (GDOI) section 4.1 discusses PFS by using the GROUPKEY-PUSH message: The GROUPKEY-PUSH message is protected by the group KEK though in all cases, the GROUPKEY-PUSH message carries new key downloads, among other information. A freshly generated secret must protect the key download for the GROUPKEY-PUSH message to have PFS.

### 1.5.3.7.3.8 Initiator Operations

RFC 3547 (GDOI) section 3.3 states:
Before a group member (GDOI initiator) contacts the GCKS, it must determine the group identifier and acceptable Phase 1 policy via an out-of-band method such as SDP (Session Description Protocol).

Group identification and Phase 1 policy will be contained in configuration files. These configuration files will be placed during provisioning or under carefully controlled conditions (i.e. re-provision).

### 1.5.3.7.3.9 GROUPKEY-PUSH Exchange

Several items related to the GROUPKEY-PUSH exchange are discussed below.

### Messages

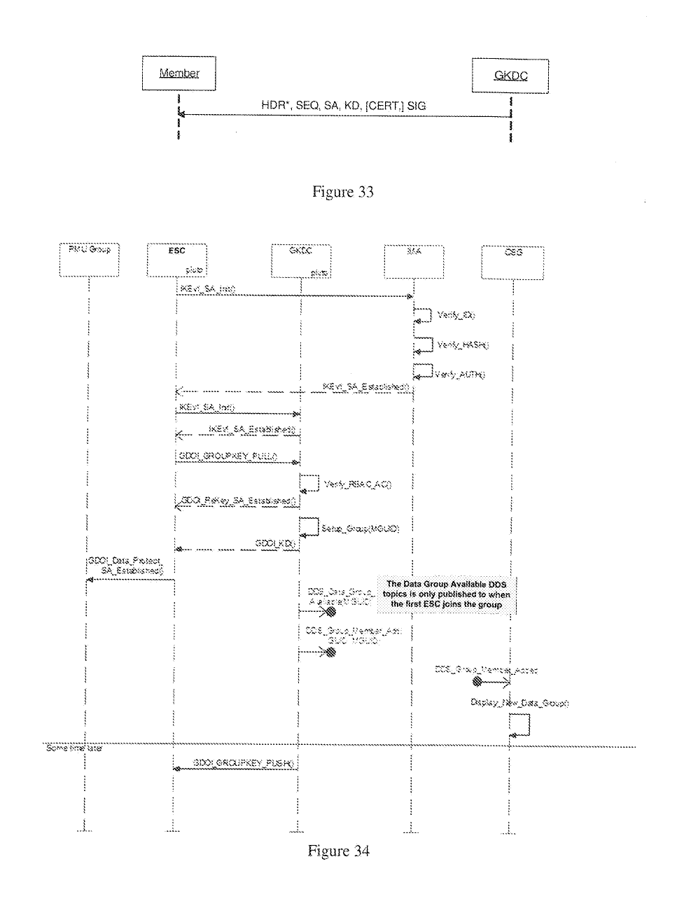

The FIG. 33 sequence diagram describes a GROUPKEY-PUSH exchange. Since GDOI runs over UDP this message should be repeated several times in order to ensure delivery.

FIG. 33 is the Exchange Sequence Diagram Key for the GDOI GROUPKEY-PUSH.

TABLE 0-17
GDOI GROUPKEY-PUSH Exchange Sequence Diagram Key

| | |
|---|---|
| Term | Definition |

| | |
|---|---|
| * (asterisk) | When an asterisk is present all content in the PDU to the |
| | right of the asterisk is protected by the Re-key SA KEK. |
| HDR | ISAKMP header payload that uses Phase 1 cookies and |
| | a message identifier (M-ID) as in IKEv2. |
| SEQ | GDOI Sequence payload |
| SA | GDOI Security Association payload |
| KD | Key Download Array payload |
| CERT | ISAKMP Certificate payload |
| SIG | ISAKMP Signature payload. This is a hash of the entire |
| | message before encryption (including the header and |
| | excluding the SIG payload itself), prefixed with the |
| | string “rekey”. |

### Forward and Backward Access Control

RFC 3547 (GDOI) section 4.2 states:
Through GROUPKEY-PUSH, the GDOI supports algorithms such as LKH that have the property of denying access to a new group key by a member removed from the group (forward access control) and to an old group key by a member added to the group (backward access control).

Forward and backward access control can be supported by LKH. RFC 3547 (GDOI) section 4.2.1 discusses how forward access control may be obtained through the use of a combination of GROUPKEY-PUSH messages. Backward access control is accomplished by re-key upon a group join. Forward access control is a requirement.

### Delegation of Key Management

Delegation of key management is not supported in this system. If connectivity to the GKDC is lost, new key members will not be able to join and existing members must keep using the same key regardless of its expiration status.

### Security Association Payload

The SA payload is always followed by additional payloads that define specific security association attributes for the KEKs and/or TEKs. There may be zero or one SAK Payloads, and zero or more SAT Payloads, where either one SAK or SAT payload must be present. The maximum number of SAK/SAT payloads that may follow an SA payload is one of each.

### SA TEK (SAT) Payload

The last field in the SAT payload is called “TEK Protocol-Specific Payload”. RFC 3547 (GDOI) section 5.4.1 defines a payload for use in this field called PROTO_IPSEC_ESP. This payload will be used for data transfer.

### GDOI LKH Payload

RFC 35447 (GDOI) section 5.5.3.1 describes the format of a LKH key payload. This payload contains two time related fields labeled “Key Creation Date” and “Key Expiration Date”. They are described as follows:
Key Creation Date—This is the time value of when this key data was originally generated. A time value of zero indicates that there is no time before which this key is not valid.
Key Expiration Date—This is the time value of when this key is no longer valid for use. A time value of zero indicates that this key does not have an expiration time.

In this system a time value of zero is not valid for either of these fields.

### 1.5.3.7.4 Logical Key Hierarchy (LKH)

LKH is an NSA developed protocol for the management of group keys. LKH focuses on solving two main areas of concern with respect to key management; initializing the multicast group with a common net key and rekeying the multicast group. LKH balances the costs of time, storage and number of required messages for rekey.

RFC 3547 (GDOI) was written with LKH in mind for the group key management. It is referenced in several places and there is a LKH download type for the key download payload. The LKH download type is further dived into several subtypes that allow the group key manager to:
Download a set of keys to a group member
Update keys for the group
Distribute the public key for the Security Parameter Index (SPI)(useful if no PKI is available)

This LKH oriented built in functionality allows a GDOI/LKH implementation to:
Distribute group keys
Secure removal of a compromised Client device from the multicast group
Re-key the CCS network to re-establish security
Limit the scope of a re-key
Perform well in a large group

### 1.5.3.7.4.1 Storage

The storage requirement for each user and the transmissions required for key replacement are both logarithmic in the number of users, with no background transmissions required.

### 1.5.3.7.4.2 Legacy Compatibility

GDOI defines support for LKH; however IEC 61850-90-5 currently does not. The need to support legacy devices that do not support LKH is vendor-specified.

In the event that a legacy IEC 61850-90-5 compliant device is present, LKH will not be used. Instead a flat group structure will be in place. If a group member leaves data loss may occur during group tear down and re-establishment.

### 1.5.3.7.4.3 LKH Profile

This section describes the design decisions that were made.

### Disparate Processing Abilities

We must take into account the case where PMUs may have vastly differing processing power. By issuing key updates a specific amount of time before the key expiration date of the current key we can minimize risk of data loss during key rollover.

GROUPKEY-PUSH re-key messages will be sent out by the GKDC no later than 48 hours before the key expiration date.

### 1.5.3.7.4.4 Failure Cases

In the scenario where a single group member fails to re-key that group member shall attempt to rejoin the group.

### 1.5.3.7.5 Low Level Design—SA Establishment

The Phase 1 ISAKMP SA is established using main mode, as aggressive mode does not support identity protection. The Phase 2 GDOI re-key and data protection SAs is established using the exchanges defined in RFC 3547 (GDOI).

Note that GROUPKEY-PUSH messages use the previously established Phase 2 GDOI re-key SA.

### 1.5.3.7.6 Low Level Design—SA Re-Key

When an SA has only a bit of lifetime left, the Client will initiate the creation of a new SA. This applies to ISAKMP and GDOI SAs.

The Client will not rekey an SA if that SA is not the most recent of its type (GDOI or ISAKMP) for its connection. This avoids creating redundant SAs.

### 1.5.3.7.7 Policy Notes

The PMU data packet size is 110 bytes as per section 5.5.2 of the WASAS System Design Document. The desired future reporting frequency is 120 times per second. Therefore the number of bytes per second is:

110*120=13,200 bytes per second
The number of 128 bit AES blocks generated would be:

13,200/16[128 bits]=825 blocks per second
Thus, the counter will increment 825 times per second.

Table 0-18 provides a list of overflow values dependent on the size of the counter bits.

TABLE 0-18
AES Counter Overflow Based on Number of Counter Bits

| Counter | Counter Overflow |
|---|---|
| Bits | Time |
| 20 | 21 m 10 s |
| 21 | 42 m 22 s |
| 22 | 1 h 24 m 43 s |
| 23 | 2 h 49 m 28 s |
| 24 | 5 h 38 m 55 s |
| 25 | 11 h 17 m 52 s |
| 26 | 22 h 35 m 43 s |
| 27 | 1 d 21 h 11 m 28 s |
| 28 | 3 d 18 h 22 m 56 s |
| 29 | 7 d 12 h 45 m 52 s |

### 1.5.3.7.8 GDOI Use Cases

The following sections describe several group key management related use cases.

### 1.5.3.7.8.1 PMU Multicast Group Member Add (GDOI)

This section describes the process of adding a new group member.

The following DDS Topics are involved in the PMU Multicast Group Member Add process:
Group Available—Used by the first Client to join the group to inform the GKDC and other potential group members that this group is now available.
Group Member Added—Used by the GKDC to notify the CSG and other group members that a member has been added to a group.

Note that the group is created when the first PMU requests to join the group.

The diagram in FIG. 34 illustrates the PMU Multicast Group Setup process.

### 1.5.3.7.8.2 PMU Multicast Group Member Eviction (GDOI)

This section describes the process of evicting a group member.

The following DDS Topics are involved in the PMU Multicast Group Eviction process:
Group Member Evict Request—Used by the CSG to inform the GKDC and group members that a group member needs to be evicted from a specific group.
Group Member Evicted—Used by the GKDC to inform the CSG and others group members that a group member has been evicted from a specific group.

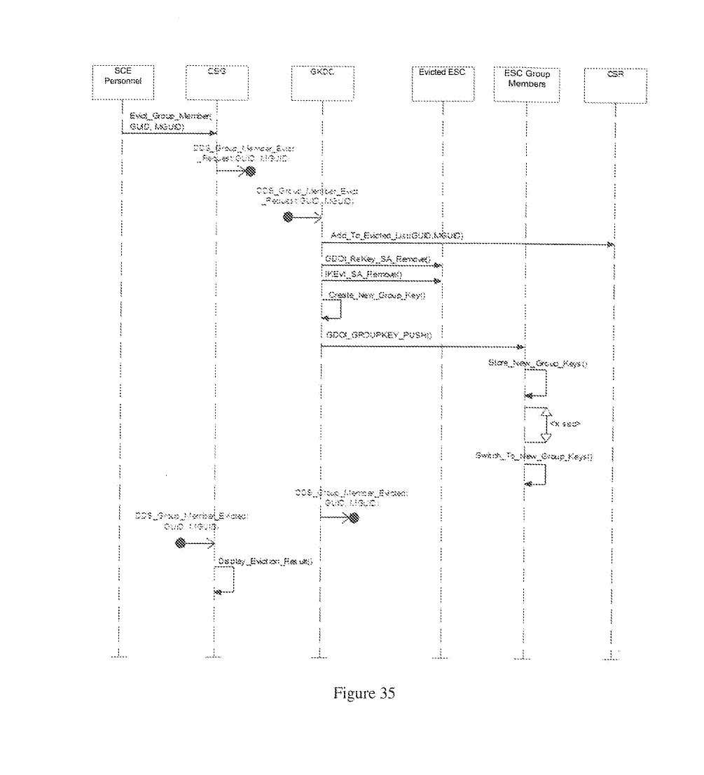

The diagram in FIG. 35 illustrates the PMU Multicast Group Member Eviction process.

### 1.5.3.8 Data Distribution Service (DDS)

The Control Plane communications between Central Security Services and the Clients in the field all take place over Data Distribution Service (DDS). DDS is an Object Management Group (OMG) standard. The Client uses DDS to communicate status information to the Central Security Services and receive control commands from Central Security Services.

### 1.5.3.8.1 Overview

The Control Plane Data Distribution Service is responsible for the following types of information referred to as Topics (Table 0-19).

TABLE 0-19
DDS Topics

| Category | Topic | Purpose |
|---|---|---|
| Status | QoTStatus | Provides the QoT Status of the Client |
| | GridAppQoTStatus | Provides the QoT Status of the Grid Application |
| | IDCertQoTStatus | Provides the Status of the Identity Certificate for |
| | | a Client |
| | SAConnectionStatus | Provides the Status of the SA Connection for a |
| | | Client |
| | GroupMemberStatus | Provides the Group Member Status of the a |
| | | Client |
| Alerts | AletMsg | Encapsulate data corresponding to events |
| | | requiring immediate attention |
| Logs | LogMsg | This is data received from monitoring all |
| | | software components; this information is |
| | | collected for forensic purposes and does not |
| | | require immediate action. |
| Certificate | PKIMessage | Defines a DDS topic used by the system to |
| Management | | communicate PKI messages. |
| Secure | SAConnectionCommand | Performs IKEv2 session handshake with DDS as |
| Connectivity | | transport. DDS' discovery semantics will help |
| | | decentralize SA establishment. |
| Trust Anchor | TAMPMessage | Defines a DDS topic used by the system to |
| Management | | communicate TAMP Requests. |
| | TAMPResponse | Defines a DDS topic used by the system to |
| | | communicate TAMP Responses. |
| System | Pulse | |
| Health | GKDCHeartBeat | |
| Group | GroupMemberEvictReq | Request from Central Services to the GKDC to |
| Management | | evict a Client from a GDOI group. |
| Client | NETCONF RPC | NETCONF RPC commands from the Central |
| Configuration | Command | Security Configuration Manager to Clients |
| | NETCONF RPC | NETCONF RPC responses from Clients to the |
| | Response | Central Security Configuration Manager |
| Integrity | Reattest | Request from the IMA to Clients to perform |
| Management | | integrity attestation. |
| | BillOfHealthIssued | Messages containing Client BoH that are |
| | | published to the system at large. |

### 1.5.3.8.2 DDS Technology Overview

DDS is a collection of technologies and conventions used to create a data-centric publish/subscribe global data system. The data systems are encapsulated in a domain. The domain can contain any number of participants, readers, writers, topics, and data types. Collections of a type of data are called Topics. The domain participant can instantiate readers and writers to interact with topics. Readers can distribute quality of service needs to enforce latency and filtering based on data properties. Data in DDS, often referred to as a sample, is represented by a pair of identifiers, (key, instance). The key designates a source of data, for example, a particular Client. The instance designates the unique sample.

The DDS protocol specifies both API and data interchange wire protocol. The API supports programming languages such as C, C++, and Java. The wire protocol is a collection of both the Real-Time Publish Subscribe protocol (RTPS) and the Common Data Representation (CDR) standard. RTPS allows for a variety of transports. UDP is currently the only standardized transport. DDS middleware vendors support shared memory, TCP, as well as proprietary hardware based transports. The transport mechanism is used to enable both participant discovery and data exchange. The DDS standard specifies built-in readers and writers used to publicize presence and available data. The built-in entities can be overridden to modify the discovery feature.

### 1.5.3.8.2.1 Data Centricity

Application programmers interact with the global data system using a local cache. Data samples are placed in or appear in the cache, each associated with either a publisher or a subscriber. The cache is strongly typed and enforced by DDS. Data types can be arbitrarily complex using the following: structures, unions, enumerables, strings, sized numbers among others. The CDR format takes care that endianness is translated across platforms.

Once a sample is placed in the cache the data is distributed per the quality of service settings—from the writers perspective there is no guarantee that data is immediately sent to readers. The readers can read from their cache using arbitrarily complex SQL queries to filter out unwanted messages. Depending on the middleware implementation, these filters can be distributed to writers. This improves the efficiency of the system by only sending requested data to readers.

The ability to delete data is a fundamental discriminator in DDS vs. all other architectures. Other architectures are treated as conduits for data, whereas DDS is a data space.

### In Comparison: Message Oriented Architectures

DDS is not a message-oriented architecture. Message-oriented architectures route data from publisher to subscriber by using header information through any number of brokers. The data of the messages is opaque and ignored by the messaging architecture. Examples of such systems are the Java Messaging System (JMS) and the Advanced Message Queuing Protocol (AMQP). Because brokers are required to pass messages between participants they become a single point of failure. There is no concept of data filtering at the middleware layer—all filtering must be performed by applications.

### 1.5.3.8.2.2 Domain Segmentation

A DDS domain is segmented to allow strict separation of domain participants. The domain scheme maps a positive integer identifier to a UDP port range. Two different domain IDs will never overlap unless they vary in port determination schemes. The domains will never exchange end-point information because those discovery points will be different.

### 1.5.3.8.2.3 Data Versioning

Over the life of the system we will see the evolution of data types to support new functionality or modifications to existing functionality. To support this operation we will look to version the data at the system level. A domain, in its entirety, will be limited to using strict representations of pre-determined data. Essentially, the Interface Definition Language (IDL) derived for meeting the functional requirements of CCS will become the data standard.

Compatibility of data will be managed at an operations level. Devices with newer capabilities will be added to a new, unused domain, which can operate transparently and safely in parallel to an existing domain. CCS will contain functional bridges between domains—allowing operators to migrate as necessary. This design decision will greatly simplify Client design as all data is assumed to be strict, valid, and operational under the pre-determined semantics.

### 1.5.3.8.2.4 Quality of Service

The DDS standard provides data durability and timeliness settings. The durability settings control how long data remain in the cache and the semantics for sending data to late-joiners. The timeliness settings control how often data will be sent to participants. These settings can be set programmatically by the API programmer, or as a better practice, they can be loaded from XML files outside of any executable. The QoS settings give control to the system operators by giving fine-grained control to the DDS semantics independently from the Client logic.

The DDS API provides a suite of callbacks for handling QoS failure situations. The Client must provide callbacks to handle the arrival of new participants, QoS mismatches, and latency contract failures, among others. Please refer to the OMG DDS documentation for a full list of life-cycle support.

### 1.5.3.8.3 IPSec Transport Mode Security for DDS

The Client Identity Certificate is used to authenticate IPSec transport mode security associations. Authentication is bi-directional, so a Client must be provisioned with a valid signed identity certificate, private key, and valid trust anchors before it can participate on the DDS (Interface SCI-02). Publish authorization is handled at a higher layer as specified in the next section.

### 1.5.3.8.4 Publish Authorization Layer for DDS

Certain DDS topics are signed by the publisher. The Client should check that the identities of publishers of signed topics either 1) match the identity given in the topic data (ex: a Client publishes a tamper alert about itself) or that the identity appears in a configuration file list of authorized publishers for that topic.

### 1.5.3.9 Audit

The following paragraphs define the requirements for generation and delivery of events, alarms, and time stamps; generation of security audit records, and protection of security audit records.

The system requirements are briefly presented, the Syslog standard is used over the DDS protocol for the overall logging system.

### 1.5.3.9.1 Overview

The Security Information Event Management (SIEM) system is used to track all events regarding the participants of the CCS network. All sessions are logged while more severe alerts will generate audits. These logs and audits will be persisted using the standard Syslog format. In this system, each Client is a sender and the SIEM is a receiver of logging information. The DDS protocol will be used to transport all logs and audits.

The logs will be transported on a low priority DDS Topic while the alerts and audits will be transported on a high priority DDS topic. The higher priority of alerts and audits will be enforced through strong QoS settings for latency guarantees and higher durability.

### 1.5.3.9.2 SIEM Architecture

All required Client and CCS operational activity, alert information, and audit logs will be recorded by SIEM. Two DDS topics will be created, hereafter referred to as LOG and ALERT. The LOG topic will be used only for activity logs; the ALERT topic will be used only for alert data. Readers on either the ALERT or the LOG topic may utilize content filters to receive only desired information.

A Client would be concerned with monitoring its own internal software components and logging them to a DDS Publisher on the Client. This DDS implementation is vendor specified.

### 1.5.3.9.2.1 Overall Connection Setup

Log data contains the following information:
Audits generated by security alerts
Component-specific information
Generation timestamps
Network participant identifier

Several functions within a Client can generate audit messages and alerts may also generate audits. When an alert is sent out over DDS, an audit appears in the Syslog trail so it actually appears in both the LOG and ALERT DDS topic, just more quickly in the ALERT.

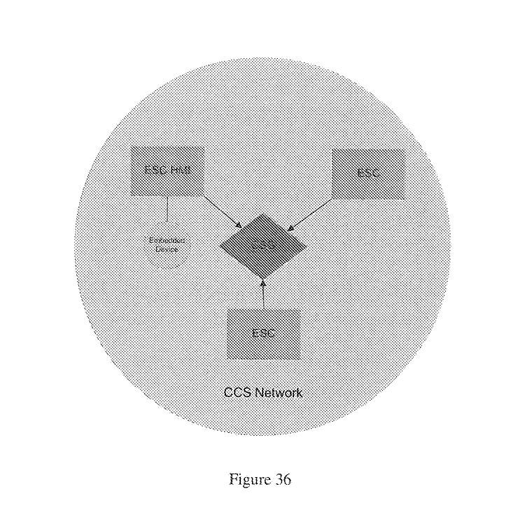

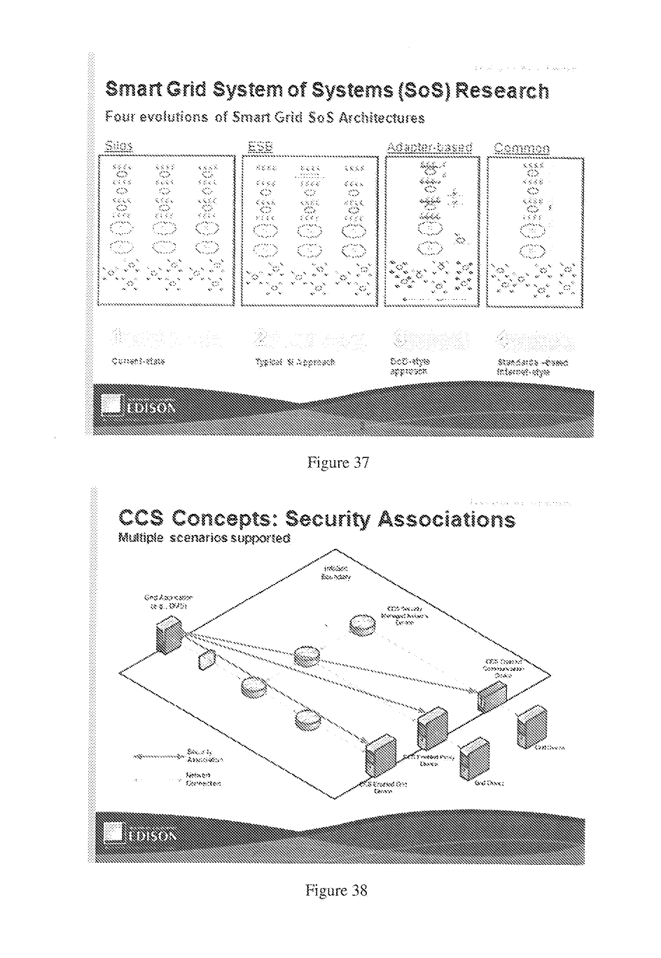

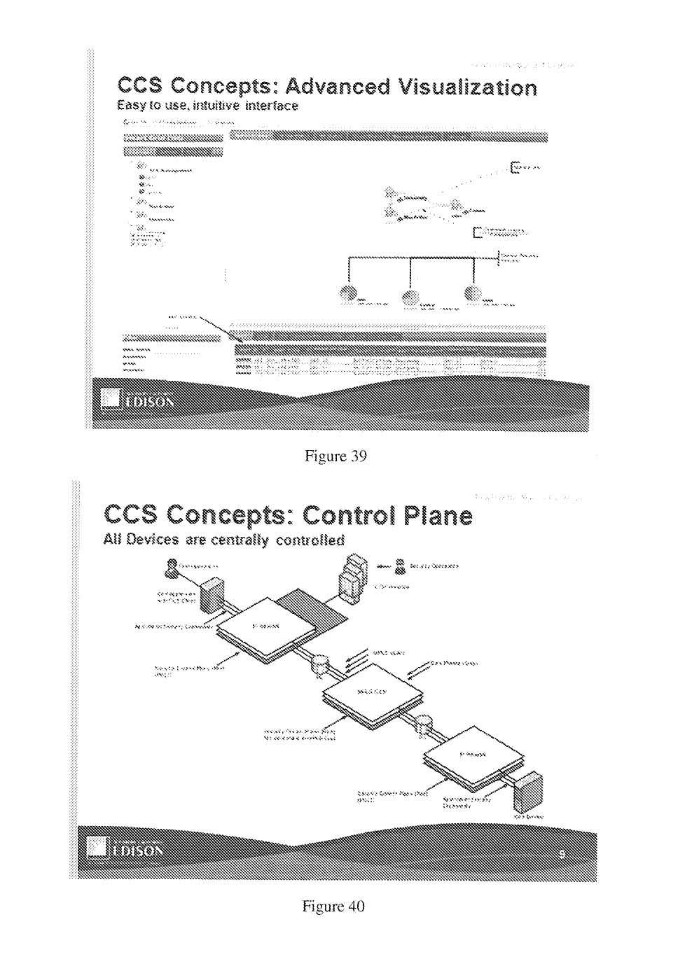

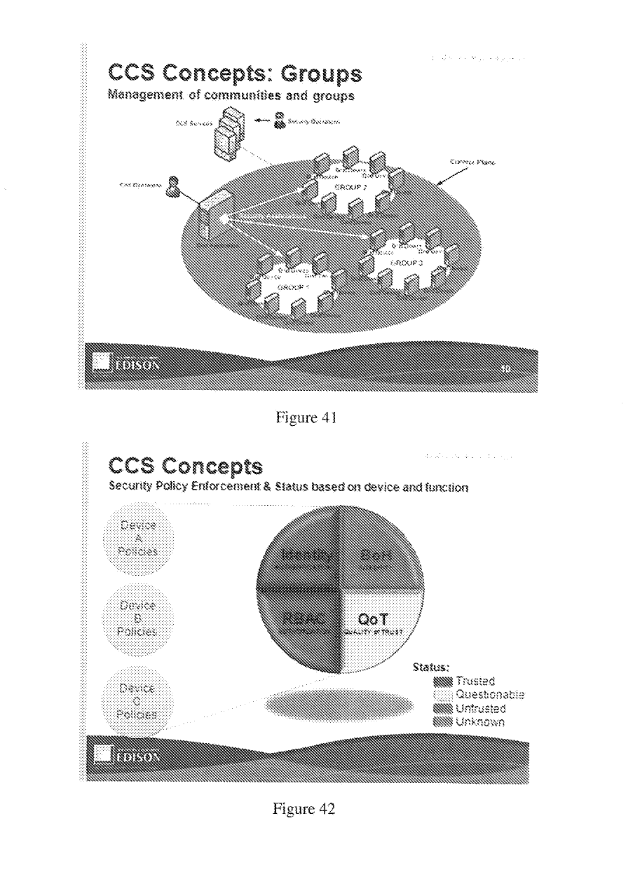

In FIG. 36, the solid arrows represent logs and alert data flowing from one network participant to another. As mentioned before, data flows primarily from clients to the CSG. Clients may host access to data that comes from external embedded devices.

The Client will forward logs and alerts from devices. A local user interface may also be present depending on the deployment. The Client user interface will also generate log data and alerts for all local interactions, including operator log in and all state transitions, as well as Client status.

### 1.5.3.9.3 Syslog Categories

Table 0-20 shows the log levels that will be supported.

TABLE 0-20
Log Levels That Will be Supported

| Level | Potential Use |
|---|---|
| Debug | Software testing will not be included in final product. |
| Info | Can be used for a non-threatening event that took place |
| | such as boot-up procedures. |
| Notice | Can be used for non-threatening events that are more |
| | significant such as successful creation of SA's. |
| Warning | Can be used to describe potentially threatening events such |
| | as integrity being downgraded. |
| Error | Can be used for when a software component fails or crashes |
| | for some reason. |
| Critical | Can be used for high priority security events such as |
| | physical security breaches or |
| Error | certificates revoked. |

### 1.5.3.9.4 Failures

The system is able to use more of DDS's QoS options to help detect failure with both Syslog-NG messages and alerts:
Liveliness—This setting can be used by a DDS Reader (in this case the CSG) to detect when a DDS Writer (i.e., Client) goes down. It works similarly to Syslog's mark messages in that a duration is specified and liveliness is asserted by the reader after the duration passes.
Resource Limits—This setting is useful for detecting for when a client gets compromised and begins flooding data into a DDS topic (DoS attack). Memory constraints are placed upon individual DDS nodes and specific settings are configured for dynamic memory usage. If one were to attempt to flood the system, they would have to use up a lot of memory on a DDS writer. This setting would block the writer after that memory limit had been reached, effectively halting the attack.

### 1.5.3.9.5 Log Host Interface for Legacy Substation Equipment

Not all of the Edge devices will be able to reserve enough space for their own local interface. For these devices the user interface is separate from the actual. Given these circumstances, the Client user interface will act as a Syslog-NG host similarly to the CSG to collect log information from the device. Such devices include physical security alarm systems, weather systems, and power and cooling (HVAC or Heating, Ventilation, and Air Cooling). At the vendor's discretion the Client user interface will receive the logs by listening on UDP port 514 for incoming information.

### 1.5.3.9.6 Client Log Template

By appending the above option in our Syslog-NG configuration file, the CSG will be able to display the date, host name, program name, facility label, logging level/priority, and the message itself using Syslog-NG's environment variables. With the exception of MSG, these variables are all automatically set by the Syslog-NG connection every time a log message is received from the pipe.

Since Syslog-NG uses UNIX time which does not count leap seconds, we may need to derive our timestamps from the Client applications instead of from UNIX.

### 1.5.3.9.7 DDS IDL Mapping to Alert and Syslog Formats

The Client will use Common Event Expression (CEE) to specify the fields of the message.

### 1.6 External Interface Requirements

The identification of each external interface includes a project unique identifier and designates the interfacing entities (systems, configuration items, users, etc.).

### 1.6.1 Security Assurance Requirements Assurance is the grounds for confidence that an IT product meets its security objectives. Assurance can be derived from reference to sources such as unsubstantiated assertions, prior relevant experience, or specific experience.

This specification defines three levels of assurance (Assurance Levels 1 to 3), Level 1 is the lowest level assurance and Level 3 is the highest. Clients are assigned an Assurance Level for physical security and as well as cybersecurity need.

The assurance requirements for a fielded device are dependent upon the security environment in which the device is deployed and the data it processes. The security environment considers the physical environment (can attackers physically access the Cyber System Component), the cyber environment (the cyber-attack risk from network(s) the device is attached to), the data requiring protection (files, databases, authorization credentials, and so on) and the purpose of the Cyber System Component (what kind of product is it? what is the intended use?). These factors along with the associated acceptable risks determine which Assurance Level the device will need to comply with.

SCE will determine the level of assurance required for a specific procurement. This determination should be based upon completing a risk assessment and mapping the identified risks to the required assurance level. SCE can then specify the assurance level required for the procurement and select appropriate technology that, at a minimum, meets the technical requirements for the required level of assurance.

In determining the appropriate level of physical protections required for a device, it is important to consider both the operating environment, the value and sensitivity of the data protected by the device, and the level of security assurance required for specific applications and transactions, based on the risks and their likelihood of occurrence of each application or transaction. The required level of physical assurance should be based upon the likely consequences of a successful physical compromise. As the consequences of physical compromise become more serious, the required level of assurance increases.

For example, SCE may conclude that a module protecting low value information and deployed in an environment with physical protections and controls, such as equipment cages, locks, cameras, and security guards, etc., requires no additional physical protections and may be implemented in software executing on a general purpose computer system (i.e. Assurance Level 1). However, in the same environment, cryptographic modules protecting high value or sensitive information, such as root keys, may require strong physical security.

When deploying EPS Cyber System Components the environment, the value of the information, and the functionality protected by the module should be considered when assessing the level of module physical security required.

In determining the appropriate level of cyber protections required for a device, it is important to consider the network or networks the device is connected to, the value and sensitivity of the data protected by the device, and the level of security assurance required for specific applications and transactions, based on the risks and their likelihood of occurrence of each application or transaction. The required level of cyber assurance should be based upon the likely consequences of a successful cyber compromise. As the consequences of a cyber-compromise become more serious, the required level of assurance increases.

### 1.6.1.1 Procurement Assurance Requirements

The Procurement Assurance Requirements specified in Table 0-21 have been extracted from the Application Security Procurement Language defined by SANS Institute. In the following tables: Table 0-22 shows the Application Development Assurance Requirements, Table 0-23 the Development Environment Assurance Requirements, Table 0-24 the Testing Assurance Requirements, Table 0-35 the Patch and Update Assurance Requirements, Table 0-26 the Delivery Assurance Requirements, and Table 0-27 the Security Acceptance and Maintenance Assurance Requirements.

TABLE 0-21
Procurement Assurance Requirements

| REQ ID | Requirement Text |
|---|---|
| ESC.2381 | The Vendor shall adopt software development standards and practices for |
| | trustworthy software throughout the development life cycle as specified in |
| | Department of Homeland Security: Cyber Security Procurement Language for |
| | Control Systems (dated September 2009) paragraph 5 CODING PRACTICES. |
| | In lieu of the Department of Homeland Security: Cyber Security Procurement |
| | Language for Control Systems, the Application Security Procurement Language |
| | defined by SANS Institute may be specified. |
| ESC.2382 | The vendor shall identify all security configuration checklist(s) required for |
| | installation and maintenance of vendor's computer software and hardware. A |
| | security configuration checklist (also referred to as a lockdown guide, hardening |
| | guide, security guide, security technical implementation guide [STIG], or |
| | benchmark) is essentially a document that contains instructions or procedures for |
| | configuring, installing and maintaining an IT product in an operational |
| | environment. |
| ESC.2383 | The Vendor shall identify the checklists required for installation and maintenance |
| | of vendor's computer software and hardware. |
| ESC.2384 | The Vendor shall use the highest applicable industry standards for sound secure |
| | software development practices to resolve critical security issues as quickly as |
| | possible. |
| ESC.2385 | The “highest applicable industry standards” shall be defined as the degree of care, |
| | skill, efficiency, and diligence that a prudent person possessing technical |
| | expertise in the subject area and acting in a like capacity would exercise in |
| | similar circumstances. |
| ESC.2386 | The Vendor shall conduct an analysis of the 2011 CWE/SANS Top 25 Most |
| | Dangerous Software Errors (1.0.3, dated Sep. 13, 2011), and document in |
| | writing that they have been mitigated. |
| ESC.2387 | The Vendor shall track all security issues uncovered during the entire software |
| | lifecycle, whether a requirements, design, implementation, testing, deployment, |
| | or operational issue. |
| ESC.2388 | The risk associated with each security issue shall be evaluated, documented, and |
| | reported to Purchaser as soon as possible after discovery. |
| ESC.2389 | The Security Lead shall certify to the purchaser in writing that the software meets |
| | the security requirements, all security activities have been performed, and all |
| | identified security issues have been documented and resolved. Any exceptions to |
| | the certification status shall be fully documented with the delivery. |

TABLE 0-22
Application Development Assurance Requirements

| REQ ID | Requirement Text |
|---|---|
| ESC.2390 | Prior to contract award, the Vendor shall provide purchaser written |
| | documentation detailing their application development, patch management and |
| | update process. |
| ESC.2391 | The documentation detailing the application development, patch management |
| | and update process shall clearly identify the measures that will be taken at each |
| | level of the process to develop, maintain and manage the software securely. |
| ESC.2392 | The Vendor shall provide secure configuration guidelines in writing to the |
| | Purchaser that fully describe all security relevant configuration options and their |
| | implications for the overall security of the software. |
| ESC.2393 | The guideline shall include a full description of dependencies on the supporting |
| | platform, including operating system, web server, and application server, and |
| | how they should be configured for security. |
| ESC.2394 | The default configuration of the software shall be secure. |
| ESC.2395 | Pre-contract award, the Vendor shall specify in writing to the Purchaser what |
| | industry security standards and level of care that they follow. |
| ESC.2396 | The Vendor shall provide written documentation to the Purchaser that clearly |
| | explains the design for achieving each of the security requirements. |
| ESC.2397 | The Vendor shall provide and follow a set of secure coding guidelines. These |
| | guidelines will indicate how code should be formatted, structured, and |
| | commented. |
| ESC.2398 | All security-relevant code shall be thoroughly commented (unless COTS). |
| ESC.2399 | Specific guidance on avoiding common security vulnerabilities shall be included. |
| ESC.2400 | All code shall be reviewed by at least one other Developer against the security |
| | requirements and coding guideline before it is considered ready for test. |

TABLE 0-23
Development Environment Assurance Requirements

| REQ ID | Requirement Text |
|---|---|
| ESC.2401 | The Vendor shall disclose what tools are used in the |
| | software development environment to |
| | encourage secure coding. |
| ESC.2402 | The Vendor shall use a source code control system that |
| | authenticates and logs the team member associated with all |
| | changes to the software baseline and all related configuration |
| | and build files. |
| ESC.2403 | The Vendor shall use a build process that reliably builds |
| | a complete distribution from source. |
| ESC.2404 | This build process shall include a method for verifying the |
| | integrity of the software delivered to Client. |
| ESC.2405 | The Vendor shall document all third party software used |
| | in the software, including all libraries, frameworks, |
| | components, and other products, whether commercial, |
| | free, open-source, or closed-source. |

TABLE 0-24
Testing Assurance Requirements

| REQ ID | Requirement Text |
|---|---|
| ESC.2407 | The Vendor shall provide and follow a security test plan that |
| | defines an approach for testing or otherwise establishing |
| | that each of the security requirements has been met and the |
| | level of rigor of the testing process. |
| ESC.2408 | The vendor shall implement the security test plan and provide |
| | the test results to SCE in writing |
| ESC.2409 | The Vendor shall have a well-documented procedure and |
| | framework for conducting code reviews. |
| ESC.2410 | The Vendor shall agree in writing that prior to production the |
| | application shall undergo vulnerability and a penetration test. |
| ESC.2411 | Post production, the Vendor shall perform contractually |
| | agreed upon security scans (with the most current signature |
| | files) to verify that the system has not been compromised |
| | during the testing phase. |
| ESC.2412 | The Vendor shall provide written documentation of the results |
| | of the security scans and tests along with a mitigation plan. |
| ESC.2413 | The Vendor shall agree that any vulnerabilities will be |
| | mitigated within a pre-negotiated period. |

TABLE 0-25
Patch and Update Assurance Requirements

| REQ ID | Requirement Text |
|---|---|
| ESC.2414 | The Vendor shall provide notification of patches and updates |
| | affecting security within a pre-negotiated period as identified |
| | in the patch management process throughout the |
| | software lifecycle. |
| ESC.2415 | The Vendor shall apply, test, and validate and document |
| | the appropriate patches and updates and/or workarounds on a |
| | test version of the application before distribution. |
| ESC.2416 | The Vendor shall verify application functionality, based |
| | upon pre-negotiated procedures, at the conclusion of patch |
| | updates, and provide documentation of the results. |

TABLE 0-26
Delivery Assurance Requirements

| REQ ID | Requirement Text |
|---|---|
| ESC.2417 | The Vendor shall provide a “certification package” consisting |
| | of the security documentation created throughout the |
| | development process. |
| ESC.2418 | The certification package shall establish that the security |
| | requirements, design, implementation, and test results were |
| | properly completed and all security issues were resolved |
| | appropriately and any exceptions fully documented. |
| ESC.2419 | Developer shall warrant that the software shall not contain |
| | any code that does not support a software requirement and |
| | weakens the security of the application, including computer |
| | viruses, worms, time bombs, back doors, Trojan horses, |
| | Easter eggs, and all other forms of malicious code. |

TABLE 0-27
Security Acceptance and Maintenance Assurance Requirements

| REQ ID | Requirement Text |
|---|---|
| ESC.2420 | The software shall not be considered accepted until the |
| | Vendor certification package is complete and all security |
| | issues have been resolved. |

The Assurance Requirements for each of the three levels are specified in the following paragraphs.

### 1.6.1.2 Assurance Level 1 (AL1) Requirements

The Assurance Level 1 Cyber and Physical Security Requirements are specified in the following table. These are the minimum requirements that all Clients must meet.

TABLE 0-28
Assurance Level 1 (AL1) Requirements

| REQ ID | Requirement Text |
|---|---|
| ESC.2421 | The Assurance Level 1 (AL1) Client Operating system shall |
| | implement process separation mechanisms such as protected |
| | memory and file and object access permissions. |
| ESC.2422 | The AL1 Client Operating system shall be hardened in |
| | accordance the applicable operating system security |
| | configuration checklist. The applicable security configuration |
| | checklist is dependent upon the operating system residing |
| | within the client device. |
| ESC.2423 | The Client shall use a FIPS 140-2 Cryptographic Module |
| | certified to overall Security Level 1 or higher to perform the |
| | required cryptographic operations. |
| ESC.2431 | The AL1 Client shall use a FIPS 140-2 Cryptographic |
| | Module certified to overall Security Level 1 or higher to store |
| | cryptographic keys. |
| ESC.2432 | The Client Operating System shall implement an audit trail |
| | for privileged functions. |
| ESC.2433 | The Client Operating system shall implement controls and |
| | auditing for privileged functions. |
| ESC.2434 | The Client Operating system shall implement file system |
| | or whole disk encryption for local data storage. |
| ESC.2435 | The Client Operating system shall implement an audit and |
| | alert mechanism for physical chassis access when |
| | power is available. |

### 1.6.1.3 Assurance Level 2 (AL2) Cybersecurity Requirements

The Assurance Level 2 Cybersecurity Requirements are specified in the following table.

TABLE 0-29
Assurance Level 2 (AL2) Cybersecurity Requirements

| REQ ID | Requirement Text |
|---|---|
| ESC.2424 | In addition to the AL1 requirements, the AL2 Client |
| | Operating system shall implement a type enforcement |
| | (mandatory permissions) policy. |

### 1.6.1.4 Assurance Level 2 (AL2) Physical Security Requirements

The Assurance Level 2 Physical Security Requirements are specified in the following table.

TABLE 0-30
Assurance Level 2 (AL2) Physical Security Requirements

| REQ ID | Requirement Text |
|---|---|
| ESC.2425 | The AL2 Client shall use a FIPS 140-2 Cryptographic Module |
| | certified to overall Security Level 2 or higher. |

### 1.6.1.5 Assurance Level 3 (AL3) Cybersecurity Requirements

The Assurance Level 3 Cybersecurity Requirements are specified in the following table.

TABLE 0-31
Assurance Level 3 (AL3) Cybersecurity Requirements

| REQ ID | Requirement Text |
|---|---|
| ESC.2426 | In addition to the AL2 requirements, the AL3 Client |
| | Operating system shall be evaluated to EAL 4 or better in |
| | accordance with Common Criteria. |
| ESC.2427 | The AL3 Client shall use a FIPS 140-2 Cryptographic Module |
| | certified to overall Security Level 2 or higher. |

The following is a sampling of the OSs known to have been evaluated to a minimum of EAL 4.
a. SUSE Linux Enterprise Server 10 SP1 EAL4
b. Red Hat Enterprise Linux EAL 4 augmented with ALC_FLR.3
c. Solaris 10 Release 11/06 Trusted Extensions EAL 4+ augmented with ALC_FLR.3
d. Microsoft Windows Server™ 2003, Standard Edition (32-bit version) with Service Pack 1, EAL 4 augmented with ALC_FLR.3
e. Microsoft Windows Server 2003, Enterprise Edition (32-bit and 64-bit versions) with Service Pack 1, EAL 4 augmented with ALC_FLR.3
f. Microsoft Windows Server 2003, Datacenter Edition (32-bit and 64-bit versions) with Service Pack 1, EAL 4 augmented with ALC_FLR.3
g. Microsoft Windows Server 2003 Certificate Server, Certificate Issuing and Management Components (CIMC) (Security Level 3 Protection Profile, Version 1.0), EAL 4 augmented with ALC_FLR.3
h. Microsoft Windows XP Professional with Service Pack 2, EAL 4 augmented with ALC_FLR.3
i. Microsoft Windows XP Embedded with Service Pack 2, EAL 4 augmented with ALC_FLR.3

### 1.6.1.6 Assurance Level 3 (AL3) Physical Security Requirements

The Assurance Level 3 Physical Security Requirements are specified in the following table.

TABLE 0-32
Assurance Level 3 (AL3) Physical Security Requirements

| REQ ID | Requirement Text |
|---|---|
| ESC.2428 | The AL3 Client shall use a FIPS 140-2 Cryptographic Module |
| | certified to overall physical Security Level 3 or higher. |

### Notes

This section contains any general information that aids in understanding this document (e.g., background information, glossary, rationale). This section includes an alphabetical listing of all acronyms, abbreviations, and their meanings as used in this document and a list of any terms and definitions needed to understand this document.

### 1.7 Definitions and Acronyms

This section list all abbreviations, acronyms, and definitions used throughout the document here in the context of this document and project. Entries are in alphabetical order.

TABLE 0-33
Acronyms

| Acronym | Definition |
|---|---|
| AA | Attribute Authority |
| AAA | Authentication, Authorization, and Accounting |
| A&V | Analytics and Visualization |
| AC | Attribute Certificate or Access Control |
| ACL | Access Control List |
| AES | Advanced Encryption Standard |
| AES-128 | AES with 128 bit key |
| AES-128- | AES Galois Counter Mode with 128 bit key |
| GCM | |
| AH | Authentication Header |
| AK | Authentication Key |
| AKI | Authority Key Identifier |
| AL | Assurance Level |
| AMI | Advanced/Automated Metering Infrastructure |
| AMI-SEC | AMI Security [Task Force] |
| AMQP | Advanced Message Queuing Protocol |
| ANSI | American National Standards Institute |
| AOR | Area of Responsibility |
| API | Application Programming Interface |
| AR | Access Requestor |
| ASN | Abstract Syntax Notation |
| ASTM | American Society for Testing and Materials |
| ATP | Acceptance Test Procedures |
| ATR | Attribute |
| AVVC | Advanced Volt/VAr Control |
| BEM | Building Energy Management |
| BER | Bit Error Rate |
| BIOS | Basic Input/Output System (The software in a Personal |
| | Computer that runs at power-on before the |
| | Operating System starts) |
| BIT | Built In Test |
| BMS | Building Management System |
| BoH | Bill of Health |
| CA | Certificate Authority |
| CAISO | California Independent System Operator |
| CBC | Cipher Block Chaining |
| CBC-MAC | Cipher Block Chaining Message Authentication Code |
| CC | Common Criteria or Control Center |
| CCA | Critical Cyber Asset |
| CCC | Central Cybersecurity Component |
| CCS | Common Cybersecurity Service(s) |
| CCSC | Common Cybersecurity Service-Central |
| CCSE | Common Cybersecurity Service-Edge |
| CCS-IED | CCS Intelligent Electronic Device |
| CCS-MS | CCS Management Services |
| CCSRG | Field Communications Services Router and Gateway |
| CDR | Common Data Representation |
| CEE | Common Event Expression |
| CERT | Certificate(abv) |
| CHP | Combined Heat and Power |
| CI&A | Confidentiality, Integrity, and Availability |
| CIA | Confidentiality, Integrity, and Availability |
| CIM | Common Information Model |
| CIP | Critical Infrastructure Protection |
| CIS | Cryptographic Interoperability Strategy |
| CIS | Customer Information System |
| CKS | Central Key Service/Server |
| CM | Configuration Management |
| CMAC | Cipher-based Message Authentication Code |
| CMC | Certificate Management over Cryptographic Message |
| | Syntax (CMS) |
| CMM | Capability Maturity Model |
| CMMS | Computer-based Maintenance Management Systems |
| CMRI | CAISO Market Results Interface |
| CMS | Central Management Server or Cryptographic |
| | Message Syntax |
| CN | Canonical Name |
| COI | Community of Interest |
| COTS | Commercial Off-the-Shelf |
| CP | Certificate Policy |
| CPSC | Control Plane Secure Change |
| CPU | Central Processing Unit |
| CRC | Cyclic Redundancy Check |
| CRD | CCS Reference Design |
| CRL | Certificate Revocation List |
| CS | Central Security |
| CSCA | Central Security Certificate Authority |
| CSCI | Computer Software Configuration Item |
| CSCM | Central Security Configuration Manager |
| CSCTG | Cyber Security Coordination Task Group |
| CSG | Central Security GUI |
| CSI | Central Security Interface |
| CSMA | Central Security Management Authority |
| CSMS | Central Security Management Service |
| CSR | Certificate Signing Request or Central Security Repository |
| CSRA | Central Security Registration Authority |
| CSS | Cyber Security Systems |
| CSSWG | Control Systems Security Working Group |
| CSWG | Cyber Security Working Group |
| DBS | Data Beyond SCADA |
| DCS | Distributed Control System |
| DDS | Data Distribution Service |
| DER | Distributed Energy Resources |
| DES | Data Encryption Standard |
| DFR | Digital Fault Recorder |
| DG | Data Group |
| DGM | Distribution Grid Management |
| DGPS | Distributed Grid Protection Systems |
| DHCP | Dynamic Host Configuration Protocol |
| DHS | Department of Homeland Security |
| DM | Distribution Management |
| DMS | Distribution Management System |
| DN | Distinguished Name |
| DNP | Distributed Network Protocol |
| DNS | Domain Name Service |
| DoS | Denial of Service |
| DPI | Deep Packet Inspection |
| DR | Demand Response |
| DRM | Digital Rights Management |
| DSA | Digital Signature Algorithm |
| DSS | Digital Signature Standard |
| DTLS | Datagram Transport Layer Security |
| EAL | Evaluation Assurance Level |
| EAMS | Enterprise Asset Management System |
| EAP | Extensible Authentication Protocol |
| EAP-TNC | Extensible Authentication Protocol-Trusted |
| | Network Connect |
| ECS | EPS Cyber System |
| ECSC | EPS Cyber Systems Component |
| EE | End Entity |
| EKU | Extended Key Usage |
| EMC | Electromagnetic Compatibility |
| EMI | Electromagnetic Interference |
| EMS | Energy Management System |
| EMSK | Extended Master Session Key |
| EPS | Electric Power System |
| ESC | Edge Security Client |
| ESI | Energy Smart Industrial |
| ESI | Energy Services Interface |
| ESM | Enterprise Semantic Model |
| ESP | Electronic Security Perimeter |
| ESP | Encapsulated Security Payload |
| ESP | Energy Service Provider |
| FAT | Factory Acceptance Test |
| FERC | Federal Energy Regulatory Commission |
| FIPS | Federal Information Processing Standards |
| FL | Fault Location |
| FLIR | Fault Location, Isolation, Restoration |
| FNET | Frequency Monitoring Network |
| FTP | File Transfer Protocol |
| GC | Group Controller |
| GCC | Grid Control Center |
| GCCN | Grid Control Center Network |
| GCKS | Group Controller/Key Server |
| GCM | Galois Counter Mode |
| GDC | Group Distribution Center |
| GDOI | ISAKMP Group Domain of Interpretation |
| GEM | Global Event Management |
| GeoXACML | Geospatial Extensible Access Control Markup Language |
| GKDC | Group Key Distribution Center |
| GMAC | Galois Message Authentication Code |
| GMT | Greenwich Mean Time |
| GPA | Grid Protection Application |
| GPHD | Grid Protection Hardware Device |
| GPRS | General Packet Radio Service |
| GPS | Global Positioning System |
| GPSK | Generalized Pre-Shared Key |
| GRE | Generic Routing Encapsulation |
| GR-KEK | Group Key Encrypting Key |
| GSA | Group Security Association |
| GSAKMP | Group Security Association Key Management Protocol |
| GUI | Graphical User Interface |
| GUID | Globally Unique Identifier (assigned by the manufacturer |
| | or an international assignment authority) |
| GWAC | GridWise Architecture Council |
| HMAC | Hash Message Authentication Code |
| HMI | Human-Machine Interface |
| HSM | Hardware Security Module |
| HTTP | Hypertext Transfer Protocol |
| HTTPS | Hypertext Transfer Protocol Secure |
| HVAC | Heating, Ventilation, and Air Cooling |
| HWCI | Hardware Configuration Item |
| IA | Information Assurance |
| IAC | Integrity, Availability, and Confidentiality |
| IACS | Industrial Automation and Control Systems |
| IAK | Identification Authentication Key |
| IBE | Identity-Based Encryption |
| IBT | Initiated Built In Test |
| ICCP | Inter-Control Center Communications Protocol |
| ICS | Industrial Control Systems |
| ID | Identity/Identifier |
| IDL | Interface Definition Language |
| IDS | Intrusion Detection System |
| IEC | International Electrotechnical Commission |
| IED | Intelligent Electronic Device |
| IEEE | Institute of Electrical and Electronics Engineers |
| IETF | Internet Engineering Task Force |
| IGMP | Internet Group Management Protocol |
| IKE | Internet Key Exchange. Protocol used to set up a security |
| | association in the IPsec protocol suite. |
| IMA | Integrity Measurement Authority |
| IMC | Integrity Measurement Collector |
| IMV | Integrity Measurement Verifier |
| IP | Internet Protocol |
| IPv4, IPv6 | IP version 4, IP version 6 |
| IPP | Independent Power Producer |
| IPR | Intellectual Property Rights |
| IPS | Intrusion Prevention System |
| IPSec | Internet Protocol Security |
| IS | Information Security |
| ISA | International Society of Automation |
| ISAKMP | Internet Security Association and Key |
| | Management Protocol |
| ISGD | Irvine Smart Grid Demo |
| ISMS | Information Security Management System |
| ISO | International Standards Organization |
| ISO | Independent System Operator |
| IT | Information Technology |
| ITGI | IT Governance Institute |
| ITL | Information Technology Laboratory |
| ITS | Information Technology Security |
| IVR | Interactive Voice Response |
| JMS | Java Messaging System |
| JNI | Java Native Interface |
| JTC | Joint Technical Committee |
| KDC | Key Distribution Center |
| KEK | Key Encryption Key |
| KMI | Key Management Infrastructure |
| KS | Key Server |
| LAN | Local Area Network |
| LD | Logical Device |
| LDAP | Lightweight Directory Access Protocol |
| LFOM | Low Frequency Oscillation Monitoring |
| LKH | Logical Key Hierarchy |
| LLC | Link Layer Control |
| LMS | Load Management System |
| LN | Logical Node |
| MAC | Message Authentication Code |
| MD | Message Digest |
| MIB | Management Information Base |
| MPLS | Multi Protocol Label Switching |
| MTBF | Mean Time Between Failure |
| MTTR | Mean Time to Repair |
| NASPInet | North America Synchrophasor Initiative Network |
| NERC | North American Electric Reliability Corporation |
| NETCONF | Network Configuration Protocol |
| NFM | Node Frequency Monitoring |
| NFRCM | Node Frequency Rate-of-Change Monitoring |
| NIC | Network Interface Card |
| NIPP | National Infrastructure Protection Plan |
| NIST | National Institute of Standards and Technology |
| NISTIR | NIST Interagency Report |
| NMAP | Networked Messaging Application Protocol |
| NSM | Network and System Management |
| OBIT | Operational Built In Test |
| OCSP | Online Certificate Status Protocol |
| ODS | Operational Data Server |
| OGS | Open Geospatial Consortium |
| OID | Object Identifier |
| OLE | Object Linking and Embedding |
| OMG | Object Management Group |
| OMS | Outage Management System |
| OODA | Observe, Orient, Decide, Act |
| OPC | OLE for Process Control |
| ORL | Outage Request Library |
| OSI | Open System Interconnection |
| OTN | Over the Network |
| OTNR | Over The Network Rekey |
| OTNZ | Over The Network Zeroize |
| OUI | Organizationally Unique Identifier |
| OWASP | Open Web Application Security Project |
| PBIT | Power-on Built In Test |
| PC | Personal Computer |
| PCI | Plaintext Channel Interface |
| PCR | Platform Configuration Registers |
| PD | Physical Device |
| PDC | Phasor Data Concentrator |
| PDP | Policy Decision Point |
| PE | Protocol Encryption |
| PFS | Perfect Forward Secrecy |
| PG | Phasor (data) Gateway |
| PGCS | Predictive Grid Control System |
| PGW | Phasor Gateway |
| PHY | Physical Layer |
| PKC | Public Key Certificate |
| PKCS | Public-Key Cryptography Standards |
| PKI | Public Key Infrastructure |
| PKIX | Public-Key Infrastructure (X.509) working group |
| PMI | Privilege Management Infrastructure |
| PMU | Phasor Measurement Unit |
| POP | Proof of Possession |
| PPP | Point-to-Point Protocol |
| PQ | Power Quality |
| PRNG | Pseudo Random Number Generator/Generation |
| PSP | Physical Security Perimeter |
| PUC | Public Utilities Commission |
| QoS | Quality of Service |
| QoT | Quality of Trust |
| RA | Registration Authority |
| RAM | Random Access Memory |
| RBAC | Role-Based Access Control |
| RF | Radio Frequency |
| RFC | Request for Comments |
| RG | Registration Group |
| RK | Registration Key |
| RNG | Random Number Generator |
| RP | Registration Passphrase |
| RP | Relying Party |
| RPC | Remote Procedure Call |
| RR | Registration Request |
| RSA | Public key cryptography algorithm named for its |
| | co-inventors: Ron Rivest, Adi Shamir, and Len Adleman. |
| RTPS | Real-Time Publish Subscribe |
| RTU | Remote Terminal Unit |
| SA | Security Association |
| SAM | Security Authentication Module |
| SAML | Security Assertion Markup Language |
| SAP | Service Access Point |
| SAS | Substation Automation System |
| SAT | Site Acceptance Test or Security Association TEK |
| | (traffic encryption key) |
| SCADA | Supervisory Control and Data Acquisition |
| SCE | Southern California Edison |
| SCE-COI | Southern California Edison Community of Interest |
| SCI | Secure Channel Interface |
| SCL | Substation Configuration Language |
| SCM | Security Configuration Management |
| SCSM | Specific Communication Service Mapping |
| SDD | System Design Document |
| SDLC | Software Development Lifecycle |
| SDM | System and Data Management |
| SDU | Service Data Unit |
| SEI | Software Engineering Institute |
| SEI | SCE External Interfaces |
| SEL | Schweitzer Engineering Laboratories |
| SEM | Security Event Management |
| SEP | Smart Energy Profile |
| SER | Sequence of Events Recorder |
| SFTP | Secure File Transfer Protocol |
| SG | Smart Grid |
| SHA | Secure Hash Algorithm |
| SHS | Secure Hash Standard |
| SIEM | Security Information and Event Management |
| SNMP | Simple Network Management Protocol |
| SNTP | Simple Network Time Protocol |
| SOA | Service Oriented Architecture |
| SOAP | Simple Object Access Protocol (XML protocol) |
| SPP | Single-use Provisioning Passphrase |
| SPOF | Signal Point of Failure |
| SRS | System Requirements Specification |
| SSH | Secure Shell |
| SSID | Service Set Identifier |
| SSL | Secure Sockets Layer |
| SSL/TLS | Secure Socket Layer/Transport Layer Security |
| STIG | Security Technical Implementation Guide |
| SubCA | Subordinate Certificate Authority |
| SW | Software |
| T&D | Transmission and Distribution |
| TA | Trust Anchor |
| TAMP | Trust Anchor Management Protocol |
| TCG | Trusted Computing Group |
| TCP | Transmission Control Protocol |
| TCP/IP | Transmission Control Protocol/Internet Protocol |
| TCPA | Telephone Consumer Protection Act |
| TEK | Traffic Encryption Key |
| TEMPEST | A codename referring to investigations and studies of |
| | conducted emissions |
| TLS | Transport Layer Security |
| TNC | Trusted Network Connect |
| TNCC | Trusted Network Connect Client |
| TPM | Trusted Platform Monitor/Module |
| TRSM | Tamper Resistant Security Modules |
| TS | Technical Specification |
| TSF | Trusted Security Function |
| UDP | User Datagram Protocol |
| UDP/IP | User Datagram Protocol/Internet Protocol |
| UI | User Interface |
| UML | Unified Modeling Language |
| UPS | Uninterruptable Power Supply |
| URI | Universal Resource Indicator |
| URL | Universal Resource Locator |
| USACM | U.S. Association for Computing Machinery |
| USRK | Usage-Specific Root Key |
| UTC | Coordinated Universal Time |
| VLAN | Virtual Local Area Network |
| VMM | Virtual Machine Monitor |
| VOIP | Voice Over Internet Protocols |
| VPADM | Voltage Phase Angle Difference Monitoring |
| VPN | Virtual Private Network |
| WAN | Wide Area Network |
| WAP | Wireless Access Protocol |
| WASA | Wide Area Situational Awareness |
| WASAS | Wide Area Situational Awareness System |
| WECC | Western Electricity Coordinating Council |
| WG | Working Group |
| Wi-Fi | Term often used as a synonym for IEEE 802.11 |
| | technologies. Wi-Fi is a trademark of the Wi-Fi Alliance. |
| WiMAX | Worldwide Interoperability for Microwave Access |
| WiMAX | Wireless digital communications system, also known as |
| | IEEE 802.16 |
| WLAN | Wireless Local Area Network |
| WMS | Work Management System |
| WPA2 | Wi-Fi Protected Access 2 (Wi-Fi Alliance) |
| WRF | CSSField Communications Services Router/Firewall |
| WSDD | WASAS System Design Document |
| XACML | Extensible Access Control Markup Language |
| XML | Extensible Markup Language |

What is claimed is:

1. A system for integrating in the electric grid new sources of renewable and distributed energy supply and storage comprising security controls and mechanisms as shown in FIG. 1.
